(19) United States
(12) Patent Application Publication
(10) Pub. No.: US 2026/0302210 A1
(43) Pub. Date: Oct. 1, 2026

(54) SECONDARY BATTERY

(71) Applicant: SEMICONDUCTOR ENERGY LABORATORY CO., LTD., Atsugi-shi, Kanagawa-ken (JP)

(72) Inventors: Shunpei YAMAZAKI, Setagaya, Tokyo (JP); Kazune YOKOMIZO, Tama, Tokyo (JP)

(21) Appl. No.: 19/477,397

(22) PCT Filed: Apr. 24, 2024
(86) PCT No.: PCT/IB2024/053966

§ 371 Date: Oct. 21, 2025

(30) Foreign Application Priority Data
May 2, 2023 (JP) 2023-076037

(51) Int. Cl. H01M 4/525; H01M 4/02; H01M 4/36; H01M 4/38; H01M 10/0525

(52) U.S. Cl. CPC H01M 4/525; H01M 4/366; H01M 4/388; H01M 10/0525; H01M 2004/021; H01M 2004/028

(57) ABSTRACT

A positive electrode active material that can be used in a lithium-ion secondary battery and in which conductivity is improved and/or insertion and extraction of lithium ions are promoted is provided. A secondary battery includes a positive electrode active material; the positive electrode active material contains an additive element whose oxide can be a semiconductor, magnesium, and lithium cobalt oxide; the positive electrode active material includes a crack; the positive electrode active material includes a surface portion and a crack portion; the surface portion is a region within 10 nm from a surface other than the crack portion in a direction substantially perpendicular to the surface; the crack portion is a region within 10 nm from a surface of the crack portion in a direction substantially perpendicular to the surface and is a region other than the surface portion; magnesium is detected from the surface portion and the crack portion; the element whose oxide can be a semiconductor is detected from the surface portion; and the element whose oxide can be a semiconductor is one or two selected from nickel and titanium.

### TECHNICAL FIELD

One embodiment of the present invention relates to an object, a method, or a manufacturing method. Alternatively, the present invention relates to a process, a machine, manufacture, or a composition (composition of matter). One embodiment of the present invention relates to any of a power storage device, a semiconductor device, a display device, a light-emitting device, a lighting device, and an electronic device each including a secondary battery, or a manufacturing method thereof.

Electronic devices in this specification refer to all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

In particular, secondary batteries for mobile electronic devices, for example, are highly demanded to have high discharge capacity per weight and excellent cycle performance. In order to meet such demands, positive electrode active materials included in positive electrodes of secondary batteries have been actively improved (e.g., Patent Document 1 and Patent Document 2). In addition, a crystal structure of a positive electrode active material has also been studied (Non-Patent Document 1 to Non-Patent Document 3). Lithium-ion secondary batteries which has higher charge and discharge cycle performance and rate characteristics, and can operate in a wider temperature range has been required.

In addition, X-ray diffraction (XRD) is one of methods used for analysis of the crystal structure of a positive electrode active material. With the use of the ICSD (Inorganic Crystal Structure Database) described in Non-Patent Document 4, XRD data can be analyzed. For example, the ICSD can be referred to for the lattice constant of lithium cobalt oxide described in Non-Patent Document 5. For Rietveld analysis, the analysis program RIETAN-FP (Non-Patent Document 6) can be used, for example. As software for drawing crystal structures, VESTA (Non-Patent Document 7) can be used.

Shannon's ionic radii (Non-Patent Document 8) can be referred to for consideration of a crystal structure of an oxide.

As image processing software, for example, ImageJ (Non-Patent Document 9 to Non-Patent Document 11) is known. Using this software makes it possible to analyze the shape of a positive electrode active material, for example.

Nanobeam electron diffraction can also be effectively used to identify the crystal structure of a positive electrode active material, in particular, the crystal structure of a surface portion of a positive electrode active material. For analysis of electron diffraction patterns, an analysis program called ReciPro (Non-Patent Document 12) can be used, for example.

The electrochemical characteristics of a metal oxide have been studied for a long time (Non-Patent Document 13).

### REFERENCES

### Patent Documents

[Patent Document 1] Japanese Published Patent Application No. 2018-206747
[Patent Document 2] Japanese Published Patent Application No. 2022-070247

### Non-Patent Documents

[Non-Patent Document 1] Toyoki Okumura et. al., “Correlation of lithium ion distribution and X-ray absorption near-edge structure in O3- and O2-lithium cobalt oxides from first-principle calculation”, Journal of Materials Chemistry, 2012, 22, p. 17340-17348
[Non-Patent Document 2] Motohashi, T. et. al., “Electronic phase diagram of the layered cobalt oxide system LiₓCoO₂ (0.0≤x≤1.0)”, Physical Review B, 80 (16); 165114
[Non-Patent Document 3] Zhaohui Chen et. al., “Staging Phase Transitions in LiₓCoO₂”, Journal of The Electrochemical Society, 2002, 149 (12) A1604-A1609
[Non-Patent Document 4] Belsky, A. et. al., “New developments in the Inorganic Crystal Structure Database (ICSD): accessibility in support of materials research and design”, Acta Cryst., (2002) B58 364-369.
[Non-Patent Document 5] Akimoto, J.; Gotoh, Y.; Oosawa, Y. “Synthesis and structure refinement of LiCoO₂ single crystals”, Journal of Solid State Chemistry (1998) 141, p. 298-302
[Non-Patent Document 6] F. Izumi and K. Momma, “Three-Dimensional Visualization in Powder Diffraction”, Solid State Phenom. 130, 15-20 (2007)
[Non-Patent Document 7] K. Momma and F. Izumi, “VESTA 3 for three-dimensional visualization of crystal, volumetric and morphology data”, J. Appl. Cryst., (2011). 44, 1272-1276
[Non-Patent Document 8] Shannon, R. D, “Revised Effective Ionic Radii and Systematic Studies of Interatomic Distances in Halides and Chalcogenides”, Acta Crystallographica. Section A, (1976) A32, 751-767.
[Non-Patent Document 9] Rasband, W. S., ImageJ, U. S. National Institutes of Health, Bethesda, Maryland, USA, http://rsb.info.nih.gov/ij/, 1997-2012.
[Non-Patent Document 10] Schneider, C. A., Rasband, W. S., Eliceiri, K. W. “NIH Image to ImageJ: 25 years of image analysis”. Nature Methods 9, 671-675, 2012.
[Non-Patent Document 11] Abramoff, M. D., Magelhaes, P. J., Ram, S. J. “Image Processing with ImageJ”. Biophotonics International, volume 11, issue 7, pp. 36-42, 2004.
[Non-Patent Document 12] Seto, Y. & Ohtsuka, M., “ReciPro: free and open-source multipurpose crystallographic software integrating a crystal model database and viewer, diffraction and microscopy simulators, and diffraction data analysis tools” (2022). J. Appl. Cryst. 55.
[Non-Patent Document 13] Tamura Hideo and Yoneyama Hiroshi, Electrochemical characteristics of oxide semiconductor, Denki kagaku oyobi kogyo butsuri kagaku, 1980, Vol. 48, No. 6, p. 335-343.

### SUMMARY OF THE INVENTION

### Problems to be Solved by the Invention

There is room for improvement in a variety of aspects of lithium-ion secondary batteries, such as discharge capacity, cycle performance, reliability, safety, and cost. For example, in order to inhibit a change in the crystal structure of the surface of a positive electrode active material, the surface of the positive electrode active material is sometimes covered with an electrochemically stable oxide, in which case the coating film might reduce conductivity and inhibit insertion and extraction of lithium. Reduction in conductivity and/or inhibition of insertion and extraction of lithium ions might reduce secondary battery characteristics, e.g., reduce rate characteristics and reduce charge and discharge capacity in a low-temperature environment.

In view of the above, an object of one embodiment of the present invention is to provide a positive electrode active material that can be used in a lithium-ion secondary battery and in which conductivity is improved and/or insertion and extraction of lithium ions are promoted. Another object is to provide a positive electrode active material or a composite oxide that inhibits a decrease in discharge capacity in a low-temperature environment. Another object is to provide a positive electrode active material or a composite oxide that inhibits a decrease in discharge capacity in charge and discharge cycles. Another object is to provide a positive electrode active material or a composite oxide whose crystal structure is not easily broken even when charge and discharge are repeated. Another object is to provide a positive electrode active material or a composite oxide enabling high discharge capacity. Another object is to provide a secondary battery or a vehicle with high safety or high reliability.

Another object of one embodiment of the present invention is to provide a positive electrode active material, a composite oxide, a power storage device, or a manufacturing method thereof.

Note that the description of these objects does not preclude the existence of other objects. One embodiment of the present invention does not necessarily achieve all these objects. Note that other objects can be derived from the description of the specification, the drawings, and the claims.

### Means for Solving the Problems

In order to achieve the above objects, one embodiment of the present invention provides a positive electrode active material containing an element whose oxide can be a semiconductor in a surface portion. As such an element, one or more selected from nickel, titanium, ruthenium, vanadium, niobium, chromium, molybdenum, tungsten, rhenium, osmium, rhodium, iridium, lanthanum, and strontium can be used, for example.

In addition to the above, it is further preferable that the surface portion of the positive electrode active material contain an additive element stabilizing a crystal structure. As the additive element stabilizing a crystal structure, one or more selected from magnesium, fluorine, nickel, and aluminum can be used, for example.

One embodiment of the present invention is a secondary battery including a positive electrode active material. The positive electrode active material contains an additive element whose oxide can be a semiconductor, magnesium, and lithium cobalt oxide. The positive electrode active material includes a crack. The positive electrode active material includes a surface portion and a crack portion. The surface portion is a region within 10 nm from a surface other than the crack in a direction substantially perpendicular to the surface. The crack portion is a region within 10 nm from a surface of the crack in a direction substantially perpendicular to the surface and is a region other than the surface portion. Magnesium is detected from the surface portion and the crack portion. The element whose oxide can be a semiconductor is detected from the surface portion and is one or two selected from nickel and titanium.

Another embodiment of the present invention is a secondary battery including a positive electrode active material. The positive electrode active material contains magnesium and lithium cobalt oxide. Magnesium has a concentration gradient in a surface portion of the positive electrode active material. In EDX line analysis of magnesium contained in the positive electrode active material, when a peak width at a height which is ⅕ of a height of a maximum value of a detected amount of magnesium is divided into two parts by a perpendicular extending from the maximum value to a horizontal axis, a peak width MgW_{core} on an inner portion side is larger than a peak width MgWₛₕₑₗₗ on a surface side.

Another embodiment of the present invention is a secondary battery including a positive electrode active material. The positive electrode active material contains an additive element whose oxide can be a semiconductor, magnesium, and lithium cobalt oxide. The positive electrode active material includes a crack. The positive electrode active material includes a surface portion and a crack portion. The surface portion is a region within 10 nm from a surface other than the crack in a direction substantially perpendicular to the surface. The crack portion is a region within 10 nm from a surface of the crack in a direction substantially perpendicular to the surface and is a region other than the surface portion. Magnesium is detected from the surface portion and the crack portion. The element whose oxide can be a semiconductor is detected from the surface portion. The element whose oxide can be a semiconductor is one or two selected from nickel and titanium. Magnesium has a concentration gradient in a surface portion of the positive electrode active material. In EDX line analysis of magnesium contained in the positive electrode active material, when a peak width at a height which is ⅕ of a height of a maximum value of a detected amount of magnesium is divided into two parts by a perpendicular extending from the maximum value to a horizontal axis, a peak width MgW_{core} on an inner portion side is larger than a peak width MgWₛₕₑₗₗ on a surface side.

In the above, the surface portion and the crack portion preferably contain fluorine.

### Effect of the Invention

According to one embodiment of the present invention, a positive electrode active material that can be used in a lithium-ion secondary battery and in which conductivity is improved and/or insertion and extraction of lithium ions are promoted. A positive electrode active material or a composite oxide that can be used in a lithium-ion secondary battery and that inhibits a decrease in discharge capacity in a low-temperature environment can be provided. Alternatively, a positive electrode active material or a composite oxide that inhibits a decrease in discharge capacity in charge and discharge cycles can be provided. A positive electrode active material or a composite oxide whose crystal structure is not easily broken even when charge and discharge are repeated can be provided. Alternatively, a positive electrode active material or a composite oxide enabling high discharge capacity can be provided. Alternatively, a secondary battery or a vehicle with high safety or high reliability can be provided.

According to one embodiment of the present invention, a positive electrode active material, a composite oxide, a power storage device, or a manufacturing method thereof can be provided.

Note that the description of these effects does not preclude the existence of other effects. One embodiment of the present invention does not need to have all these effects. Other effects will be apparent from and can be derived from the description of the specification, the drawings, the claims, and the like.

### BRIEF DESCRIPTION OF THE DRAWINGS

FIG. 1A is a cross-sectional view of a positive electrode active material, and FIG. 1B is a diagram showing distributions of magnesium, fluorine, and aluminum and a distribution of nickel (Ni) or titanium (Ti).

FIG. 2 is a diagram showing distribution of magnesium.

FIG. 3 is an example of a TEM image showing crystal orientations substantially aligned with each other.

FIG. 4A is an example of a STEM image showing crystal orientations substantially aligned with each other. FIG. 4B is an FFT pattern of a region of a rock-salt crystal RS, and FIG. 4C is an FFT pattern of a region of a layered rock-salt crystal LRS.

FIG. 5 is a diagram illustrating crystal structures of a positive electrode active material.

FIG. 6 is a diagram illustrating crystal structures of a conventional positive electrode active material.

FIG. 7 is a diagram showing XRD patterns calculated from crystal structures.

FIG. 8 is a diagram showing XRD patterns calculated from crystal structures.

FIG. 9A and FIG. 9B are diagrams showing XRD patterns calculated from crystal structures.

FIG. 10 is a cross-sectional view of a positive electrode active material.

FIG. 11 is a diagram showing a formation method of a positive electrode active material.

FIG. 12A to FIG. 12C are diagrams showing a formation method of a positive electrode active material.

FIG. 13A and FIG. 13B are diagrams showing a formation method of a positive electrode active material.

FIG. 14 is a diagram illustrating the appearance of a secondary battery.

FIG. 15A to FIG. 15C are diagrams illustrating a manufacturing method of a secondary battery.

FIG. 16A to FIG. 16H are diagrams illustrating examples of electronic devices.

FIG. 17A to FIG. 17D are diagrams illustrating examples of electronic devices.

FIG. 18A to FIG. 18C are diagrams illustrating examples of electronic devices.

FIG. 19A to FIG. 19C are diagrams illustrating examples of vehicles.

### MODE FOR CARRYING OUT THE INVENTION

Examples of embodiments for carrying out the present invention will be described below with reference to the drawings and the like. Note that the present invention should not be interpreted as being limited to the examples of embodiments given below. Embodiments for carrying out the invention can be changed unless they deviate from the spirit of the present invention.

In this specification and the like, a space group is represented using the short notation of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, space groups, crystal planes, and crystal orientations are sometimes expressed by placing “-” (a minus sign) in front of the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”. A trigonal system represented by the space group R-3m is generally represented by a composite hexagonal lattice for easy understanding of the structure in some cases. In some cases, not only (hkl) but also (hkil) is used as the Miller index. Here, i is −(h+k). In this specification and the like, a crystal plane or the like in the space group R-3m is represented with use of a composite hexagonal lattice, unless otherwise specified.

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

The theoretical capacity of a positive electrode active material refers to the amount of electricity obtained when all lithium that can be inserted into and extracted from the positive electrode active material is extracted. For example, the theoretical capacity of LiCoO₂ is 274 mAh/g, the theoretical capacity of LiNiO₂ is 275 mAh/g, and the theoretical capacity of LiMn₂O₄ is 148 mAh/g.

The remaining amount of lithium that can be inserted into and extracted from a positive electrode active material is represented by x in a compositional formula, e.g., x in LiₓMO₂ (here, Mis one or more selected from cobalt, nickel, and manganese). In the case of a positive electrode active material in a secondary battery, x=(theoretical capacity−charge capacity)/theoretical capacity can be satisfied. For example, in the case where a secondary battery including LiMO₂ as a positive electrode active material is charged to 219.2 mAh/g, the positive electrode active material can be represented by Li_{0.2}MO₂ or x=0.2. The expression “x in LiₓMO₂ is small” means, for example, 0.1<x≤0.24. The amount of lithium extracted from a positive electrode active material with respect to the theoretical capacity is sometimes represented by a charge depth. In this specification and the like, a charge depth is 1-x.

For example, lithium cobalt oxide to be used for a positive electrode, which has been appropriately synthesized and almost satisfies the stoichiometric proportion, is LiCoO₂ with x=1. Lithium cobalt oxide contained in a secondary battery after its discharging ends can also be LiCoO₂ with x=1. Here, “discharge ends” means that a voltage becomes lower than or equal to 3.0 V or lower than or equal to 2.5 V at a current of 100 mA/g or lower, for example.

Charge capacity and/or discharge capacity used for calculation of x in LiₓMO₂ is preferably measured under the condition of no influence or small influence of a short circuit and/or decomposition of an electrolyte solution or the like. For example, data of a secondary battery that is measured while a sudden change in capacity that seems to be derived from a short circuit should not be used for calculation of x.

The space group of a crystal structure is identified by XRD, electron diffraction, neutron diffraction, or the like. Thus, in this specification and the like, belonging to a space group, being attributed to a space group, or being a space group can be rephrased as being identified as a space group.

Furthermore, when the arrangement of anions is close to a cubic close-packed structure, the arrangement can be regarded as the cubic close-packed structure. The arrangement of anions forming the cubic close-packed structure refers to a state where, above voids between anions packed in the first layer, anions in the second layer are positioned, and anions in the third layer are placed at the positions that are right above voids between the anions in the second layer and are not right above the anions in the first layer. Accordingly, anions do not necessarily form a precise cubic lattice structure. In addition, actual crystals always have a defect and thus, analysis results are not necessarily consistent with the theory. For example, in an electron diffraction pattern or an FFT (fast Fourier transform) pattern of a TEM image or the like, a spot may appear in a position slightly different from a theoretical position. For example, anions can be regarded as forming a cubic close-packed structure when the difference in orientation from a theoretical position is less than or equal to 5° or less than or equal to 2.5°.

The distribution of an element refers to a region where the element is successively detected by a successive analysis method to the extent that the detection value is no longer on the noise level. The region where the element is successively detected to the extent that the detection value is no longer on the noise level can be rephrased as, for example, a region where the element is surely detected when the analysis is performed a plurality of times.

A positive electrode active material to which an additive element increasing conductivity and/or an additive element stabilizing a crystal structure are/is added is sometimes referred to as a composite oxide, a positive electrode member, a positive electrode material, a secondary battery positive electrode member, or the like. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

In the case where the features of individual particles of a positive electrode active material are described in the following embodiments and the like, not all the particles necessarily have the features. When 50% or more, preferably 70% or more, further preferably 90% or more of three or more randomly selected particles of a positive electrode active material have the features, for example, it can be said that an effect of improving the characteristics of the positive electrode active material and a secondary battery including the positive electrode active material is sufficiently obtained.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can inhibit a decrease in charge and discharge capacity due to repeated charge and discharge.

Note that the description is made on the assumption that materials (such as a positive electrode active material, a negative electrode active material, an electrolyte, and a separator) of a secondary battery have not been degraded unless otherwise specified. A decrease in discharge capacity due to aging treatment and burn-in treatment during the manufacturing process of a secondary battery is not regarded as deterioration. For example, a state where discharge capacity is greater than or equal to 97% of the rated capacity of a lithium-ion secondary battery cell and an assembled lithium-ion secondary battery (hereinafter, referred to as a lithium-ion secondary battery) can be regarded as a non-degraded state. The rated capacity conforms to JIS C 8711:2019 in the case of a lithium-ion secondary battery for a portable device. The rated capacities of other lithium-ion secondary batteries conform to JIS described above, JIS for electric vehicle propulsion, industrial use, and the like, standards defined by IEC, and the like.

In this specification and the like, in some cases, materials that are included in a secondary battery and that have not been degraded are referred to as initial products or materials in an initial state, and materials that have been degraded (have discharge capacity less than 97% of the rated capacity of the secondary battery) are referred to as products in use, materials in a used state, products that are already used, or materials in an already-used state.

### Embodiment 1

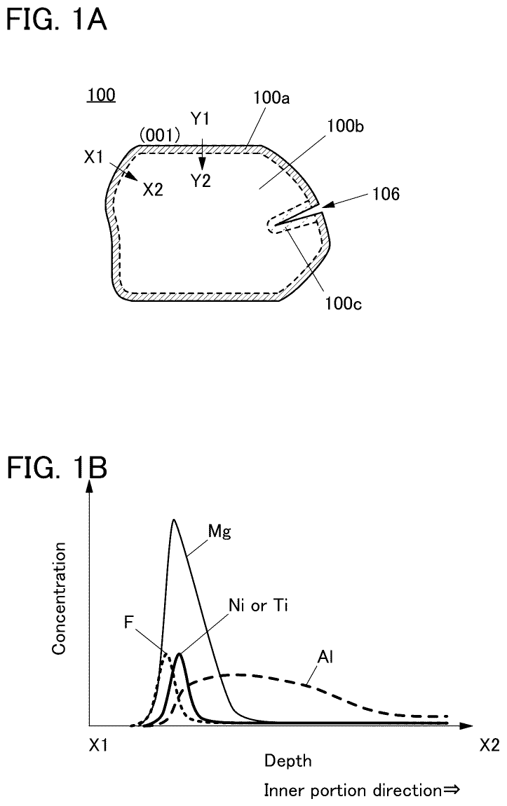

In this embodiment, a positive electrode active material 100 of one embodiment of the present invention is described with reference to FIG. 1 to FIG. 10.

FIG. 1A illustrates a cross section of the positive electrode active material 100 of one embodiment of the present invention. As illustrated in FIG. 1A, the positive electrode active material 100 includes a surface portion 100a and an inner portion 100b. The dashed line in FIG. 1A denotes a boundary between the surface portion 100a and the inner portion 100b. (001) in the drawing represents a (001) plane in the case where the positive electrode active material 100 is LiMO₂ (M is one or more selected from Co, Ni, Mn, and Fe) having a layered rock-salt crystal structure belonging to the space group R-3m.

In this specification and the like, the surface portion 100a of the positive electrode active material 100 refers to a region within 10 nm from the surface in a direction perpendicular or substantially perpendicular to the surface, for example. Note that “substantially perpendicular” refers to an angle greater than or equal to 80° and less than or equal to 100°. The surface portion 100a can be rephrased as the vicinity of the surface, a region in the vicinity of the surface, or a shell.

In the case where the positive electrode active material 100 includes a crack portion 106 as illustrated in FIG. 1A, a region which is within 10 nm from the surface of the crack in a direction perpendicular or substantially perpendicular to the surface and does not overlap with the surface portion 100a is referred to as an inner wall surface portion 100c.

A region which is deeper than the surface portion 100a and the inner wall surface portion 100c of the positive electrode active material is referred to as the inner portion 100b. The inner portion 100b can be rephrased as an inner region or a core.

FIG. 1B is a schematic view of element concentration distribution of the case of measurement from the surface toward the inner portion 100b in analysis of a cross section including the surface and the surface portion 100a of the positive electrode active material 100. Measurement from a surface toward an inner portion is also referred to as measurement in a depth direction, and arrows X1-X2 and Y1-Y2 in FIG. 1A are examples of the depth direction.

In the case where the positive electrode active material 100 has a layered rock-salt crystal structure belonging to the space group R-3m, the surface portion 100a includes an edge region and a basal region. Here, the edge region includes a surface exposed in a direction intersecting the (001) plane (also referred to as a surface having an orientation other than the (001) orientation), and a region within 10 nm from the surface in a direction perpendicular or substantially perpendicular to the surface is referred to as the edge region. Here, “intersect” means that an angle between the line perpendicular to the first plane (the (001) plane) and the line normal to the second plane (the surface of the positive electrode active material 100) is greater than or equal to 10° and less than or equal to 90°, preferably greater than or equal to 30° and less than or equal to 90°, further preferably greater than or equal to 50° and less than or equal to 90°.

The basal region has a surface parallel to the (001) plane (also referred to as a surface having the (001) orientation), and a region within 10 nm from the surface in a direction perpendicular or substantially perpendicular to the surface is referred to as a basal region. Here, “parallel” means that an angle between a line perpendicular to a first plane (the (001) plane) and a line normal to a second plane (a surface of the positive electrode active material 100) is greater than or equal to 0° and less than 10°, preferably greater than or equal to 0° and less than or equal to 5°, further preferably greater than or equal to 0° and less than or equal to 2.5°.

A surface of the positive electrode active material 100 refers to a surface of a composite oxide including the surface portion 100a and the inner portion 100b. Thus, the positive electrode active material 100 does not contain a material to which a metal oxide that does not contain a lithium site contributing to charge and discharge, such as aluminum oxide (Al₂O₃), is attached, or a carbonate, a hydroxy group, or the like which is chemically adsorbed after formation of the positive electrode active material. Note that the attached metal oxide refers to, for example, a metal oxide having a crystal orientation different from that of the inner portion 100b.

Furthermore, an electrolyte, an organic solvent, a binder, a conductive material, and a compound originating from any of these that are attached to the positive electrode active material 100 are not included either in the positive electrode active material 100.

Although not illustrated, the positive electrode active material 100 may have a crystal grain boundary. A crystal grain boundary refers to, for example, a portion where particles of the positive electrode active material 100 adhere to each other, or a portion where a crystal orientation changes inside the positive electrode active material 100, i.e., a portion where repetition of bright lines and dark lines is discontinuous in a STEM image or the like, a portion including a large number of crystal defects, a portion with a disordered crystal structure, or the like. A crystal defect refers to a defect that can be observed in a cross-sectional TEM (transmission electron microscope) image, a cross-sectional STEM image, or the like, i.e., a structure containing another atom between lattices, a cavity, or the like. A crystal grain boundary can be regarded as a plane defect. The vicinity of a crystal grain boundary refers to a region within 10 nm from the crystal grain boundary.

### <Contained Element>

The positive electrode active material 100 contains lithium, a transition metal M, oxygen, and an additive element whose oxide can be a semiconductor. The additive element stabilizing the crystal structure is preferably also contained. “Additive element” is simply used as a superordinate concept of the additive element whose oxide can be a semiconductor and the additive element stabilizing the crystal structure in some cases.

The transition metal M is one or more selected from cobalt, nickel, manganese, and iron.

The positive electrode active material 100 can have a layered rock-salt crystal structure, a spinel crystal structure, or an olivine crystal structure, for example. Specifically, the positive electrode active material 100 can contain lithium cobalt oxide (LCO), lithium nickel cobalt manganese oxide (NCM), lithium nickel cobalt aluminum oxide (NCA) that each have a layered rock-salt crystal structure, LiMnO₂ having a spinel crystal structure, lithium iron phosphate (LFP) having an olivine crystal structure, or the like.

In particular, the positive electrode active material 100 preferably contains a composite oxide of lithium and the transition metal M having a layered rock-salt crystal structure (LiMO₂) to which an additive element is added. Note that in this case, the positive electrode active material 100 of one embodiment of the present invention has a distribution of the additive element or a crystal structure described later. Thus, the composition is not strictly limited to Li:M:O=1:1:2 (atomic ratio).

A positive electrode active material of a lithium-ion secondary battery needs to contain a transition metal that can be oxidized or reduced in order to maintain a neutrally charged state even when lithium ions are inserted and extracted. It is preferable that the positive electrode active material 100 of one embodiment of the present invention mainly contain cobalt as the transition metal M taking part in an oxidation-reduction reaction. When cobalt accounts for higher than or equal to 75 at %, preferably higher than or equal to 90 at %, further preferably higher than or equal to 95 at % of the transition metal contained in the positive electrode active material 100, there are many advantages such as relatively easy synthesis, easy handling, and excellent cycle performance, which is preferable.

When cobalt accounts for greater than or equal to 75 atomic %, preferably greater than or equal to 90 atomic %, further preferably greater than or equal to 95 atomic % of the transition metal M of the positive electrode active material 100, the stability when much lithium is released by charging is higher than that of a composite oxide in which nickel accounts for the majority of the transition metal, such as lithium nickel oxide (LiNiO₂). This is probably because the influence of distortion by the Jahn-Teller effect is smaller in the case of using cobalt than in the case of using nickel. The Jahn-Teller effect in a transition metal compound varies in degree according to the number of electrons in the d orbital of the transition metal. The influence of the Jahn-Teller effect is large in a composite oxide having a layered rock-salt crystal structure, such as lithium nickel oxide, in which octahedral coordinated low-spin nickel (III) accounts for the majority of the transition metal M, and a layer formed of octahedrons of nickel and oxygen is likely to be distorted.

Thus, a concern that the crystal structure might break in charge and discharge cycles grows. The size of a nickel ion is larger than the size of a cobalt ion and close to that of a lithium ion. Thus, there is a problem in that cation mixing between nickel and lithium is likely to occur in a composite oxide having a layered rock-salt crystal structure in which nickel accounts for the majority of the transition metal M, such as lithium nickel oxide.

### [Additive Element Whose Oxide can be a Semiconductor]

As the additive element whose oxide can be a semiconductor, the positive electrode active material 100 can contain one or more selected from nickel, titanium, copper, ruthenium, vanadium, niobium, chromium, molybdenum, tungsten, rhenium, osmium, rhodium, iridium, lanthanum, and strontium, for example. In this specification and the like, the additive element whose oxide can be a semiconductor refers to the metal whose oxide has an electrical resistivity (literature value) higher than or equal to 1×10⁻⁸ S/cm and which has characteristics where the electrical resistance reduces as a temperature rises. It is expected that containing such an additive element reduces the resistance at the interface between the surface of the positive electrode active material 100 and the electrolyte solution. In addition, the impedance of a secondary battery using the positive electrode active material 100 is expected to decrease.

When the additive element whose oxide can be a semiconductor, such as nickel or titanium, exists in the surface portion 100a, it is expected that the additive element offers the effect of increasing the conductivity of the positive electrode active material 100 and/or the effect of promoting insertion and extraction of lithium ions into and from the positive electrode active material. Furthermore, when additive element whose oxide can be a semiconductor is contained in the surface portion 100a, the impedance of the positive electrode active material 100 is expected to decrease. An oxide of the additive element such as magnesium stabilizing the crystal structure exhibits an insulating property, and it is considered that when the additive element whose oxide can be a semiconductor is contained, the insulating property can be relieved.

On the other hand, depending on the additive element whose oxide can be a semiconductor, the crystal structure of the positive electrode active material 100 might be distorted when the concentration of the additive element whose oxide can be a semiconductor is too high or a region containing only the additive element whose oxide can be a semiconductor is too large. For example, in the case of titanium, it is difficult to obtain LiTiO₂ having a layered rock-salt structure in a stable phase; thus, there is a concern for using titanium as the additive element for the positive electrode active material having a layered rock-salt crystal structure. Meanwhile, in the case of nickel, since LiNiO₂ having a layered rock-salt crystal structure is relatively stable, nickel is less likely to distort the layered rock-salt crystal structure than titanium, and thus further preferable as the additive element used for the positive electrode active material having a layered rock-salt crystal structure.

As the additive element stabilizing the crystal structure, one or two or more selected from magnesium, aluminum, fluorine, zirconium, iron, manganese, chromium, arsenic, zinc, silicon, sulfur, phosphorus, boron, bromine, and beryllium is preferably used.

That is, the positive electrode active material 100 can contain lithium cobalt oxide to which magnesium and nickel are added, lithium cobalt oxide to which magnesium, nickel, and fluorine are added, lithium cobalt oxide to which magnesium, nickel, aluminum, and titanium are added, lithium cobalt oxide to which magnesium, nickel, aluminum, titanium, and fluorine are added or the like.

The additive element whose oxide can be a semiconductor and the additive element stabilizing the crystal structure preferably form a solid solution with the positive electrode active material 100. Thus, in STEM-EDX line analysis, for example, a depth at which the detected amount of these additive elements increases is preferably at a deeper position than a depth at which the detected amount of transition metal M increases, i.e., on the inner portion side of the positive electrode active material 100.

In this specification and the like, the depth at which the detected amount of an element increases in STEM-EDX line analysis refers to the depth at which a measured value, which can be determined not to be a noise in terms of intensity, spatial resolution, and the like, is successively obtained.

In this specification and the like, the additive element can be rephrased as part of a raw material or a mixture.

Note that as the additive element whose oxide can be a semiconductor, nickel, titanium, copper, ruthenium, vanadium, niobium, chromium, molybdenum, tungsten, rhenium, osmium, rhodium, iridium, lanthanum, or strontium is not necessarily contained. As the additive element stabilizing the crystal structure, fluorine, zirconium, iron, manganese, chromium, arsenic, zinc, silicon, sulfur, phosphorus, boron, bromine, or beryllium is not necessarily contained.

When the positive electrode active material 100 is substantially free from manganese, for example, the above advantages such as relatively easy synthesis, easy handling, and excellent cycle performance are enhanced. The weight of manganese contained in the positive electrode active material 100 is preferably less than or equal to 600 ppm, further preferably less than or equal to 100 ppm, for example.

The positive electrode active material 100 contains the above-described additive element in the surface portion 100a. It is further preferable that the positive electrode active material 100 contain a plurality of additive elements. The concentration(s) of one or two or more selected from the additive elements is/are preferably higher in the surface portion 100a than in the inner portion 100b. Alternatively, the detected amount(s) of one or two or more selected from the additive elements is/are preferably larger in the surface portion 100a than in the inner portion 100b. The one or two or more selected from the additive elements contained in the positive electrode active material 100 preferably have a concentration gradient. The detected amount refers to counts in EDX line analysis, for example.

In addition, it is preferable that the additive elements contained in the positive electrode active material 100 be distributed differently, not similarly. For example, it is preferable that the additive elements exhibit peaks at different depths. The peak in this case refers to the local maximum value of the detected amount in the surface portion 100a or a region within 50 nm from the surface. The depth in this case refers to the depth from a reference point in EDX line analysis described later or the surface. [Distribution]

In order to obtain an effect of stabilizing the crystal structure of the positive electrode active material 100 and an effect of reducing resistance at the interface between the surface and the electrolyte solution, at least magnesium and nickel or titanium among the additive elements preferably have a higher concentration in the surface portion 100a than in the inner portion 100b. Alternatively, the detected amounts of at least magnesium and nickel or titanium are preferably larger in the surface portion 100a than in the inner portion 100b. It is further preferable that peaks of the detected amounts be observed in a region of the surface portion 100a that is closer to the surface. For example, the peaks of the detected amounts are preferably observed in a region within 3 nm from the surface or the reference point. The distribution of magnesium and that of nickel preferably overlap with each other. In the depth direction analysis, peak of the detected amount of magnesium and that of the detected amount of nickel may be observed at the same depth, the peak of magnesium may be observed closer to the surface, or the peak of nickel may be observed closer to the surface. The difference in depth between the peak of the detected amount of nickel and the peak of the detected amount of magnesium is preferably less than or equal to 3 nm, further preferably less than or equal to 1 nm. In addition, the half widths of the detected amounts are preferably small.

Similarly, the distribution of magnesium and that of titanium preferably overlap with each other. The peak of the detected amount of magnesium and that of the detected amount of titanium may be observed at the same depth, the peak of magnesium may be observed closer to the surface, or the peak of titanium may be observed closer to the surface. The difference in depth between the peak of the detected amount of titanium and the peak of the detected amount of magnesium is preferably less than or equal to 3 nm, further preferably less than or equal to 1 nm. In addition, the half widths of the detected amounts are preferably small.

Similarly, in the case where magnesium, nickel, and titanium are contained, distributions thereof preferably overlap with each other. The difference in depth among the peak of the detected amount of titanium, the peak of the detected amount of nickel, and the peak of the detected amount of magnesium is preferably less than or equal to 3 nm, further preferably less than or equal to 1 nm. In addition, the half widths of the detected amounts are preferably small.

A region where the distributions of magnesium and nickel overlap with each other, a region where the distributions of magnesium and titanium overlap with each other, or a region where the distributions of magnesium, nickel, and titanium overlap with each other is preferably in the edge region where lithium ions are inserted and extracted in the surface portion 100a. That is, the distributions of the additive elements shown in the schematic view in FIG. 1B are preferably observed in depth direction analysis of the edge region such as the arrow X1-X2 in FIG. 1A. On the other hand, in the surface portion 100a, the overlaps of the distributions of the additive elements described above are not necessarily required in depth direction analysis of the basal region such as the arrow Y1-Y2.

In STEM-EDX analysis of the positive electrode active material containing a large amount of cobalt as the transition metal M, the detected amount of nickel in the inner portion 100b is much smaller than that in the surface portion 100a or less than or equal to 1 atomic %, or no nickel is detected in the inner portion 100b in some cases.

As in the case of magnesium or nickel, the detected amount of fluorine is preferably larger in the surface portion 100a than in the inner portion. A peak of the detected amount is preferably observed in a region of the surface portion 100a that is closer to the surface. For example, the peak of the detected amount is preferably observed in a region within 3 nm from the surface or the reference point. Similarly, the detected amounts of titanium, silicon, phosphorus, boron, and/or calcium are/is also preferably larger in the surface portion 100a than in the inner portion. Peaks of the detected amounts are preferably observed in a region of the surface portion 100a that is closer to the surface. For example, the peaks of the detected amounts are preferably observed in a region within 3 nm from the surface or the reference point in STEM-EDX line analysis.

It is further preferable that a peak of the magnesium concentration be observed slightly closer to the inner portion than the peak of the fluorine concentration is. In other words, a peak of the fluorine concentration is preferably observed slightly closer to the outer side than the magnesium concentration is. This can further improve the resistance to hydrofluoric acid in the case where hydrofluoric acid is contained in the electrolyte solution as an impurity. For example, it is preferable that a peak of the magnesium concentration be observed closer to the inner portion side than a peak of the fluorine concentration is by 0.5 nm or more, further preferably 1.5 nm or more.

A peak of the detected amount of at least aluminum among the additive elements is preferably observed in a region that is located inward from a region in which peaks of the detected amounts of magnesium and titanium are observed. Although the distributions of magnesium and aluminum may overlap with each other as shown in FIG. 1B, they may have almost no overlapping region. The peak of the detected amount of aluminum may be located in the surface portion 100a or may be located deeper than the surface portion 100a. For example, the peak is preferably observed in a region of greater than or equal to 5 nm and less than or equal to 30 nm toward the inner portion from the surface or the reference point.

When aluminum is distributed as described above, the layered rock-salt crystal structure of the positive electrode active material 100 can be more stable. For example, a change from a layered rock-salt crystal structure to a spinel crystal structure in the surface portion 100a of the positive electrode active material 100 is expected to be inhibited.

Aluminum can be distributed more inwardly than magnesium and titanium presumably because the diffusion rate of aluminum is high. Meanwhile, the detected amount of aluminum is small in the region that is closest to the surface presumably because aluminum can exist more stably in a region other than the region where magnesium or the like forms a solid solution at a high concentration.

To be specific, in a region having a layered rock-salt crystal structure belonging to the space group R-3m or a cubic rock-salt crystal structure, the distance between a cation and oxygen in a region where magnesium at a high concentration forms a solid solution is longer than the distance in LiAlO₂ having a layered rock-salt crystal structure, and thus aluminum is difficult to exist stably. In the vicinity of cobalt, valence change due to substitution of Mg²⁺ for Li⁺ can be compensated for by Co³⁺ becoming Co²⁺, so that cation balance can be maintained. By contrast, Al is always trivalent and is thus presumed to be less likely to exist stably in the vicinity of magnesium in a rock-salt or layered rock-salt crystal structure.

Although not illustrated, in the case where the positive electrode active material 100 contains manganese, a peak of the detected amount of manganese is preferably observed in a region that is located inward from the region in which the peak of the detected amount of magnesium is observed in STEM-EDX line analysis, as in the case of aluminum.

Note that the additive elements do not necessarily have similar concentration gradients and similar distributions throughout the surface portion 100a and the inner wall surface portion 100c of the positive electrode active material 100. [Crack portion]

For example, some of the additive elements detected in the surface portion 100a are not necessarily detected in the inner wall surface portion 100c. It is particularly preferable that the additive element whose oxide can be a semiconductor (e.g., titanium or nickel) not be detected or be detected at 1 atomic % or less in the inner wall surface portion 100c. It is particularly preferable that the additive element whose oxide can be a semiconductor not be detected or be detected at 1 atomic % or less in a deep portion of the inner wall surface portion 100c, e.g., a region of greater than or equal to 300 nm from the surface. “The additive element is not detected” here means that the detected amount of the element is lower than or equal to the lower detection limit in STEM-EDX analysis, for example.

The crack portion 106 is a portion that might be deeper or wider as deterioration proceeds. When the crack becomes deeper or wider, the positive electrode active material 100 might be cracked and a conduction path might be lost, for example, which leads to a serious reduction in capacity. Meanwhile, the area of the inner wall surface portion 100c facing the crack portion 106 is much smaller than that of the surface portion 100a. Thus, the inner wall surface portion 100c is a region where inhibition of deterioration takes precedence over a function of a diffusion path of lithium ions. Accordingly, it is preferable that the additive element whose oxide can be a semiconductor, which is expected to promote insertion and extraction of lithium ions, do not exist or exist in small amounts in the inner wall surface portion 100c.

On the other hand, the additive element in a shallow portion of the inner wall surface portion 100c, e.g., a region of less than 300 nm from the surface, hardly affects crack development; thus, even when the additive element whose oxide can be a semiconductor is detected in the portion, it does not become a big problem.

Note that in the positive electrode active material 100, the crack portion 106 is preferably small in number or shallow, and most preferably, no crack portion 106 exists.

Furthermore, the additive element may be distributed in an island shape in the surface portion 100a, or the distribution tendency of the additive element may vary depending on the crystal plane. In the case where the positive electrode active material 100 has a layered rock-salt crystal structure belonging to the space group R-3m, the distribution of the additive elements at the surface having the (001) orientation of the positive electrode active material 100 may be different from the distribution of the additive elements at other surfaces. For example, the surface having the (001) orientation and the surface portion 100a thereof may have a lower detected amount of one or two or more elements selected from the additive elements than a surface having an orientation other than the (001) orientation. Specifically, the detected amount(s) of one or two or more among magnesium, nickel, and titanium may be small. Alternatively, at the surface having the (001) orientation and the surface portion 100a thereof, one or two or more selected from the additive elements may be detected at 1 atomic % or less, or may not be detected in STEM-EDX analysis. Specifically, it is acceptable that nickel is not detected or the detected amount thereof is less than or equal to 1 atomic %. Especially in the case of an analysis method, e.g., EDX, by which characteristic X-rays are detected, the energy of Ks for cobalt is close to that of K_{α} for nickel, and it is thus difficult to detect a slight amount of nickel in a material whose main element is cobalt.

Alternatively, the peaks of the detected amounts of one or two or more selected from the additive elements at the surface having the (001) orientation and the surface portion 100a thereof may be located shallower from the surface than the peaks at the surface having an orientation other than the (001) orientation. Specifically, the peaks of the detected amounts of magnesium and aluminum may be located shallower than the peaks at another surface.

In a layered rock-salt crystal structure belonging to the space group R-3m, cations are arranged parallel to the (001) plane. In other words, MO₂ layers and lithium layers are alternately stacked parallel to the (001) plane. Accordingly, a diffusion path of lithium ions also exists parallel to the (001) plane.

The MO₂ layer is relatively stable and thus, the surface of the positive electrode active material 100 is more stable when having the (001) orientation. A main diffusion path of lithium ions in charge and discharge is not exposed at the (001) plane.

By contrast, a diffusion path of lithium ions is exposed at a surface having an orientation other than the (001) orientation. Thus, the surface having an orientation other than the (001) orientation and the surface portion 100a thereof easily lose stability because they are regions where extraction of lithium ions starts as well as important regions for maintaining a diffusion path of lithium ions. It is thus extremely important to reinforce the surface having an orientation other than the (001) orientation and the surface portion 100a thereof so that the crystal structure of the whole positive electrode active material 100 is maintained.

Accordingly, in the positive electrode active material 100 of another embodiment of the present invention, it is important that the distribution of the additive element at the surface having an orientation other than the (001) orientation and the surface portion 100a thereof is the distribution shown in FIG. 1B, for example. In particular, among the additive elements, nickel is preferably detected at the surface having an orientation other than the (001) orientation and the surface portion 100a thereof. By contrast, at the surface having the (001) orientation and the surface portion 100a thereof, the concentration of the additive element may be low as described above or the additive element may be absent.

For example, the half width of the distribution of magnesium at the surface having the (001) orientation and the surface portion 100a thereof is preferably greater than or equal to 10 nm and less than or equal to 200 nm, further preferably greater than or equal to 50 nm and less than or equal to 150 nm, still further preferably greater than or equal to 80 nm and less than or equal to 120 nm. The half width of the distribution of magnesium at the surface not having the (001) orientation and the surface portion 100a thereof is preferably greater than 200 nm and less than or equal to 500 nm, further preferably greater than 200 nm and less than or equal to 300 nm, still further preferably greater than or equal to 230 nm and less than or equal to 270 nm.

The half width of the distribution of nickel at the surface not having the (001) orientation and the surface portion 100a thereof is preferably greater than or equal to 30 nm and less than or equal to 150 nm, further preferably greater than or equal to 50 nm and less than or equal to 130 nm, still further preferably greater than or equal to 70 nm and less than or equal to 110 nm.

In the formation method as described in an embodiment below, in which high-purity LiMO₂ is formed, the additive element is mixed afterwards, and heating is performed, the additive element spreads mainly through a diffusion path of lithium ions. Thus, the distribution of the additive element at the surface having an orientation other than the (001) orientation and the surface portion 100a thereof can easily fall within a preferred range.

### [Distribution of Magnesium]

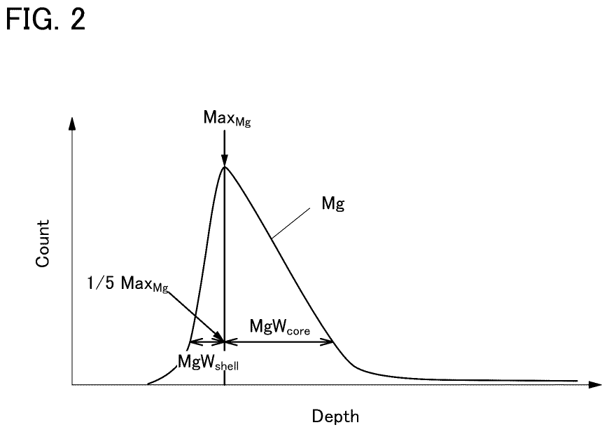

The additive element distribution in the depth direction is not normal distribution in some cases. For example, as shown in FIG. 2, when the magnesium distribution in the depth direction analysis is divided by the peak, i.e., the maximum value Max_{Mg} of the number of counts, inclination might be different between the surface side and the inner portion side. For example, the surface side is steep and the inner portion side has a gentle-slope shape in some cases. More specifically, when the peak width at the height (⅕ Max_{Mg}) that is ⅕ of the height of the maximum value (Max_{Mg}) of the detected amount of magnesium is divided into two parts by a perpendicular extending from the maximum value to the horizontal axis, the peak width MgW_{core} on the inner portion side is sometimes larger than the peak width MgWₛₕₑₗₗ on the surface side.

The distribution of magnesium in the depth direction in FIG. 2 means that the magnesium concentration in a region close to the outermost surface is sufficiently high and the magnesium concentration gradually decreases toward the inner portion. Accordingly, it can be said that a function of a barrier film in the outermost surface is enhanced and the orientations of crystals in the surface portion 100a and the inner portion 100b are likely to be substantially aligned with each other with this distribution.

### [Magnesium]

Magnesium is divalent, and a magnesium ion is more stable at lithium sites than at cobalt sites in a layered rock-salt crystal structure; thus, magnesium is likely to enter the lithium sites. An appropriate magnesium concentration at the lithium sites of the surface portion 100a can facilitate the maintenance of the layered rock-salt crystal structure. This is presumably because magnesium at the lithium sites serves as a pillar supporting MO₂ layers. Moreover, the presence of magnesium can inhibit release of oxygen therearound in a state where x in LiₓCoO₂ is, for example, less than or equal to 0.24. The presence of magnesium is also expected to increase the density of the positive electrode active material 100. In addition, a high magnesium concentration in the surface portion 100a can be expected to increase the corrosion resistance to hydrofluoric acid generated by the decomposition of the electrolyte solution.

An appropriate concentration of magnesium can bring the above-described advantages without an adverse effect on insertion and extraction of lithium in charge and discharge. However, excess magnesium might adversely affect insertion and extraction of lithium. Furthermore, the effect of stabilizing the crystal structure might be reduced. This is probably because magnesium enters the cobalt sites in addition to the lithium sites. Moreover, an undesired magnesium compound (e.g., an oxide and fluoride) which is substituted for neither the lithium site nor the cobalt site might segregate at the surface of the positive electrode active material or the like to serve as a resistance component of a secondary battery. As the magnesium concentration of the positive electrode active material increases, the discharge capacity of the positive electrode active material decreases in some cases. This is probably because excess magnesium enters the lithium sites and the amount of lithium contributing to charge and discharge decreases.

Thus, the entire positive electrode active material 100 preferably contains an appropriate amount of magnesium. For example, the number of magnesium atoms is preferably greater than or equal to 0.002 times and less than or equal to 0.06 times, further preferably greater than or equal to 0.005 times and less than or equal to 0.03 times, still further preferably approximately 0.01 times the number of cobalt atoms. The amount of magnesium contained in the entire positive electrode active material 100 here may be, for example, a value obtained by element analysis on the entire positive electrode active material 100 with GD-MS, ICP-MS, or the like or may be a value based on the ratio of the raw materials mixed in the process of forming the positive electrode active material 100.

### [Nickel]

Nickel in a layered rock-salt crystal structure of LiMO₂ can exist at both the cobalt site and the lithium site. Since nickel has a lower oxidation-reduction potential than cobalt, the presence of nickel at the cobalt site can facilitate release of lithium and electrons during charging, for example. As a result, the charge and discharge speed is expected to be increased.

Accordingly, at the same charge voltage, the charge and discharge capacity of the case of the transition metal M being nickel can be higher than that of the case of the transition metal M being cobalt.

In addition, when nickel exists at a lithium site, a shift in the layered structure formed of octahedrons of cobalt and oxygen can be inhibited. Moreover, a change in volume in charge and discharge is inhibited. Furthermore, an elastic modulus becomes large, i.e., hardness increases. This is probably because nickel at the lithium sites also serves as a pillar supporting the MO₂ layers. Thus, in particular, the crystal structure is expected to be more stable in a charged state at high temperatures, e.g., higher than or equal to 45° C., which is preferable.

The distance between a cation and an anion of nickel oxide (NiO) is closer to the average of the distance between a cation and an anion of LiCoO₂ than those of rock-salt MgO and rock-salt CoO, and the orientations of NiO and LiCoO₂ are likely to be aligned with each other.

Ionization tendency decreases in the order of magnesium, aluminum, cobalt, and nickel (Mg>Al>Co>Ni). Thus, it is considered that in charging, nickel is less likely to be dissolved into an electrolyte solution than the other elements described above. Accordingly, nickel is considered to have a high effect of stabilizing the crystal structure of the surface portion in a charged state.

Furthermore, in nickel, Ni²⁺ is more stable than Ni³⁺ and Ni⁴⁺, and nickel has higher trivalent ionization energy than cobalt. Thus, it is known that a spinel crystal structure does not appear only with nickel and oxygen. Thus, nickel is considered to have an effect of inhibiting a phase change from a layered rock-salt crystal structure to a spinel crystal structure.

Meanwhile, excessive nickel increases the influence of distortion due to the Jahn-Teller effect, which is not preferable. Moreover, excess nickel might adversely affect insertion and extraction of lithium.

Thus, the entire positive electrode active material 100 preferably contains an appropriate amount of nickel. For example, in the positive electrode active material 100, the number of nickel atoms is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, the number of nickel atoms is preferably greater than 0% and less than or equal to 4% of the number of cobalt atoms. Alternatively, the number of nickel atoms is preferably greater than 0% and less than or equal to 2% of the number of cobalt atoms. Alternatively, the number of nickel atoms is preferably greater than or equal to 0.05% and less than or equal to 7.5% of the number of cobalt atoms.

Alternatively, the number of nickel atoms is preferably greater than or equal to 0.05% and less than or equal to 2% of the number of cobalt atoms. Alternatively, the number of nickel atoms is preferably greater than or equal to 0.1% and less than or equal to 7.5% of the number of cobalt atoms. Alternatively, the number of nickel atoms is preferably greater than or equal to 0.1% and less than or equal to 4% of the number of cobalt atoms. The amount of nickel described here may be a value obtained by element analysis on the entire positive electrode active material with GD-MS, ICP-MS, or the like or may be a value based on the ratio of the raw materials mixed in the process of forming the positive electrode active material, for example.

### [Aluminum]

Aluminum can exist at the cobalt site in a layered rock-salt crystal structure. Since aluminum is a trivalent representative element and its valence does not change, lithium around aluminum is less likely to move even in charge and discharge. Thus, aluminum and lithium around aluminum serve as columns to inhibit a change in the crystal structure. This would inhibit degradation of the positive electrode active material 100 if force of expansion and contraction of the positive electrode active material 100 in the c-axis direction operates owing to insertion and extraction of lithium ions, i.e., owing to a change in charge depth or charge rate, as described later.

Furthermore, aluminum has an effect of inhibiting dissolution of cobalt around aluminum and improving continuous charging tolerance. Moreover, an Al—O bond is stronger than a Co—O bond and thus release of oxygen around aluminum can be inhibited. These effects improve thermal stability. Thus, a secondary battery that includes the positive electrode active material 100 containing aluminum as the additive element can have higher level of safety. In addition, the positive electrode active material 100 having a crystal structure that is less likely to be broken by repeated charge and discharge can be provided.

Meanwhile, excess aluminum might adversely affect insertion and extraction of lithium.

Thus, the entire positive electrode active material 100 preferably contains an appropriate amount of aluminum. For example, in the entire positive electrode active material 100, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2% of the number of cobalt atoms. Alternatively, it is preferably greater than or equal to 0.1% and less than or equal to 4% of the number of cobalt atoms. Here, the amount of aluminum contained in the entire positive electrode active material 100 may be a value obtained by element analysis on the entire positive electrode active material 100 with GD-MS, ICP-MS, or the like or may be a value based on the ratio of the raw materials mixed in the process of forming the positive electrode active material 100, for example.

### [Fluorine]

When fluorine, which is a monovalent anion, is substituted for part of oxygen in the surface portion 100a, the lithium extraction energy is lowered. This is because the oxidation-reduction potential of cobalt ions associated with lithium extraction differs depending on the presence or absence of fluorine. That is, when fluorine is not contained, cobalt ions change from a trivalent state to a tetravalent state owing to lithium extraction. Meanwhile, when fluorine is contained, cobalt ions change from a divalent state to a trivalent state owing to lithium extraction.

The oxidation-reduction potential of cobalt ions differs in these cases. It can thus be said that when fluorine is substituted for part of oxygen in the surface portion 100a of the positive electrode active material 100, lithium ions near fluorine are likely to be extracted and inserted smoothly. Thus, a secondary battery including the positive electrode active material 100 can have improved charge and discharge characteristics, improved large current characteristics, or the like. When fluorine exists at the surface portion 100a including the surface that is in contact with an electrolyte solution, or when a fluoride is attached to the surface, an overreaction between the positive electrode active material 100 and the electrolyte solution can be inhibited. In addition, the corrosion resistance to hydrofluoric acid can be effectively increased.

In the case where a fluoride such as lithium fluoride has a lower melting point than another additive element source, the fluoride can serve as a fusing agent (also referred to as a flux) for lowering the melting point of the another additive element source. In the case where the fluoride contains LiF and MgF₂, since the eutectic point of LiF and MgF₂ is around 742° C., the heating temperature in the heating step after the mixing of the additive element is preferably higher than or equal to 742° C., and further preferably higher than or equal to 830° C. The heating temperature may be higher than or equal to 800° C. between the above temperatures.

### [Other Additive Elements]

The surface portion 100a preferably contains phosphorus, in which case a short circuit can be sometimes inhibited while a state with small x in LiₓCoO₂ is maintained. For example, a compound containing phosphorus and oxygen preferably exists in the surface portion 100a.

The positive electrode active material 100 preferably contains phosphorus, in which case the phosphorus reacts with hydrogen fluoride generated by the decomposition of the electrolyte solution or the electrolyte, which can reduce the hydrogen fluoride concentration in the electrolyte.

In the case where the electrolyte contains LiPF₆, hydrogen fluoride might be generated by hydrolysis. Furthermore, hydrogen fluoride might be generated by the reaction of polyvinylidene fluoride (PVDF) used as a component of the positive electrode and alkali. The decrease in the concentration of hydrogen fluoride in the electrolyte can inhibit corrosion of a current collector and/or separation of a coating portion 104 in some cases. Furthermore, a reduction in adhesion properties due to gelling and/or insolubilization of PVDF can be inhibited in some cases.

The positive electrode active material 100 preferably contains magnesium and phosphorus, in which case the stability in a state with small x in LiₓCoO₂ is extremely high. In the case where the positive electrode active material 100 contains phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, the number of phosphorus atoms is preferably greater than or equal to 1% and less than or equal to 10% of the number of cobalt atoms. Alternatively, the number of phosphorus atoms is preferably greater than or equal to 1% and less than or equal to 8% of the number of cobalt atoms. Alternatively, the number of phosphorus atoms is preferably greater than or equal to 2% and less than or equal to 20% of the number of cobalt atoms. Alternatively, the number of phosphorus atoms is preferably greater than or equal to 2% and less than or equal to 8% of the number of cobalt atoms. Alternatively, the number of phosphorus atoms is preferably greater than or equal to 3% and less than or equal to 20% of the number of cobalt atoms. Alternatively, the number of phosphorus atoms is preferably greater than or equal to 3% and less than or equal to 10% of the number of cobalt atoms. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, the number of magnesium atoms is preferably greater than or equal to 0.1% and less than or equal to 5% of the number of cobalt atoms. Alternatively, the number of magnesium atoms is preferably greater than or equal to 0.1% and less than or equal to 4% of the number of cobalt atoms. Alternatively, the number of magnesium atoms is preferably greater than or equal to 0.5% and less than or equal to 10% of the number of cobalt atoms. Alternatively, the number of magnesium atoms is preferably greater than or equal to 0.5% and less than or equal to 4% of the number of cobalt atoms. Alternatively, the number of magnesium atoms is preferably greater than or equal to 0.7% and less than or equal to 10% of the number of cobalt atoms. Alternatively, the number of magnesium atoms is preferably greater than or equal to 0.7% and less than or equal to 5% of the number of cobalt atoms. The phosphorus concentration and the magnesium concentration described here may each be a value obtained by element analysis on the entire positive electrode active material 100 using GD-MS, ICP-MS, or the like, or may be a value based on the ratio of the raw materials mixed in the process of forming the positive electrode active material 100, for example.

In the case where the positive electrode active material 100 has a crack, crack development can be inhibited by phosphorus, more specifically, a compound containing, for example, phosphorus and oxygen, being in the inner portion, e.g., a filling portion, of the positive electrode active material having the crack on its surface.

### [Synergistic Effect of a Plurality of Additive Elements]

When the surface portion 100a contains both magnesium and nickel, divalent nickel might be able to exist more stably in the vicinity of divalent magnesium. Thus, even when x in

LiₓMO₂ is small, dissolution of magnesium can be inhibited. This might contribute to stabilization of the surface portion 100a.

For a similar reason, when the additive element is added to lithium cobalt oxide in the formation process, magnesium is preferably added in a step before a step where nickel is added. Alternatively, magnesium and nickel are preferably added in the same step. Magnesium has a large ion radius and thus easily remains in the surface portion of lithium cobalt oxide regardless of in which step magnesium is added, but nickel may be widely diffused to the inner portion of lithium cobalt oxide when magnesium does not exist. Thus, when nickel is added before magnesium is added, nickel might be diffused to the inner portion of lithium cobalt oxide and a preferable amount of nickel might not remain in the surface portion.

Additive elements that are differently distributed are preferably contained at a time, in which case the crystal structure of a wider region can be stabilized. For example, a stable crystal structure can be obtained in a wide region in the case where the positive electrode active material 100 contains, in the surface portion 100a, magnesium and nickel distributed in a region closer to the surface and aluminum distributed in a region deeper than magnesium and nickel, as compared with the case where only magnesium and nickel are contained or the case where only aluminum is contained. In the case where the positive electrode active material 100 contains the additive elements that are differently distributed as described above, the surface can be sufficiently stabilized by magnesium, nickel, and the like; thus, aluminum is not necessary for the surface. It is preferable that aluminum be widely distributed in a deeper region. For example, it is preferable that aluminum be continuously detected in a region of greater than or equal to 1 nm and less than or equal to 25 nm in a depth direction from the surface. Aluminum is preferably widely distributed in a region of greater than or equal to 0 nm and less than or equal to 100 nm from the surface, further preferably a region of greater than or equal to 0.5 nm and less than or equal to 50 nm from the surface, in which case the crystal structure of a wider region can be stabilized.

When a plurality of the additive elements are contained as described above, the effects of the additive elements can contribute synergistically to further stabilization of the surface portion 100a. In particular, magnesium, nickel, and aluminum are preferably contained, in which case a high effect of stabilizing the composition and the crystal structure can be obtained.

Note that the surface portion 100a occupied by only a compound of an additive element and oxygen is not preferred because this surface portion 100a would make insertion and extraction of lithium difficult. For example, it is not preferable that the surface portion 100a be occupied by only MgO or a structure in which MgO and MO (II) form a solid solution. Thus, the surface portion 100a needs to contain at least the transition metal M typified by cobalt, also contain lithium in a discharged state, and have the path through which lithium is inserted and extracted.

To ensure the sufficient path through which lithium is inserted and extracted, the concentration of cobalt is preferably higher than that of magnesium in the surface portion 100a. For example, when measurement by XPS is performed from the surface of the positive electrode active material 100, the ratio Mg/Co of the number of magnesium atoms Mg to the number of cobalt atoms Co is preferably less than or equal to 0.62. The concentration of cobalt is preferably higher than that of nickel in the surface portion 100a. The concentration of cobalt is preferably higher than that of aluminum in the surface portion 100a. The concentration of cobalt is higher than that of fluorine in the surface portion 100a.

Moreover, excess nickel might hinder diffusion of lithium; thus, the magnesium concentration is preferably higher than that of nickel in the surface portion 100a. For example, when measurement by XPS is performed from the surface of the positive electrode active material 100, the number of nickel atoms is preferably less than or equal to ⅙ of that of magnesium atoms.

It is preferable that some additive elements, in particular, magnesium, nickel, and aluminum have higher concentrations in the surface portion 100a than in the inner portion 100b and exist randomly at low concentrations also in the inner portion 100b. When magnesium and aluminum exist at the lithium sites of the inner portion 100b at appropriate concentrations, an effect of facilitating maintenance of the layered rock-salt crystal structure can be obtained in a manner similar to the above. When nickel exists in the inner portion 100b at an appropriate concentration, a shift in the layered structure formed of octahedrons of cobalt and oxygen can be inhibited in a manner similar to the above. Also in the case where both magnesium and nickel are contained, a synergistic effect of inhibiting dissolution of magnesium can be expected in a manner similar to the above.

It is preferable that the crystal structure continuously change from the inner portion 100b toward the surface owing to the above-described concentration gradient of the additive element. Alternatively, it is preferable that the crystal orientations of the surface portion 100a and the inner portion 100b be substantially aligned with each other.

For example, a crystal structure preferably changes continuously from the layered rock-salt inner portion 100b toward the surface and the surface portion 100a that have a rock-salt structure or have features of both a rock-salt structure and a layered rock-salt structure. Alternatively, the crystal orientation of the surface portion 100a that has a rock-salt structure or features of both a rock-salt structure and a layered rock-salt structure is preferably substantially aligned with that of the layered rock-salt inner portion 100b.

In this specification and the like, a layered rock-salt crystal structure, which belongs to the space group R-3m, of a composite oxide containing lithium and the transition metal such as cobalt refers to a crystal structure in which a rock-salt ion arrangement where cations and anions are alternately arranged is included and lithium and the transition metal are regularly arranged to form a two-dimensional plane, so that lithium can be diffused two-dimensionally. Note that a defect such as a cation or anion vacancy may exist. Moreover, in the layered rock-salt crystal structure, strictly, a lattice of a rock-salt crystal is distorted in some cases.

A rock-salt crystal structure refers to a structure in which a cubic crystal structure with the space group Fm-3m or the like is included and cations and anions are alternately arranged. Note that a cation or anion vacancy may exist.

Having features of both a layered rock-salt crystal structure and a rock-salt crystal structure can be determined from electron diffraction, a TEM image, a cross-sectional STEM image, or the like.

There is no distinction among cation sites in a rock-salt structure; meanwhile, a layered rock-salt crystal structure has two types of cation sites: one type is mostly occupied by lithium, and the other is occupied by the transition metal. A stacked-layer structure where two-dimensional planes of cations and two-dimensional planes of anions are alternately arranged is the same in a rock-salt structure and a layered rock-salt structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt crystal structure, for instance, and on the (003) plane in a layered rock-salt crystal structure, for instance. For example, when electron diffraction patterns of rock-salt MgO and layered rock-salt LiCoO₂ are compared to each other, the distance between the bright spots on the (003) plane of LiCoO₂ is observed at a distance approximately half the distance between the bright spots on the (111) plane of MgO. Thus, when two phases of rock-salt MgO and layered rock-salt LiCoO₂ are included in a region to be analyzed, a plane orientation in which bright spots with high luminance and bright spots with low luminance are alternately arranged exists in an electron diffraction pattern. A bright spot common between the rock-salt structure and the layered rock-salt structure has high luminance, whereas a bright spot caused only in the layered rock-salt structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt structure because there is no distinction among cation sites therein. When a crystal structure having the features of both a rock-salt structure and a layered rock-salt structure is observed from a given crystal orientation, layers observed with high luminance and layers observed with low luminance are alternately observed in a cross-sectional STEM image and the like, and a metal that has a larger atomic number than lithium exists in part of the layers with low luminance, i.e., the lithium layers.

Anions of a layered rock-salt crystal and anions of a rock-salt crystal form a cubic close-packed structure (face-centered cubic lattice structure). Anions of an O3′ type crystal and a monoclinic O1(15) crystal, which are described later, are presumed to form a cubic close-packed structure. Thus, when a layered rock-salt crystal and a rock-salt crystal are in contact with each other, there is a crystal plane at which orientations of cubic close-packed structures formed of anions are aligned with each other.

The description can also be made as follows. Anions on the {111} plane of a cubic crystal structure have a triangle lattice. A layered rock-salt crystal structure, which belongs to the space group R-3m and is a rhombohedral structure, is generally represented by a composite hexagonal lattice for easy understanding of the structure, and the (001) plane of the layered rock-salt crystal structure has a hexagonal lattice. The triangle lattice on the {111} plane of the cubic crystal has atomic arrangement similar to that of the hexagonal lattice on the (001) plane of the layered rock-salt crystal structure. These lattices being consistent with each other can be expressed as “orientations of the cubic close-packed structures are aligned with each other”.

Note that the space group of the layered rock-salt crystal and the O3′ type crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ type crystal is different from that in the rock-salt crystal. In this specification, in the layered rock-salt crystal, the O3′ type crystal, and the rock-salt crystal, a state where the orientations of the cubic close-packed structures formed of anions are aligned with each other may be referred to as a state where crystal orientations are substantially aligned with each other. In addition, a state where three-dimensional structures have similarity, e.g., crystal orientations are substantially aligned with each other, or orientations are crystallographically the same is referred to as topotaxy.

The crystal orientations in two regions being substantially aligned with each other can be determined, for example, from a TEM (Transmission Electron Microscope) image, a STEM (Scanning Transmission Electron Microscope) image, a HAADF-STEM (High-angle Annular Dark Field Scanning TEM) image, an ABF-STEM (Annular Bright-Field Scanning Transmission Electron Microscope) image, or an electron diffraction pattern. They can be determined also from an FFT pattern of a TEM image or an FFT pattern of a STEM image or the like. XRD (X-ray Diffraction), neutron diffraction, and the like can also be used for determination.

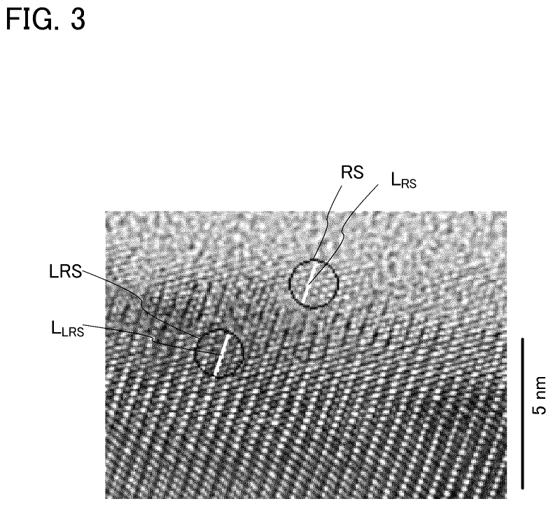

FIG. 3 shows an example of a TEM image in which orientations of the layered rock-salt crystal LRS and the rock-salt crystal RS are substantially aligned with each other. In a TEM image, a STEM image, a HAADF-STEM image, an ABF-STEM image, and the like, an image reflecting a crystal structure is obtained.

For example, in a high-resolution TEM image, a contrast derived from a crystal plane is obtained. When an electron beam is incident perpendicularly to the c-axis of a composite hexagonal lattice of a layered rock-salt crystal structure, for example, a contrast derived from the (003) plane is obtained as repetition of bright bands (bright strips) and dark bands (dark strips) because of diffraction and interference of the electron beam. Thus, when repetition of bright lines and dark lines is observed and the angle between the bright lines (e.g., LRs and LLRS in FIG. 3) is less than or equal to 5° or less than or equal to 2.5° in the TEM image, it can be determined that the crystal planes are substantially aligned with each other, that is, orientations of the crystals are substantially aligned with each other. Similarly, when the angle between the dark lines is less than or equal to 5° or less than or equal to 2.5°, it can be determined that orientations of the crystals are substantially aligned with each other.

In a HAADF-STEM image, a contrast corresponding to the atomic number is obtained, and an element having a larger atomic number is observed to be brighter. For example, in the case of lithium cobalt oxide that has a layered rock-salt crystal structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having a layered rock-salt crystal structure is observed perpendicularly to the c-axis, arrangement of the cobalt atoms is observed as bright lines or arrangement of high-luminance dots in the direction perpendicular to the c-axis, and arrangement of lithium atoms and oxygen atoms is observed as dark lines or a low-luminance region. The same applies to the case where fluorine (atomic number: 9) and magnesium (atomic number: 12) are contained as the additive elements of the lithium cobalt oxide.

Consequently, in the case where repetition of bright lines and dark lines is observed in two regions having different crystal structures and the angle between the bright lines is less than or equal to 5° or less than or equal to 2.5° in a HAADF-STEM image, it can be determined that arrangements of the atoms are substantially aligned with each other, that is, orientations of the crystals are substantially aligned with each other. Similarly, when the angle between the dark lines is less than or equal to 5° or less than or equal to 2.5°, it can be determined that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be determined as in a HAADF-STEM image.

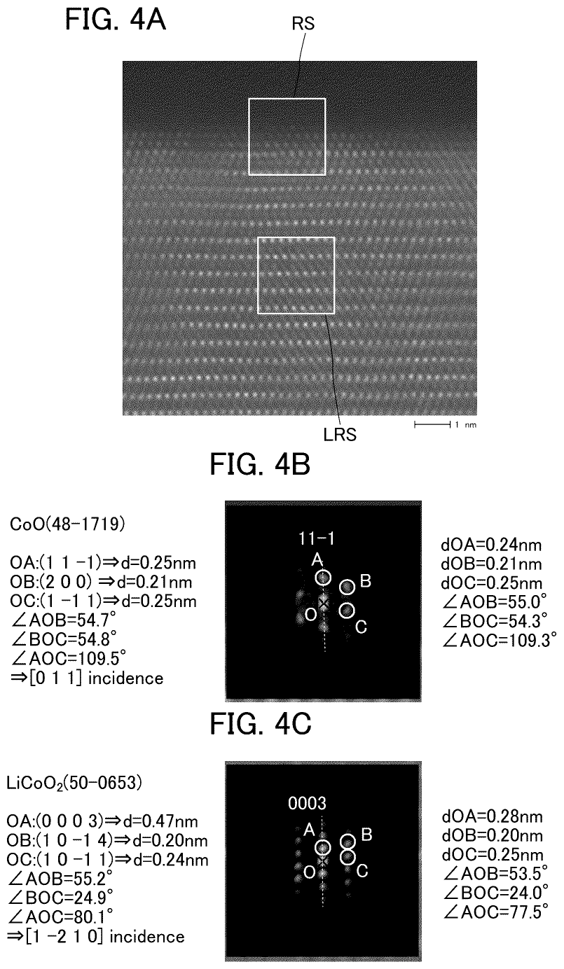

FIG. 4A shows an example of a STEM image in which orientations of the layered rock-salt crystal LRS and the rock-salt crystal RS are substantially aligned with each other. FIG. 4B shows an FFT pattern of a region of the rock-salt crystal RS, and FIG. 4C shows an FFT pattern of a region of the layered rock-salt crystal LRS. In FIG. 4B and FIG. 4C, the composition, the JCPDS card number, and d values and angles to be calculated are shown on the left. The measured values are shown on the right. A spot denoted by O is zero-order diffraction.

A spot denoted by A in FIG. 4B is derived from 11-1 reflection of a cubic structure. A spot denoted by A in FIG. 4C is derived from 0003 reflection of a layered rock-salt crystal structure. It is found from FIG. 4B and FIG. 4C that the direction of the 11-1 reflection of the cubic structure and the direction of the 0003 reflection of the layered rock-salt crystal structure are substantially aligned with each other. That is, it is found that a straight line that passes through AO in FIG. 4B is substantially parallel to a straight line that passes through AO in FIG. 4C. Here, the terms “substantially aligned” and “substantially parallel” mean that the angle is less than or equal to 5° or less than or equal to 2.5°.

When the orientations of the layered rock-salt crystal and the rock-salt crystal are substantially aligned with each other in the above manner in an FFT pattern and an electron diffraction pattern, the <0003> orientation of the layered rock-salt crystal and the <11-1>orientation of the rock-salt crystal may be substantially aligned with each other. In that case, it is preferable that these reciprocal lattice points be spot-shaped, that is, they be not connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt structure are substantially aligned with each other as described above, a spot that is not derived from the 0003 reflection of the layered rock-salt structure may be observed, depending on the incident direction of the electron beam, on a reciprocal lattice space different from the direction of the 0003 reflection of the layered rock-salt structure. For example, a spot denoted by B in FIG. 4C is derived from 1014 reflection of the layered rock-salt structure. This is sometimes observed at a position where the difference in orientation from the reciprocal lattice point derived from the 0003 reflection of the layered rock-salt crystal structure (A in FIG. 4C) is greater than or equal to 52° and less than or equal to 56° (i.e., ∠AOB is greater than or equal to 52° and less than or equal to) 56° and d is greater than or equal to 0.19 nm and less than or equal to 0.21 nm. These indices are just examples, and the spot does not necessarily correspond with them. For example, the spot may be a reciprocal lattice point equivalent to 0003 and 1014.

Similarly, a spot that is not derived from the 11-1 reflection of the cubic structure may be observed on a reciprocal lattice space different from the direction where the 11-1 reflection of the cubic structure is observed. For example, a spot denoted by B in FIG. 4B is derived from 200 reflection of the cubic structure. This diffraction spot is sometimes observed at a position where the difference in orientation from the spot derived from the 11-1 reflection of the cubic structure (A in FIG. 4B) is greater than or equal to 54° and less than or equal to 56° (i.e., ∠AOB is greater than or equal to 54° and less than or equal to) 56°. These indices are just examples, and the spot does not necessarily correspond with them. For example, the spot may be a reciprocal lattice point equivalent to 11-1 and 200 of the cubic structure.

It is known that in a layered rock-salt positive electrode active material, such as lithium cobalt oxide, the (003) plane and a plane equivalent thereto and the (104) plane and a plane equivalent thereto are likely to be crystal planes. Thus, to observe the (003) plane with a TEM or the like, for example, a positive electrode active material particle in which a crystal plane that is presumably the (003) plane is observed with a SEM or the like is preferably selected first; then, the positive electrode active material particle is preferably processed to be thin using an FIB (Focused Ion Beam) or the like so that the (003) plane can be observed with the TEM or the like with an electron beam thereof entering in [120]. To determine whether crystal orientations are aligned, the particle is preferably processed to be thin so that the (003) plane of the layered rock-salt structure is easily observed.

<<When x in LiₓMO₂ is 1>>

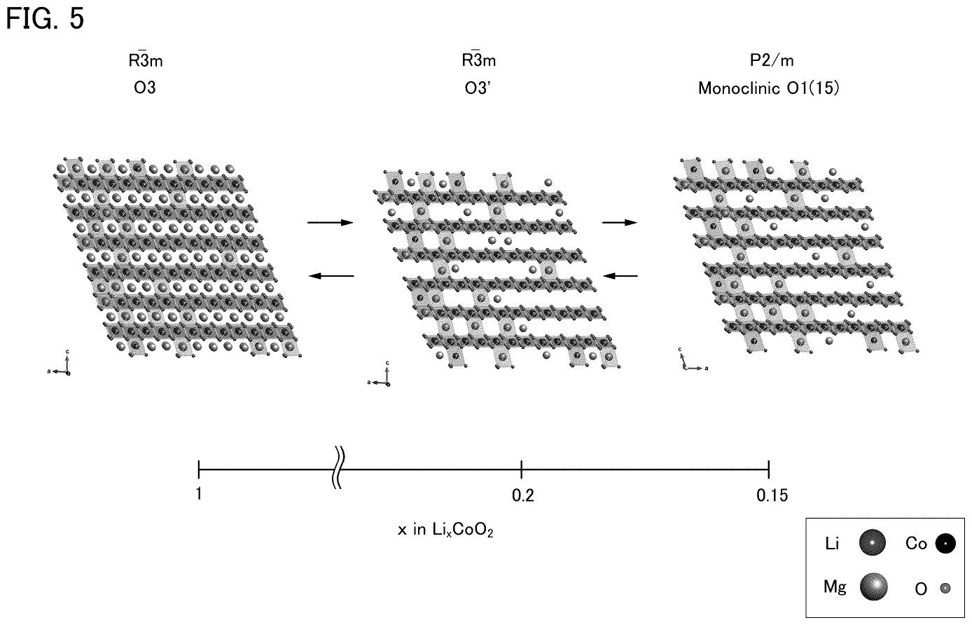

The positive electrode active material 100 of one embodiment of the present invention preferably has a layered rock-salt crystal structure belonging to the space group R-3m in a discharged state, i.e., a state where x in LiₓMoO₂ is 1. A composite oxide having a layered rock-salt crystal structure excels as a positive electrode active material of a secondary battery because it has high discharge capacity and a two-dimensional diffusion path for lithium ions and is thus suitable for an insertion/extraction reaction of lithium ions. For this reason, it is particularly preferable that the inner portion 100b, which accounts for the majority of the volume of the positive electrode active material 100, have a layered rock-salt crystal structure. In FIG. 5, the layered rock-salt crystal structure is denoted by R-3m O3. In the R-3m O3 type structure, the lattice constants are as follows: a=2.81610, b=2.81610, c=14.05360, a=90.0000, β=90.0000, and γ=120.0000; the coordinates of lithium, cobalt, and oxygen in a unit cell are represented by Li (0, 0, 0), Co (0, 0, 0.5), and O (0, 0, 0.23951), respectively (Non-Patent Document 5).

Meanwhile, the surface portion 100a of the positive electrode active material 100 of one embodiment of the present invention preferably has a function of reinforcing the layered structure, which is formed of octahedrons of the transition metal M and oxygen, of the inner portion 100b so that the layered structure does not break even when lithium is extracted from the positive electrode active material 100 by charging. Alternatively, the surface portion 100a preferably functions as a barrier film of the positive electrode active material 100. Alternatively, the surface portion 100a, which is the outer portion of the positive electrode active material 100, preferably reinforces the positive electrode active material 100. Here, the term “reinforce” means inhibition of a change in the structures of the surface portion 100a and the inner portion 100b of the positive electrode active material 100 such as extraction of oxygen and/or a shift in the layered structure formed of octahedrons of the transition metal M and oxygen. The term “reinforce” also means inhibition of oxidative decomposition of an electrolyte on the surface of the positive electrode active material 100.

Accordingly, the surface portion 100a preferably has a crystal structure different from that of the inner portion 100b. The surface portion 100a preferably has a more stable composition and a more stable crystal structure than those of the inner portion 100b at room temperature (25° C.). For example, at least part of the surface portion 100a of the positive electrode active material 100 of one embodiment of the present invention preferably has a rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

The surface portion 100a is a region from which lithium ions are extracted first in charging, and is a region that tends to have a lower lithium concentration than the inner portion 100b. It can be said that bonds between atoms are partly cut on the surface of the particle of the positive electrode active material 100 included in the surface portion 100a. Thus, the surface portion 100a is regarded as a region that tends to be unstable and tends to start deterioration of the crystal structure. For example, it is presumable that a shift in the crystal structure of the layered structure formed of octahedrons of the transition metal M and oxygen in the surface portion 100a has an influence on the inner portion 100b to cause a shift in the crystal structure of the layered structure in the inner portion 100b, leading to degradation of the crystal structure in the whole positive electrode active material 100. Meanwhile, if the surface portion 100a can have sufficient stability, the layered structure, which is formed of octahedrons of the transition metal M and oxygen, of the inner portion 100b is less likely to be broken even when x in LiₓMO₂ is small, e.g., less than or equal to 0.24. Furthermore, a shift in layers, which are formed of octahedrons of the transition metal M and oxygen, of the inner portion 100b can be inhibited.

In the inner portion 100b of the positive electrode active material 100, it is preferable that defects such as dislocation do not exist or the density thereof be low. In the positive electrode active material 100, the crystallite size measured by XRD is preferably large. In other words, the inner portion 100b preferably has high crystallinity. Furthermore, the positive electrode active material 100 preferably has a smooth surface. These features are important factors for assuring the reliability of the positive electrode active material 100 used for a secondary battery. A secondary battery can have a high upper limit of a charge voltage when including a highly reliable positive electrode active material and thereby can have high charge and discharge capacity.

Dislocation in the inner portion 100b can be observed with a TEM, for example. Defects such as dislocation are sometimes not observed in a specific 1-μm-square region of an observation sample in the case where the density of defects including dislocation is sufficiently low. Note that dislocation is a kind of crystal defect and is different from a vacancy defect.

The larger the crystallite size is, the more easily the O3′ type structure is maintained and contraction of the c-axis length is inhibited in the state where x in LiₓCoO₂ is small as described later.

It is presumed that the crystallite size measured by XRD is larger when fewer defects including dislocation are observed with a TEM.

An XRD diffraction pattern for calculation of the crystallite size is preferably obtained in a state of the positive electrode active material alone, or may be obtained in a state of a positive electrode including a current collector, a binder, a conductive material, and the like in addition to the positive electrode active material. Note that the positive electrode active material may have orientation in the positive electrode owing to, for example, pressure application in a manufacturing process. With high orientation, the crystallite size might fail to be calculated accurately; thus, it is further preferable to obtain an XRD diffraction pattern in the following manner: a positive electrode active material layer is extracted from the positive electrode, the binder and the like in the positive electrode active material layer are removed to some extent using a solvent or the like, and a sample holder is filled with the resultant positive electrode active material, for example. In another method, a powder sample may be attached onto a reflection-free silicon plate to which grease is applied, for example.

The crystallite size can be calculated using ICSD coll. code. 172909 as the literature value of lithium cobalt oxide and a diffraction pattern that is obtained with Bruker D8 ADVANCE, for example, CuKα used as an X-ray source, the 20 ranged from 15° to 90°, an increment being 0.005, and a detector being LYNXEYE XE-T. DIFFRAC.TOPAS ver. 6 can be used as crystal structure analysis software for analysis, and set as follows, for example.
Emission Profile: CuKa5.1am
Background: Chebychev polynomial of degree 5
Instrument
   Primary radius: 280 mm
   Secondary radius: 280 mm
   Linear PSD 2Th angular range: 2.9
      FDS angle: 0.3
Full Axial Convolution
   Filament length: 12 mm
   Sample length: 15 mm
   Receiving Slit length: 12 mm
   Primary Sollers: 2.5
   Secondary Sollers: 2.5
Corrections
   Specimen displacement: Refine
   LP Factor: 0

A value of LVol-IB, which is a crystallite size obtained by correction with reference to the integral width calculated by the above method, is preferably employed as a crystallite size.

When Preferred Orientation that is calculated is less than 0.8, the degree of orientation of a sample is too high; thus, this sample is not suitable for calculation of a crystallite size in some cases.

<<State where x in LiₓMO₂ is Small>>

The crystal structure in a state where x in LiₓMO₂ is small of the positive electrode active material 100 of one embodiment of the present invention is preferably different from that of a conventional positive electrode active material because the positive electrode active material 100 has the above-described additive element distribution and/or crystal structure in a discharged state. Here, “x is small” means 0.1<x≤0.24.

A conventional positive electrode active material and the positive electrode active material 100 of one embodiment of the present invention are compared and changes in crystal structures owing to a change in x in LiₓMO₂ will be described with reference to FIG. 5 to FIG. 9.

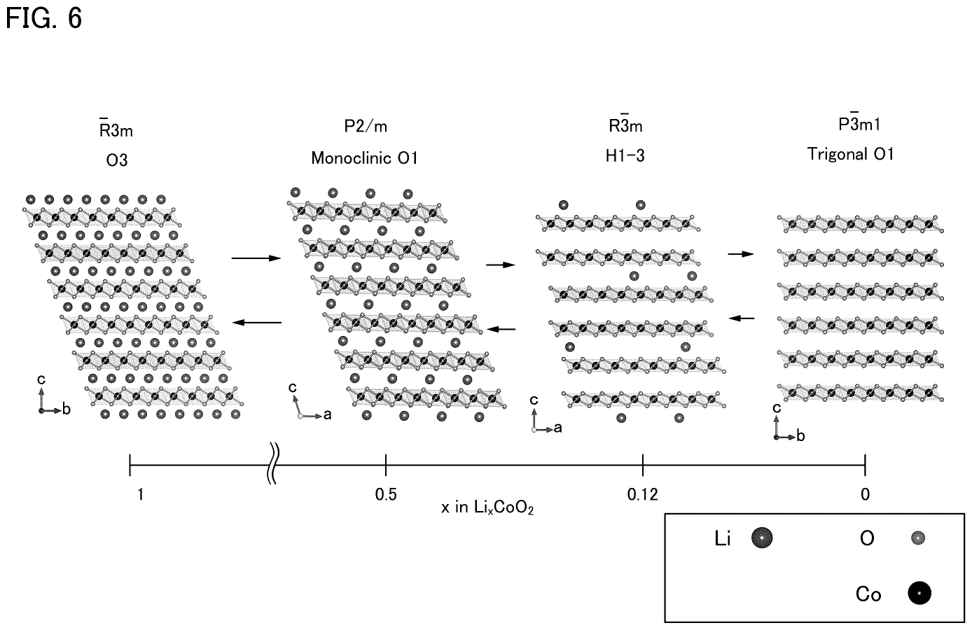

A change in the crystal structure of the conventional positive electrode active material is illustrated in FIG. 6. The conventional positive electrode active material illustrated in FIG. 6 is lithium cobalt oxide (LiCoO₂) containing no additive element. A change in the crystal structure of lithium cobalt oxide containing no additive element is described in Non-Patent Document 1 to Non-Patent Document 3 and the like.

FIG. 6 illustrates the crystal structure of lithium cobalt oxide with x=1 in LiₓCoO₂, which is denoted by R-3m O3. In this crystal structure, lithium occupies octahedral sites and a unit cell includes three CoO₂ layers. Thus, this crystal structure is referred to as an O3 type structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x of approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

A positive electrode active material with x of 0 has the trigonal crystal structure belonging to the space group P-3 ml and includes one CoO₂ layer in a unit cell. Thus, this crystal structure is referred to as an O1 type structure or a trigonal O1 type structure in some cases. Moreover, in some cases, this crystal structure is referred to as a hexagonal O1 type structure when the trigonal crystal is converted into a composite hexagonal lattice.

Conventional lithium cobalt oxide with x of approximately 0.12 has the crystal structure belonging to the space group R-3m. This structure can also be regarded as a structure in which

CoO₂ structures such as a trigonal O1 type structure and LiCoO₂ structures such as an R-3m O3 type structure are alternately stacked. Thus, this crystal structure is referred to as an H1-3 type structure in some cases. Note that since insertion and extraction of lithium do not necessarily uniformly occur in the positive electrode active material in reality, the lithium concentrations can vary; thus, the H1-3 type structure is started to be observed when x is approximately 0.25 experimentally. The number of cobalt atoms per unit cell in the actual H1-3 type structure is twice that in other structures. However, in this specification including FIG. 6, the c-axis of the H1-3 type structure is half that of the unit cell for easy comparison with the other crystal structures.

For the H1-3 type structure, as disclosed in Non-Patent Document 3, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). O1 and O2 are each an oxygen atom. A unit cell that should be used for representing a crystal structure in a positive electrode active material can be judged by Rietveld analysis of XRD patterns, for example. In this case, a unit cell is selected such that the value of GOF (goodness of fit) is small.

When charging that makes x in LiₓCoO₂ be less than or equal to 0.24 and discharging are repeated, the crystal structure of conventional lithium cobalt oxide repeatedly changes between the R-3m O3 structure in a discharged state and the H1-3 type structure (i.e., an unbalanced phase change).

However, there is a large shift in the CoO₂ layers between these two crystal structures. As illustrated in FIG. 6, the CoO₂ layer in the H1-3 type structure largely shifts from that in R-3m O3 in a discharged state. Such a dynamic structural change can adversely affect the stability of the crystal structure.

A difference in volume between these two crystal structures is also large. Thus, the difference in volume per the same number of cobalt atoms between the R-3m O3 type structure in a discharged state and the H1-3 type structure is greater than 3.5%, typically greater than or equal to 3.9%.

In addition, a structure in which CoO₂ layers are arranged continuously, as in the trigonal O1 type structure, included in the H1-3 type structure is highly likely to be unstable.

Accordingly, when charging that makes x be less than or equal to 0.24 and discharging are repeated, the crystal structure of conventional lithium cobalt oxide is gradually broken. The broken crystal structure triggers degradation of the cycle performance. This is because the broken crystal structure has a smaller number of sites where lithium can exist stably and makes it difficult to insert and extract lithium.

By contrast, in the positive electrode active material 100 of one embodiment of the present invention illustrated in FIG. 5, a change in the crystal structure between a discharged state with x in LiₓMO₂ being 1 and a state with x being less than or equal to 0.24 is smaller than that in a conventional positive electrode active material. Specifically, a shift in the MO₂ layers between the state with x of 1 and the state with x of less than or equal to 0.24 can be small. Furthermore, a change in the volume in the case where the positive electrode active materials having the same number of cobalt atoms are compared can be small. Thus, the positive electrode active material 100 of one embodiment of the present invention can have a crystal structure that is less likely to be broken even when charging that makes x be less than or equal to 0.24 and discharging are repeated, and can enable excellent cycle performance. In addition, the positive electrode active material 100 of one embodiment of the present invention with x in LiₓMO₂ being less than or equal to 0.24 can have a more stable crystal structure than a conventional positive electrode active material with x in LiₓMO₂ being less than or equal to 0.24. Thus, the positive electrode active material 100 of one embodiment of the present invention with x in LiₓMO₂ being kept at less than or equal to 0.24 inhibits a short circuit. This is preferable because the safety of the secondary battery is improved.

FIG. 5 illustrates crystal structures of the inner portion 100b of the positive electrode active material 100 in a state where x in LiₓMO₂ is 1, in a state where x is approximately 0.2, and in a state where x is approximately 0.15. The inner portion 100b, accounting for the majority of the volume of the positive electrode active material 100, largely contributes to charge and discharge and can be thus regarded as a portion where a shift in MO₂ layers and a volume change matter most.

The positive electrode active material 100 with x being 1 has the R-3m O3 type structure, which is the same as that of conventional lithium cobalt oxide.

However, in a state where x is less than or equal to 0.24, e.g., approximately 0.2 or approximately 0.15, which makes conventional lithium cobalt oxide have the H1-3 type structure, the positive electrode active material 100 has a crystal structure different from the H1-3 type structure.

The positive electrode active material 100 of one embodiment of the present invention with x being approximately 0.2 has a trigonal crystal structure belonging to the space group R-3m. The symmetry of the CoO₂ layers of this structure is the same as that of 03. Thus, this crystal structure is called an O3′ type structure. In FIG. 5, this crystal structure is denoted by R-3m O3′.

In the unit cell of the O3′ type structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (Å), further preferably 2.807≤a≤2.827 (Å), typically a=2.817 (Å). The lattice constant of the c-axis is preferably 13.681≤c≤13.881 (Å), further preferably 13.751≤c≤13.811 (Å), typically c=13.781 (Å).

The positive electrode active material 100 of one embodiment of the present invention with x being approximately 0.15 has a monoclinic crystal structure belonging to the space group P2/m in some cases. In this structure, a unit cell includes one CoO₂ layer. Here, lithium in the positive electrode active material 100 is approximately 15 atomic % of that in a discharged state. Thus, this crystal structure is referred to as a monoclinic O1(15) type structure. In FIG. 5, this crystal structure is denoted by P2/m monoclinic O1(15).

In the unit cell of the monoclinic O1(15) type structure, the coordinates of cobalt and oxygen can be represented as follows:
Co1 (0.5, 0, 0.5),
Co2 (0, 0.5, 0.5),
O1 (X_{O1}, 0, Z_{O1}),
within the ranges of 0.23≤X_{O1}≤0.24 and 0.61≤Z_{O1}≤0.65, and
O2 (X_{O2}, 0.5, Z_{O2})
within the ranges of 0.75≤X_{O2}≤0.78 and 0.68≤Z_{O2}≤0.71. Lattice constants of the unit cell is:

$$a = 4.880 \pm 0.05 Å ,$$

$$b = 2. 817 \pm 0.05 Å ,$$

$$c = 4. 839 \pm 0.05 Å ,$$

$$α = 90 ° ,$$

$$β = 10 \; 9.6 \pm 0.1 ° , and$$

$$γ = 90 ° .$$

This crystal structure can have the lattice constants even when belonging to the space group R-3m if a certain error is allowed. In this case, the coordinates of cobalt and oxygen in the unit cell can be represented by:
Co (0, 0, 0.5), and
O (0, 0, Z_{O}),
within the range of 0.21≤Z_{O}≤0.23. Lattice constants of the unit cell is:

$$a = 2.817 \pm 0.02 Å , and$$

$$c = 13.68 \pm 0.1 Å .$$

In both of the O3′ type structure and the monoclinic O1(15) type structure, an ion of cobalt, nickel, magnesium, or the like occupies a site coordinated to six oxygen atoms. Light elements such as lithium and magnesium sometimes occupy a site coordinated to four oxygen atoms.

As denoted by dotted lines in FIG. 5, the CoO₂ layers hardly shift between the R-3m O3 type structure in a discharged state, the O3′ type structure, and the monoclinic O1(15) type structure.

The R-3m O3 type structure in a discharged state and the O3′ type structure that contain the same number of cobalt atoms have a difference in volume of less than or equal to 2.5%, specifically less than or equal to 2.2%, typically 1.8%.

The R-3m O3 type structure in a discharged state and the monoclinic O1(15) type structure that contain the same number of cobalt atoms have a difference in volume of less than or equal to 3.3%, specifically less than or equal to 3.0%, typically 2.5%.

Table 1 shows the difference in volume per cobalt atom between the R-3m O3 type structure in a discharged state, the O3′ type structure, the monoclinic O1(15) type structure, the H1-3 type structure, and the trigonal O1 type structure. For the lattice constants of the R-3m O3 type structure in a discharged state and the trigonal O1 type structure in Table 1, which are used for the calculation, the literature values can be referred to (ICSD coll. code. 172909 and 88721). For the lattice constants of the H1-3 type structure, Non-Patent Document 3 can be referred to. The lattice constants of the O3′ type structure and the monoclinic O1(15) type structure can be calculated from the experimental values of XRD.

TABLE 1

| | | | | | | | Volume |
|---|---|---|---|---|---|---|---|
| | Lattice constant | | | | Volume of unit | Volume per Co | change rate |
| Crystal structure | a (Å) | b (Å) | c (Å) | β (°) | cell (Å³) | atom (Å³) | (%) |
| R-3m O3 | 2.8156 | 2.8156 | 14.0542 | 90 | 96.49 | 32.16 | — |
| (LiCoO₂) | | | | | | | |
| O3′ | 2.818 | 2.818 | 13.78 | 90 | 94.76 | 31.59 | 1.8 |
| Monoclinic O1(15) | 4.881 | 2.817 | 4.839 | 109.6 | 62.69 | 31.35 | 2.5 |
| H1-3 | 2.82 | 2.82 | 26.92 | 90 | 185.4 | 30.90 | 3.9 |
| Trigonal O1 | 2.8048 | 2.8048 | 4.2509 | 90 | 28.96 | 28.96 | 10.0 |
| (CoO_{1.92}) | | | | | | | |

As described above, in the positive electrode active material 100 of one embodiment of the present invention, a change in the crystal structure caused when x in LiₓMO₂ is small, i.e., when a large amount of lithium is extracted, is smaller than that in a conventional positive electrode active material. In addition, a change in the volume of the case where the positive electrode active materials having the same number of cobalt atoms are compared is reduced. Thus, the crystal structure of the positive electrode active material 100 does not easily break even when charging that makes x be less than or equal to 0.24 and discharging are repeated. Thus, the positive electrode active material 100 inhibits a decrease in charge and discharge capacity in charge and discharge cycles. Furthermore, the positive electrode active material 100 can stably use a larger amount of lithium than a conventional positive electrode active material and thus enables high discharge capacity per weight and per volume. Thus, with the use of the positive electrode active material 100, a secondary battery with high discharge capacity per weight and per volume can be manufactured.

Note that the positive electrode active material 100 is confirmed to have the O3′ type crystal structure in some cases when x in LiₓMO₂ is greater than or equal to 0.15 and less than or equal to 0.24, and is assumed to have the O3′ type crystal structure even when x is greater than 0.24 and less than or equal to 0.27. In addition, the positive electrode active material 100 is confirmed to have the monoclinic O1(15) type structure in some cases when x in LiₓMO₂ is greater than 0.1 and less than or equal to 0.2, typically greater than or equal to 0.15 and less than or equal to 0.17. However, the crystal structure is affected by not only x in LiₓMO₂ but also the number of charge and discharge cycles, a charge current and a discharge current, temperature, an electrolyte, and the like, so that the range of x is not limited to the above.

Thus, when x in LiₓMO₂ is greater than 0.1 and less than or equal to 0.24, the positive electrode active material 100 may have only the O3′ type structure, only the monoclinic O1(15) type structure, or both of them. Not all particles of the inner portion 100b of the positive electrode active material 100 necessarily have the O3′ type structure and/or the monoclinic O1(15) type structure. The positive electrode active material may include another crystal structure or may be partly amorphous.

In order to make x in LiₓMO₂ small, charging at a high charge voltage is necessary in general. Thus, the state where x in LiₓMO₂ is small can be rephrased as a state where charge at a high charge voltage has been performed. For example, when CC/CV charging is performed at 25° C. and 4.6 V or higher with reference to the potential of a lithium metal, the H1-3 type structure appears in a conventional positive electrode active material. Thus, a charge voltage of 4.6 V or higher can be regarded as a high charge voltage with reference to the potential of lithium metal. In this specification and the like, unless otherwise specified, a charge voltage is shown with reference to the potential of a lithium metal.

Thus, in other words, the positive electrode active material 100 of one embodiment of the present invention is preferable because the crystal structure with the symmetry of R-3m O3 can be maintained even when charging at a high charge voltage of 4.6 V or higher is performed at 25° C., for example.

In the positive electrode active material 100, when the charge voltage is increased, the H1-3 type structure is eventually observed in some cases. As described above, the crystal structure is influenced by the number of charge and discharge cycles, a charge current and a discharge current, temperature, an electrolyte, and the like, so that the positive electrode active material 100 of one embodiment of the present invention sometimes has the O3′ type structure even at a lower charge voltage, e.g., a charge voltage of higher than or equal to 4.5 V and lower than 4.6 V at 25° C. Similarly, the positive electrode active material 100 may sometimes have the monoclinic O1(15) type structure at a charge voltage higher than or equal to 4.65 V and lower than or equal to 4.7 V at 25° C.

In the case where graphite is used as a negative electrode active material in a secondary battery, for example, the voltage of the secondary battery is lower than the above-mentioned voltage by the potential of graphite. The potential of graphite is approximately 0.05 V to 0.2 V with reference to the potential of a lithium metal. Thus, for a secondary battery using graphite as a negative electrode active material, a similar crystal structure is obtained at a voltage corresponding to a difference between the above-described voltage and the potential of the graphite.

Although a chance of the existence of lithium is the same in all lithium sites in the O3′ and monoclinic O1(15) type structures in FIG. 5, one embodiment of the present invention is not limited thereto. Lithium may exist unevenly in only some of the lithium sites; for example, lithium may symmetrically exist as in the monoclinic O1 type structure (Li_{0.5}CoO₂) illustrated in FIG. 6. The distribution of lithium can be analyzed by neutron diffraction, for example.

The O3′ type structure and the monoclinic O1(15) crystal structure can be regarded as a crystal structure that contains lithium between layers randomly but is similar to a CdCl₂ type structure. The crystal structure similar to the CdCl₂ type structure is close to a crystal structure of lithium nickel oxide charged to be Li_{0.06}NiO₂; however, pure lithium cobalt oxide or a layered rock-salt positive electrode active material containing a large amount of cobalt is known not to have the CdCl₂ type structure generally.

### <<Crystal Grain Boundary>>

It is further preferable that the additive element contained in the positive electrode active material 100 of one embodiment of the present invention have the above-described distribution and be at least partly unevenly distributed at a crystal grain boundary and the vicinity thereof.

Note that in this specification and the like, uneven distribution means that the concentration of an element in a certain region differs from that in another region. This may be rephrased as segregation, precipitation, unevenness, deviation, or a mixture of a high-concentration portion and a low-concentration portion.

For example, the concentration of magnesium at the crystal grain boundary and the vicinity thereof in the positive electrode active material 100 is preferably higher than that in the crystal grain boundary and the vicinity thereof in the inner portion 100b. In addition, the concentration of fluorine at the crystal grain boundary and the vicinity thereof in the positive electrode active material 100 is preferably higher than that in the crystal grain boundary and the vicinity thereof in the inner portion 100b. In addition, the concentration of nickel at the crystal grain boundary and the vicinity thereof in the positive electrode active material 100 is preferably higher than that in the crystal grain boundary and the vicinity thereof in the inner portion 100b. In addition, the concentration of aluminum at the crystal grain boundary and the vicinity thereof in the positive electrode active material 100 is preferably higher than that in the crystal grain boundary and the vicinity thereof in the inner portion 100b.

A crystal grain boundary is a plane defect. Thus, a crystal grain boundary is likely to be unstable and a change in the crystal structure is likely to start at the crystal grain boundary as in the surface of the particle. Thus, the higher the concentration of the additive element at the crystal grain boundary and the vicinity thereof is, the more effectively the change in the crystal structure can be reduced.

When the magnesium concentration and the fluorine concentration are high at a crystal grain boundary and the vicinity thereof, the magnesium concentration and the fluorine concentration in the vicinity of a surface generated by a crack are also high even when the crack is generated along the crystal grain boundary of the positive electrode active material 100 of one embodiment of the present invention. Thus, the positive electrode active material after generation of a crack can also have an increased corrosion resistance to hydrofluoric acid. In addition, the positive electrode active material including a crack can inhibit a side reaction between the electrolyte solution and the positive electrode active material.

### <Particle Diameter>

When the particle diameter of the positive electrode active material 100 of one embodiment of the present invention is too large, there are problems such as difficulty in lithium diffusion and large surface roughness of an active material layer at the time when the material is applied to a current collector. By contrast, too small a particle diameter causes problems such as an overreaction with the electrolyte solution.

The particle diameter of the positive electrode active material 100 can be measured with a laser diffraction particle size distribution analyzer, for example. As the particle diameter of the positive electrode active material 100 measured by a laser diffraction particle size distribution analyzer, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, it is preferably greater than or equal to 1 μm and less than or equal to 40 μm. Alternatively, it is preferably greater than or equal to 1 μm and less than or equal to 30 μm. Alternatively, it is preferably greater than or equal to 2 μm and less than or equal to 100 μm. Alternatively, it is preferably greater than or equal to 2 μm and less than or equal to 30 μm. Alternatively, it is preferably greater than or equal to 5 μm and less than or equal to 100 μm. Alternatively, it is preferably greater than or equal to 5 μm and less than or equal to 40 μm.

A positive electrode is preferably formed using a mixture of particles having different particle diameters, which can increase the electrode density and thus a secondary battery with a high energy density can be achieved. The positive electrode active material 100 with a relatively small particle diameter is expected to achieve favorable charge and discharge rate characteristics. The positive electrode active material 100 having a relatively large particle diameter is expected to have high charge and discharge cycle performance and maintain high discharge capacity.

### <Analysis Method>

Whether or not a given positive electrode active material is the positive electrode active material 100 of one embodiment of the present invention, which has the O3′ type structure and/or monoclinic O1(15) type structure when x in LiₓMO₂ is small, can be determined by analyzing a positive electrode including the positive electrode active material with small x in LiₓMO₂ by XRD, electron diffraction, neutron diffraction, electron spin resonance (ESR), nuclear magnetic resonance (NMR), or the like.

XRD is particularly preferably employed, in which case the symmetry of a transition metal such as cobalt in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example. A diffraction peak reflecting the crystal structure of the inner portion 100b of the positive electrode active material 100, which accounts for the majority of the volume of the positive electrode active material 100, is obtained through XRD, in particular, powder XRD.

In the case where the crystallite size is measured by powder XRD, the measurement is preferably performed while the influence of orientation due to pressure or the like is removed. For example, it is preferable that the positive electrode active material be taken out from a positive electrode obtained by disassembling a secondary battery, the positive electrode active material be made into a powder sample, and then the measurement be performed.

As described above, the positive electrode active material 100 of one embodiment of the present invention has a feature of a small change in the crystal structure between when x in LiₓMO₂ is 1 and when x is less than or equal to 0.24. A material 50% or more of which has the crystal structure to be largely changed by high-voltage charge is not preferable because the material cannot withstand repetition of high-voltage charge and discharge.

It should be noted that the O3′ type structure or the monoclinic O1(15) type structure is not obtained in some cases only by addition of the additive element. For example, when x in LiₓMO₂ is less than or equal to 0.24, lithium cobalt oxide containing magnesium and fluorine or lithium cobalt oxide containing magnesium and aluminum has the O3′ type structure and/or the monoclinic O1(15) type structure at 60% or more in some cases, and has the H1-3 type structure at 50% or more in other cases, depending on the concentrations and distributions of the additive elements.

In addition, in the case where x is too small, e.g., 0.1 or less, or under the condition where charge voltage is higher than 4.9 V, even the positive electrode active material 100 of one embodiment of the present invention sometimes has the H1-3 type structure or the trigonal O1 type structure. Thus, determining whether or not a positive electrode active material is the positive electrode active material 100 of one embodiment of the present invention requires analysis of the crystal structure by XRD and other methods and data such as charge capacity or charge voltage.

Note that a positive electrode active material with small x sometimes causes a change in the crystal structure when exposed to the air. For example, the O3′ type structure and the monoclinic O1(15) type structure change into the H1-3 type structure in some cases. For that reason, all samples subjected to analysis of crystal structures are preferably handled in an inert atmosphere such as an argon atmosphere.

Whether the distribution of the additive element contained in a positive electrode active material is in the above-described state can be determined by, for example, analysis using XPS, energy dispersive X-ray spectroscopy (EDX), EPMA (Electron Probe Micro Analysis), or the like.

The crystal structure of the surface portion 100a, the crystal grain boundary, or the like can be analyzed by electron diffraction of a cross section of the positive electrode active material 100, for example.

### <<Charge Method>>

Charging for determining whether or not a composite oxide is the positive electrode active material 100 of one embodiment of the present invention can be performed on a coin cell (CR2032 type with a diameter of 20 mm and a height of 3.2 mm) with a lithium counter electrode, for example.

More specifically, a positive electrode can be formed by application of slurry in which the positive electrode active material, a conductive material, and a binder are mixed to a positive electrode current collector made of aluminum foil.

A lithium metal can be used for the counter electrode. Note that when the counter electrode is formed using a material other than the lithium metal, the voltage of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, a solution in which ethylene carbonate (EC) and diethyl carbonate (DEC) at a volume ratio of 3:7 and vinylene carbonate (VC) at 2 wt % are mixed can be used.

As the separator, a 25-μm-thick polypropylene porous film can be used.

A positive electrode can and a negative electrode can each formed of stainless steel (SUS) can be used.

The coin cell fabricated under the above conditions is charged with a given voltage (e.g., 4.5 V, 4.55 V, 4.6 V, 4.65 V, 4.7 V, 4.75 V, or 4.8 V). The charge method is not particularly limited as long as charging with a given voltage can be performed for sufficient time. In the case of CCCV charging, for example, CC charging can be performed at a current higher than or equal to 20 mA/g and lower than or equal to 100 mA/g. CV charging can be ended with a current higher than or equal to 2 mA/g and lower than or equal to 10 mA/g. To observe a phase change of the positive electrode active material, charge with such a small current value is preferably performed. Meanwhile, in the case where a current does not reach higher than or equal to 2 mA/g and lower than or equal to 10 mA/g even when CV charging is performed for a long time, the CV charging may be terminated after the sufficient time passes from the start because the current is probably consumed not for charging the positive electrode active material but for decomposing the electrolyte solution. The sufficient time in that case can be longer than or equal to 1.5 hours and shorter than or equal to 3 hours. The temperature is set to 25° C. or 45° C. After charging is performed in this manner, the coin cell is disassembled in a glove box with an argon atmosphere to take out the positive electrode, whereby the positive electrode active material with a given charge capacity can be obtained. In order to inhibit a reaction with components in the external environment, the positive electrode is preferably enclosed in an argon atmosphere in performing various analyses later. For example, XRD can be performed on the positive electrode enclosed in an airtight container with an argon atmosphere. After the charging is completed, the positive electrode is preferably taken out and subjected to the analysis immediately. Specifically, the positive electrode is preferably subjected to the analysis within one hour after the completion of the charging, further preferably 30 minutes after the completion of the charging.

In the case where the crystal structure in a charged state after charge and discharge are performed multiple times is analyzed, the conditions of the charge and discharge performed multiple times may be different from the above-described charge conditions. For example, the charging can be performed by constant current charging with a current value greater than or equal to 20 mA/g and less than or equal to 100 mA/g to a given voltage (e.g., 4.6 V, 4.65 V, 4.7 V, 4.75 V, or 4.8 V) and then constant voltage charging until the current value becomes greater than or equal to 2 mA/g and less than or equal to 10 mA/g. The discharging can be performed by constant current discharging with greater than or equal to 20 mA/g and less than or equal to 100 mA/g to 2.5 V.

Also in the case where the crystal structure in a discharged state after the charge and discharge are performed multiple times is analyzed, constant current discharging can be performed with a current value greater than or equal to 20 mA/g and less than or equal to 100 mA/g to 2.5 V, for example.

### <<XRD>>

The apparatus and conditions for the XRD measurement are not particularly limited. For example, the measurement can be performed using the following apparatus and conditions. XRD apparatus: D8 ADVANCE produced by Bruker AXS Inc.
X-ray source: Cu
Output: 40 kV, 40 mA
Angle of divergence: Div. Slit, 0.5° Detector: LynxEye
Scanning method: 2θ/θ continuous scanning
Measurement range (2θ): from 15° to 90°
Step width (2θ): 0.01°
Counting time: one second/step
Rotation of sample stage: 15 rpm
From the obtained XRD patterns, the background and CuKα₂ radiation peak is preferably removed using analysis software, DIFFRAC. EVA, or the like.

In the case where the measurement sample is powder, the sample can be set by, for example, being put in a glass sample holder or being sprinkled on a reflection-free silicon plate to which grease is applied. In the case where the measurement sample is a positive electrode, the positive electrode can be set in the following manner: the positive electrode is attached to a substrate with a double-sided adhesive tape and the position of the positive electrode active material layer can be adjusted to the measurement plane required by an apparatus.

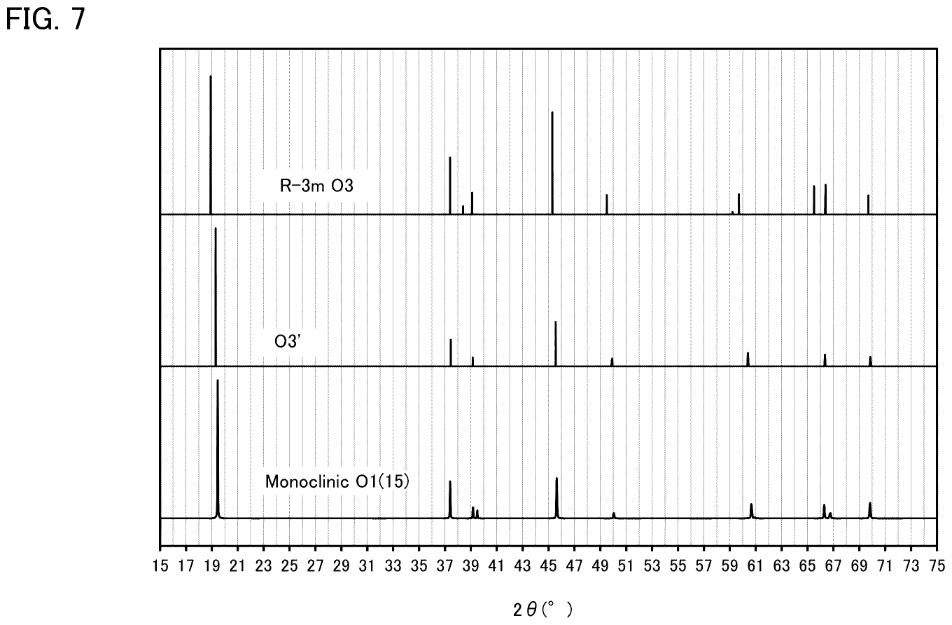

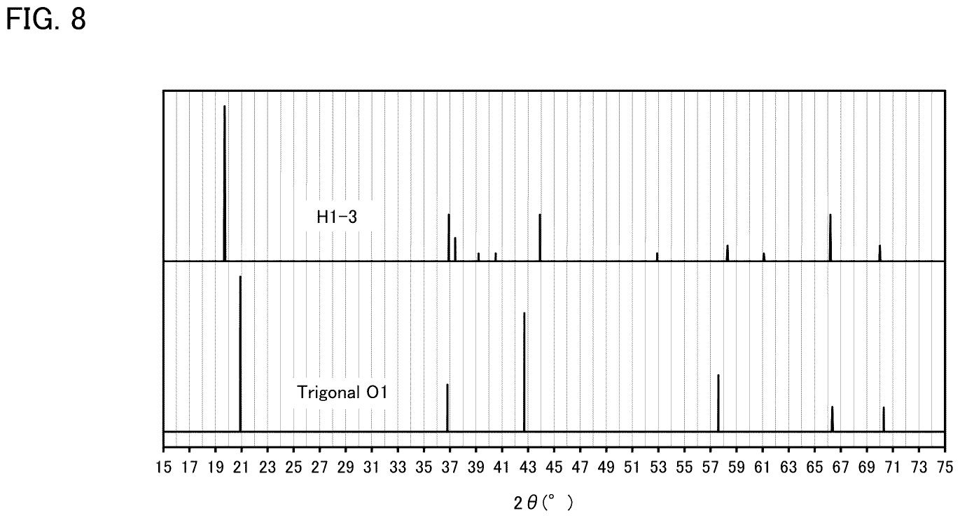

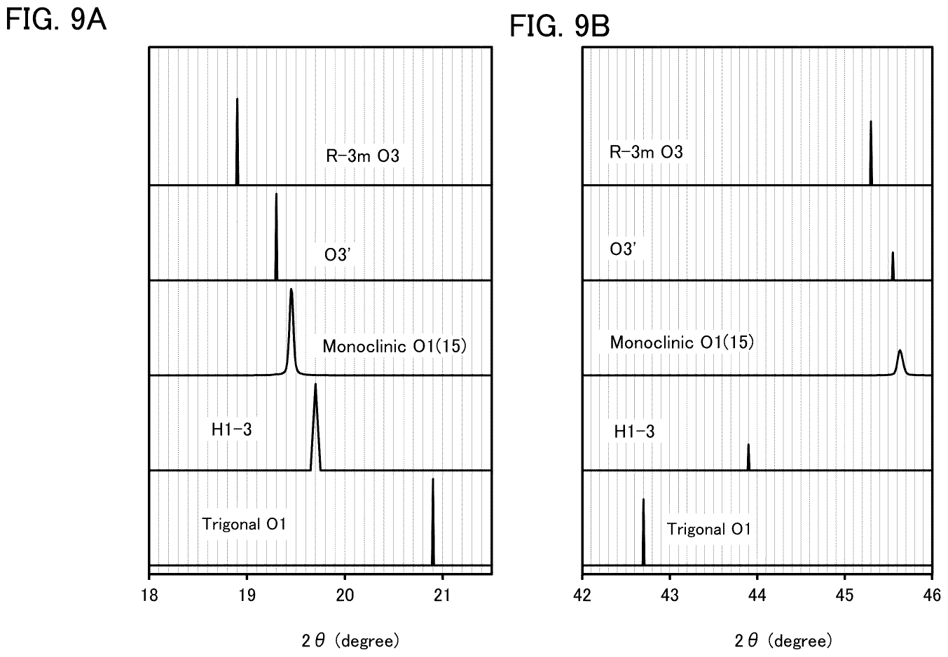

FIG. 7, FIG. 8, FIG. 9A, and FIG. 9B show ideal powder XRD patterns with CuKα₁ radiation that are calculated from models of the O3′ type structure, the monoclinic O1(15) type structure, and the H1-3 type structure. For comparison, ideal XRD patterns calculated from the LiCoO₂ O3 type structure with x=1 in LiₓMO₂ and the trigonal O1 type structure with x=0 are also shown. FIG. 9A and FIG. 9B each show the XRD patterns of the O3′ type structure, the monoclinic O1(15) type structure, and the H1-3 type structure, and FIG. 9A and FIG. 9B are enlarged diagrams showing, respectively, the 20 range of 18° to 21° and the 20 range of 42° to 46°. Note that the patterns of LiCoO₂ (O3) and CoO₂ (O1) are made from crystal structure data obtained from the ICSD (Inorganic Crystal Structure Database) (see Non-Patent Document 4) with Reflex Powder DiffracTion, which is a module of Materials Studio (BIOVIA). The 2θ range is from 15° to 75°, the step size is 0.01, the wavelength λ1 is 1.540562×10⁻¹⁰ m, the wavelength λ2 is not set, and a single monochromator is used. The pattern of the H1-3 type structure is similarly made from the crystal structure data disclosed in Non-Patent Document 3. The patterns of the O3′ type structure and the monoclinic O1(15) type structure are obtained in the following manner: the crystal structures are estimated from the XRD pattern of the positive electrode active material, fitting is performed with TOPAS ver. 3 (crystal structure analysis software produced by Bruker Corporation), and the XRD patterns are made in a manner similar to that for other structures.

As shown in FIG. 7, FIG. 9A, and FIG. 9B, the O3′ type structure exhibits diffraction peaks at 2θ=19.25±0.12° (greater than or equal to 19.13° and less than) 19.37° and 2θ=45.47±0.10° (greater than or equal to 45.37° and less than 45.57°).

Furthermore, the monoclinic O1(15) type structure exhibits diffraction peaks at 2θ=19.47±0.10° (greater than or equal to 19.37° and less than or equal to) 19.57° and 2θ=45.62±0.05° (greater than or equal to 45.57° and less than or equal to) 45.67°.

However, as shown in FIG. 8, FIG. 9A, and FIG. 9B, the H1-3 type structure and the trigonal O1 type structure do not exhibit peaks at these positions. Thus, it can be said that exhibiting peaks at greater than or equal to 19.13° and less than 19.37° and/or greater than or equal to 19.37° and less than or equal to 19.57° and at greater than or equal to 45.37° and less than 45.57° and/or greater than or equal to 45.57° and less than or equal to 45.67° in a state with small x in LiₓCoO₂ is the feature of the positive electrode active material 100 of one embodiment of the present invention.

It can also be said that in the positive electrode active material 100 of one embodiment of the present invention, the position of an XRD diffraction peak exhibited by the crystal structure with x=1 is close to that of an XRD diffraction peak exhibited by the crystal structure with x≤0.24. More specifically, it can be said that at 2θ greater than or equal to 42° and less than or equal to 46°, the difference in 2θ between the main diffraction peak exhibited by the crystal structure with x=1 and the main diffraction peak exhibited by the crystal structure with x≤0.24 is less than or equal to 0.7°, preferably less than or equal to 0.5°.

Although the positive electrode active material 100 of one embodiment of the present invention sometimes has the O3′ type structure and/or the monoclinic O1(15) type structure when x in LiₓCoO₂ is small, not all particles necessarily have the O3′ type structure and/or the monoclinic O1(15) type structure. The particles may include another crystal structure or may be partly amorphous. Note that when the XRD patterns are subjected to the Rietveld analysis, the O3′ type structure and/or the monoclinic O1(15) type structure preferably account(s) for greater than or equal to 50%, further preferably greater than or equal to 60%, still further preferably greater than or equal to 66%. The positive electrode active material in which the O3′ type structure and/or the monoclinic O1(15) type structure account(s) for greater than or equal to 50%, preferably greater than or equal to 60%, further preferably greater than or equal to 66% can enable sufficiently good cycle performance.

In addition, the H1-3 type structure and the O1 type structure preferably account for less than or equal to 50% in the Rietveld analysis performed in a similar manner. Alternatively, the H1-3 type structure and the O1 type structure preferably account for less than or equal to 34%. It is further preferable that substantially no H1-3 type structure and substantially no O1 type structure be observed.

Furthermore, even after 100 or more cycles of charge and discharge after the measurement starts, the O3′ type structure and/or the monoclinic O1(15) type structure preferably account(s) for greater than or equal to 35%, further preferably greater than or equal to 40%, still further preferably greater than or equal to 43% when the Rietveld analysis is performed.

Sharpness of a diffraction peak in an XRD pattern indicates the degree of crystallinity. It is thus preferable that the diffraction peaks after charging be sharp or in other words, have a small half width. For example, the full width at half maximum is preferably small. Even peaks that are derived from the same crystal phase have different half widths depending on the XRD measurement conditions or the 20 value. In the case of the above-described measurement conditions, the peak observed at 2θ greater than or equal to 43° and less than or equal to 46° preferably has a full width at half maximum of less than or equal to 0.2°, further preferably less than or equal to 0.15°, still further preferably less than or equal to 0.12°. Note that not all peaks need to fulfill the requirement. A crystal phase can be regarded as having high crystallinity when some peaks fulfill the requirement. Such high crystallinity sufficiently contributes to stability of the crystal structure after charge.

The crystallite size of the O3′ type structure and the monoclinic O1(15) type structure of the positive electrode active material 100 decreases to approximately 1/20 of that of LiCoO₂ (O3) in a discharged state. Thus, a clear peak of the O3′ type structure and/or the monoclinic O1(15) type structure can be observed when x in LiₓCoO₂ is small, even under the same XRD measurement conditions as those of a positive electrode before charge and discharge. By contrast, conventional LiCoO₂ has a small crystallite size and exhibits a broad and small peak even when it can partly have a structure similar to the O3′ type structure and/or the monoclinic O1(15) type structure. The crystallite size can be calculated from the half width of the XRD peak.

As described above, the influence of the Jahn-Teller effect is preferably small in the positive electrode active material 100 of one embodiment of the present invention. The positive electrode active material 100 may contain a transition metal such as nickel or manganese as the additive element in addition to cobalt as long as the influence of the Jahn-Teller effect is small.

For example, the value of a-axis/c-axis tends to significantly change between nickel concentrations of 5% and 7.5%, and the distortion of the a-axis becomes large at a nickel concentration of 7.5%. This distortion may be derived from the Jahn-Teller distortion of trivalent nickel. Thus, among the transition metals M contained in the positive electrode active material 100, nickel is preferably at lower than 7.5 atomic %.

It is also indicated that the lattice constant changes differently at manganese concentrations of 5% or higher and does not follow the Vegard's law. Thus, among the transition metals M contained in the positive electrode active material 100, manganese is preferably at lower than or equal to 4 atomic %.

The nickel concentration and the manganese concentration in the surface portion 100a are not limited to the above ranges. In other words, the nickel concentration in the surface portion 100a may be higher than the above concentration.

Examination of preferable ranges of the lattice constants of the positive electrode active material of one embodiment of the present invention based on the above revealed that, in the layered rock-salt crystal structure of the positive electrode active material 100 in a discharged state or a state where charge and discharge are not performed, which can be estimated from the XRD patterns, the a-axis lattice constant is preferably greater than 2.814×10⁻¹⁰ m and less than 2.817×10⁻¹⁰ m, and the lattice constant of the c-axis is preferably greater than 14.05×10⁻¹⁰ m and less than 14.07×10⁻¹⁰ m. The state where charge and discharge are not performed may be the state of powder before the manufacture of a positive electrode of a secondary battery.

Alternatively, in the layered rock-salt crystal structure of the positive electrode active material 100 in a discharged state or the state where charge and discharge are not performed, the value obtained by dividing the lattice constant of the a-axis by the lattice constant of the c-axis (a-axis/c-axis) is preferably greater than 0.20000 and less than 0.20049.

Alternatively, when the layered rock-salt crystal structure of the positive electrode active material 100 in the discharged state or the state where charge and discharge are not performed is subjected to XRD analysis, a first peak is observed at 2θ of greater than or equal to 18.50° and less than or equal to 19.30° and a second peak is observed at 2θ of greater than or equal to 38.00° and less than or equal to 38.80°, in some cases.

### <<XPS>>

In an inorganic oxide, a region from the surface to a depth of approximately 2 to 8 nm (normally, less than or equal to 5 nm) can be analyzed by X-ray photoelectron spectroscopy (XPS) using monochromatic aluminum Kα radiation as an X-ray source; thus, the concentrations of elements in a region within approximately half the depth of the surface portion 100a can be quantitatively analyzed by XPS. The bonding states of the elements can be analyzed by narrow scanning. The lower detection limit is approximately 1 atomic % but depends on the element.

In the positive electrode active material 100 of one embodiment of the present invention, the concentration(s) of one or two or more selected from the additive elements is/are preferably higher in the surface portion 100a than in the inner portion 100b. This means that the concentration(s) of one or two or more selected from the additive elements in the surface portion 100a is/are preferably higher than the average concentration of the selected element(s) in the entire positive electrode active material 100. For this reason, for example, it can be said that it is preferable that the concentration of one or two or more additive elements selected from the surface portion 100a, which is measured by XPS or the like, be higher than the average concentration of the additive element(s) in the entire positive electrode active material 100, which is measured by ICP-MS (inductively coupled plasma-mass spectrometry), GD-MS (glow discharge mass spectrometry), or the like. For example, the concentration of magnesium of at least part of the surface portion 100a, which is measured by XPS or the like, is preferably higher than the average concentration of magnesium of the entire positive electrode active material 100. The concentration of titanium of at least part of the surface portion 100a is preferably higher than the average concentration of titanium of the entire positive electrode active material 100. The nickel concentration in at least part of the surface portion 100a is preferably higher than the average nickel concentration in the entire positive electrode active material 100. The aluminum concentration in at least part of the surface portion 100a is preferably higher than the average aluminum concentration in the entire positive electrode active material 100. The concentration of fluorine in at least part of the surface portion 100a is preferably higher than the average concentration of fluorine in the entire positive electrode active material 100.

Note that the surface and the surface portion 100a of the positive electrode active material 100 of one embodiment of the present invention do not include a carbonate, a hydroxy group, or the like which is chemically adsorbed after formation of the positive electrode active material 100. Furthermore, an electrolyte solution, a binder, a conductive material, and a compound originating from any of these that are attached to the surface of the positive electrode active material 100 are not contained either. Thus, in quantification of the elements contained in the positive electrode active material, correction may be performed to exclude carbon, hydrogen, excessive oxygen, excessive fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample of a positive electrode active material or a positive electrode active material layer or the like may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element is not easily dissolved even in that case; thus, the atomic ratio of the additive element is not affected.

The concentration of the additive element in the surface portion 100a and the concentration of the additive element in the positive electrode active material 100 may be compared using the atomic ratio of the additive element to cobalt. The ratio of the additive element to cobalt is preferably used, in which case comparison can be performed while reducing the influence of a carbonate or the like that is chemically adsorbed after formation of the positive electrode active material. For example, in the XPS analysis, the atomic ratio of magnesium to cobalt Mg/Co is preferably greater than or equal to 0.4 and less than or equal to 1.5. In the ICP-MS analysis, Mg/Co is preferably greater than or equal to 0.001 and less than or equal to 0.06.

Similarly, to secure the sufficient path through which lithium is inserted and extracted, the concentrations of lithium and cobalt are preferably higher than those of the additive elements in the surface portion 100a of the positive electrode active material 100. It can be said that the concentrations of lithium and cobalt in the surface portion 100a are preferably higher than that of one or two or more selected from the additive elements contained in the surface portion 100a, which is measured by XPS or the like. For example, the concentration of cobalt in at least part of the surface portion 100a, which is measured by XPS or the like, is preferably higher than the concentration of magnesium in at least part of the surface portion 100a, which is measured by XPS or the like. Similarly, the concentration of lithium is preferably higher than the concentration of magnesium. In addition, the concentration of cobalt is preferably higher than the concentration of nickel. Similarly, the concentration of lithium is preferably higher than the concentration of nickel. The concentration of cobalt is preferably higher than the concentration of aluminum. Similarly, the concentration of lithium is preferably higher than the concentration of aluminum. The concentration of cobalt is preferably higher than the concentration of fluorine. Similarly, the concentration of lithium is preferably higher than the concentration of fluorine.

It is further preferable that aluminum be widely distributed in a deep region, for example, in a region at a depth greater than or equal to 5 nm and less than or equal to 50 nm from the surface or the reference point. Thus, it is further preferable that the concentration of aluminum be lower than or equal to 1 atomic % or no aluminum be detected by XPS or the like although aluminum is detected by analysis on the entire positive electrode active material 100 by ICP-MS, GD-MS, or the like.

Furthermore, when XPS analysis is performed on the positive electrode active material 100 of one embodiment of the present invention, the number of magnesium atoms is preferably greater than or equal to 0.4 times and less than or equal to 1.2 times, further preferably greater than or equal to 0.65 times and less than or equal to 1.0 times the number of cobalt atoms. The number of nickel atoms is preferably less than or equal to 0.15 times, further preferably greater than or equal to 0.03 times and less than or equal to 0.13 times the number of cobalt atoms. The number of aluminum atoms is preferably less than or equal to 0.12 times, further preferably less than or equal to 0.09 times the number of cobalt atoms. The number of fluorine atoms is preferably greater than or equal to 0.3 times and less than or equal to 0.9 times, further preferably greater than or equal to 0.1 times and less than or equal to 1.1 times the number of cobalt atoms. When the number is within the above range, it can be said that the additive element is not attached to the surface of the positive electrode active material 100 in a narrow range but widely distributed at a preferable concentration in the surface portion 100a of the positive electrode active material 100.

In the XPS analysis, monochromatic aluminum Kα radiation can be used as an X-ray source, for example. An extraction angle is, for example, 45°. For example, the measurement can be performed using the following apparatus and conditions.
Measurement apparatus: Quantera II, produced by PHI, Inc.
X-ray source: monochromatic Al Kα (1486.6 eV)
   Detection area: 100 μmφ
Detection depth: approximately 4-5 nm (extraction angle) 45°
   Measurement spectrum: wide scanning, narrow scanning of each detected element

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. The above value is different from 685 eV, which is the bonding energy of lithium fluoride, and 686 eV, which is the bonding energy of magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably at approximately 1303 eV. The above value is different from 1305 eV, which is the bonding energy of magnesium fluoride, and is close to the bonding energy of magnesium oxide.

### <<EDX>>

One or two or more selected from the additive elements contained in the positive electrode active material 100 preferably have a concentration gradient. It is further preferable that the additive elements included in the positive electrode active material 100 exhibit concentration peaks at different depths from the surface. The concentration gradient of the additive element can be evaluated by exposing a cross section of the positive electrode active material 100 using FIB (Focused Ion Beam) or the like and analyzing the cross section using energy dispersive X-ray spectroscopy (EDX), EPMA (electron probe microanalysis), or the like.

In the EDX measurement, to measure a region while scanning is performed and evaluate the region two-dimensionally is referred to as EDX area analysis. The measurement for evaluation of the atomic concentration distribution in a positive electrode active material by line scan is referred to as line analysis. Furthermore, extracting data of a linear region from EDX area analysis is referred to as line analysis in some cases. The measurement of a region without scanning is referred to as point analysis.

By EDX area analysis (e.g., element mapping), the concentrations of the additive element in the surface portion 100a, the inner portion 100b, the vicinity of a crystal grain boundary, and the like of the positive electrode active material 100 can be quantitatively analyzed. By EDX line analysis, the concentration distribution and the maximum value of the additive element can be analyzed. An analysis method in which a thinned sample is used, such as STEM-EDX, is preferable because the method makes it possible to analyze the concentration distribution in the depth direction from the surface toward the center in a specific region of the positive electrode active material regardless of the distribution in the front-back direction. To increase the spatial resolution in STEM-EDX line analysis, the beam diameter of an electron beam (also referred to as a beam diameter or a probe diameter) is preferably small. The beam diameter in STEM-EDX line analysis is preferably less than or equal to 0.3 nm, further preferably less than or equal to 0.2 nm, still further preferably less than or equal to 0.1 nm.

Since the positive electrode active material 100 is a compound containing oxygen and a transition metal into and from which lithium can be inserted and extracted, an interface between a region where oxygen and the transition metal M (Co, Ni, Mn, Fe, or the like) that is oxidized or reduced due to insertion and extraction of lithium exist and a region where oxygen and the transition metal M do not exist is considered as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

In STEM-EDX line analysis or the like, it is sometimes difficult to precisely determine the surface because a steep change in a graph of the detected amount of a characteristic X-ray of an element is not seen in principle or due to a measurement error. Thus, in the analysis of the positive electrode active material by STEM-EDX line analysis or the like, the point where the detected amount of the characteristic X-ray of the transition metal M is equal to 50% of the sum of the average value M_{AVE} of the detected amount of the characteristic X-ray of the transition metal M in the inner portion and the average value M_{BG} of the detected amount of the characteristic X-ray of the transition metal M of the background is regarded as a reference point of the surface. Alternatively, a point where the detected amount of the characteristic X-ray of oxygen is equal to 50% of the sum of the average value O_{AVE} of the detected amount of the characteristic X-ray of oxygen in the inner portion and the average value O_{BG} of the detected amount of the characteristic X-ray of oxygen of the background is regarded as a reference point of the surface. Note that in the case where the positions of these points are different, the difference is probably due to the influence of a carbonate, a metal oxide containing oxygen, or the like, which is attached to the surface; thus, the point on the basis of the transition metal M can be employed as a reference point. In the case of a positive electrode active material containing a plurality of the transition metals M, the reference point can be determined using M_{AVE} and M_{BG} of the element whose detected amount of the characteristic X-ray in the inner portion is the largest.

The average value M_{BG} of the amount of background the transition metal M can be calculated by averaging the amounts of detected transition metal M in the range greater than or equal to 2 nm, preferably greater than or equal to 3 nm, which is outside a portion of the positive electrode active material in the vicinity of the portion at which the amount of detected transition metal M begins to increase, for example. The average value M_{AVE} of the amount of detected transition metal M in the inner portion can be calculated by averaging the amounts of detected transition metal M in the range greater than or equal to 2 nm, preferably greater than or equal to 3 nm in a region where the count numbers of the transition metal M and oxygen atoms are saturated and stabilized, e.g., a portion that is greater than or equal to 30 nm, preferably greater than 50 nm in depth from the region where the amount of detected transition metal M begins to increase, for example. The average value O_{BG} of the amount of background oxygen and the average value O_{AVE} of the amount of detected oxygen in the inner portion can be calculated in a similar manner.

The surface of the positive electrode active material 100 in, for example, a cross-sectional STEM (scanning transmission electron microscope) image is a boundary between a region where an image derived from the crystal structure of the positive electrode active material is observed and a region where the image is not observed, and is determined as the outermost surface of a region where an atomic column derived from an atomic nucleus of a metal element that has a greater atomic number than lithium among the metal elements constituting the positive electrode active material is confirmed. The surface in a STEM image or the like may be judged in combination with analysis with higher spatial resolution.

A peak in STEM-EDX line analysis refers to a local maximum value of a projecting shape appearing in the graph of the characteristic X-ray intensity of each element or the maximum value of the characteristic X-ray of each element. A conceivable noise in STEM-EDX line analysis is, for example, a measured value having a half width smaller than or equal to spatial resolution (R), e.g., smaller than or equal to R/2.

The adverse effect of a noise can be reduced by scanning the same portion a plurality of times under the same conditions. For example, an integrated value obtained by performing scanning six times can be used as the detection value of each element. The number of times of scanning is not limited to six and an average of measured values obtained by performing scanning seven or more times can be used as the detection value of each element.

STEM-EDX line analysis can be performed as follows, for example. First, a protective film is deposited by evaporation over the surface of a positive electrode active material. For example, carbon can be deposited by evaporation with an ion sputtering apparatus (MC1000, produced by Hitachi High-Tech Corporation).

Next, the positive electrode active material is thinned to fabricate a STEM cross-section sample. For example, the positive electrode active material can be thinned with an FIB-SEM apparatus (XVision 200TBS, produced by Hitachi High-Tech Corporation). Here, picking up can be performed by an MPS (micro probing system), and as an example of the conditions of the finishing processing, an acceleration voltage can be 10 kV.

The STEM-EDX line analysis can be performed with a STEM apparatus (HD-2700 produced by Hitachi High-Tech Corporation) and Octane T Ultra W (with two detectors) produced by EDAX Inc can be used as EDX detectors. In the EDX line analysis, the emission current of the STEM apparatus is set to be in the range of 6 μA to 10 μA, both inclusive, and a portion of the thinned sample, which is not positioned at a deep level and has little unevenness, is measured. The magnification is 150,000 times, for example. The EDX line analysis can be performed under conditions where drift correction is performed, the line width is 42 nm, the pitch is 0.2 nm, and the number of frames is six or more.

EDX area analysis or EDX point analysis of the positive electrode active material 100 of one embodiment of the present invention preferably reveals that the concentration of each additive element, in particular, an additive element X in the surface portion 100a is higher than that in the inner portion 100b.

For example, when EDX area analysis or EDX point analysis of the positive electrode active material 100 containing magnesium as the additive element is performed, the magnesium concentration in the surface portion 100a is preferably higher than the magnesium concentration in the inner portion 100b. When the EDX line analysis is performed, the peak of the magnesium concentration in the surface portion 100a is preferably located at a depth less than or equal to 3 nm, further preferably less than or equal to 1 nm, still further preferably less than or equal to 0.5 nm from the surface of the positive electrode active material 100 or the reference point toward the center. In addition, the magnesium concentration preferably attenuates, at a depth of 1 nm from the point where the concentration reaches the peak, to less than or equal to 60% of the peak concentration. In addition, the magnesium concentration preferably attenuates, at a depth of 2 nm from the point where the concentration reaches the peak, to less than or equal to 30% of the peak concentration. Here, a “peak of concentration” refers to the local maximum value of concentration.

When the EDX line analysis is performed, the maximum value of the magnesium concentration (the detected amount of magnesium/the sum of the detected amounts of magnesium, oxygen, cobalt, fluorine, aluminum, titanium, and nickel) in the surface portion 100a is preferably greater than or equal to 0.5 Atomic % and less than or equal to 10 Atomic %, further preferably greater than or equal to 1 Atomic % and less than or equal to 5 Atomic %.

When the EDX line analysis is performed, the maximum value of the titanium concentration (the detected amount of titanium/the sum of the detected amounts of magnesium, oxygen, cobalt, fluorine, aluminum, titanium, and nickel) in the surface portion 100a is preferably greater than or equal to 0.2 Atomic % and less than or equal to 5 Atomic %, further preferably greater than or equal to 0.5 Atomic % and less than or equal to 2 Atomic %.

When the EDX line analysis is performed, the maximum value of the nickel concentration (the detected amount of nickel/the sum of the detected amounts of magnesium, oxygen, cobalt, fluorine, aluminum, titanium, and nickel) in the surface portion 100a is preferably greater than or equal to 0.2 Atomic % and less than or equal to 5 Atomic %, further preferably greater than or equal to 0.5 Atomic % and less than or equal to 3 Atomic %.

When the positive electrode active material 100 contains magnesium and fluorine as the additive elements, the distribution of fluorine preferably includes a region that overlaps with the distribution of magnesium. For example, a difference in the depth direction between the peak concentration of fluorine and the peak concentration of magnesium is preferably within 10 nm, further preferably within 3 nm, still further preferably within 1 nm.

In the EDX line analysis, a peak of the concentration of fluorine in the surface portion 100a is preferably located at a depth less than or equal to 3 nm, further preferably less than or equal to 1 nm, still further preferably less than or equal to 0.5 nm from the surface of the positive electrode active material 100 or the reference point toward the center. It is further preferable that a peak of the concentration of fluorine be exhibited slightly closer to the surface side than a peak of the concentration of magnesium is, which increases resistance to hydrofluoric acid. For example, it is preferable that a peak of the concentration of fluorine be exhibited slightly closer to the surface side than a peak of the concentration of magnesium is by 0.5 nm or more, further preferably 1.5 nm or more.

When the positive electrode active material 100 contains nickel as the additive element, a peak of the concentration of nickel in the surface portion 100a is preferably located at a depth less than or equal to 3 nm, further preferably less than or equal to 1 nm, still further preferably less than or equal to 0.5 nm from the surface of the positive electrode active material 100 or the reference point toward the center. When the positive electrode active material 100 contains magnesium and nickel, the distribution of nickel preferably includes a region overlapping with the distribution of magnesium. For example, a difference in the depth direction between a peak of the concentration of nickel and a peak of the concentration of magnesium is preferably within 3 nm, further preferably within 1 nm.

When the positive electrode active material 100 contains titanium as the additive element, the peak of the concentration of titanium in the surface portion 100a is preferably located at a depth less than or equal to 3 nm, further preferably less than or equal to 1 nm, still further preferably less than or equal to 0.5 nm from the surface of the positive electrode active material 100 or the reference point toward the center. When the positive electrode active material 100 contains magnesium and titanium, the distribution of titanium preferably includes a region overlapping with the distribution of magnesium. For example, a difference in the depth direction between a peak of the concentration of titanium and a peak of the concentration of magnesium is preferably within 3 nm, further preferably within 1 nm.

In the case where the positive electrode active material 100 contains aluminum as the additive element, the peak of the concentration of magnesium, nickel, or fluorine is preferably closer to the surface than the peak of the concentration of aluminum is in the surface portion 100a in the EDX line analysis. For example, the peak of the aluminum concentration is preferably located at a depth greater than or equal to 0.5 nm and less than or equal to 50 nm, further preferably greater than or equal to 5 nm and less than or equal to 50 nm toward the center from the surface of the positive electrode active material 100.

In the case where the positive electrode active material 100 contains magnesium, titanium, nickel, and aluminum, a battery manufactured using the positive electrode active material 100 can achieve both “high cycle performance” such that discharge capacity degradation by repetition of high-voltage charging (e.g., charging with an upper limit of 4.6 V) and discharging can be inhibited, and “excellent low-temperature characteristics” enabling high discharge capacity at low temperatures (e.g., 0° C., −20° C., and −40° C.).

When EDX line, area, or point analysis is performed on the positive electrode active material 100, the atomic ratio of magnesium Mg to cobalt Co (Mg/Co) at a peak of the concentration of magnesium is preferably greater than or equal to 0.05 and less than or equal to 0.6, further preferably greater than or equal to 0.1 and less than or equal to 0.4. The atomic ratio of aluminum Al to cobalt Co (Al/Co) at a peak of the concentration of aluminum is preferably greater than or equal to 0.05 and less than or equal to 0.6, further preferably greater than or equal to 0.1 and less than or equal to 0.45. The atomic ratio of nickel Ni to cobalt Co (Ni/Co) at a peak of the concentration of nickel is preferably greater than or equal to 0 and less than or equal to 0.2, further preferably greater than or equal to 0.01 and less than or equal to 0.1. The atomic ratio of fluorine F to cobalt Co (F/Co) at a peak of the concentration of fluorine is preferably greater than or equal to 0 and less than or equal to 1.6, further preferably greater than or equal to 0.1 and less than or equal to 1.4.

When the line analysis or the area analysis is performed on the positive electrode active material 100, the atomic ratio of the additive element to cobalt Co (A/Co) in the vicinity of a crystal grain boundary is preferably greater than or equal to 0.020 and less than or equal to 0.50. Furthermore, it is preferably greater than or equal to 0.025 and less than or equal to 0.30. Furthermore, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

When the line analysis or the area analysis is performed on the positive electrode active material 100 containing magnesium as the additive element, the atomic ratio of magnesium to cobalt (Mg/Co) in the vicinity of a crystal grain boundary is preferably greater than or equal to 0.020 and less than or equal to 0.50. Furthermore, it is preferably greater than or equal to 0.025 and less than or equal to 0.30. Furthermore, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30. When the ratio is within the above range in a plurality of portions, e.g., three or more portions, of the positive electrode active material 100, it can be said that the additive element is not attached to the surface of the positive electrode active material 100 in a narrow range but widely distributed at a preferable concentration in the surface portion 100a of the positive electrode active material 100.

### <<EPMA>>

Quantitative analysis of elements can be conducted also by EPMA (electron probe microanalysis). In area analysis, distribution of each element can be analyzed.

EPMA area analysis of a cross section of the positive electrode active material 100 of one embodiment of the present invention preferably reveals that one or two or more selected from the additive elements have a concentration gradient, as in the EDX analysis results. For example, it is further preferable that the additive elements exhibit concentration peaks at different depths from a surface. The preferred ranges of the concentration peaks of the additive elements are the same as those of the case of EDX.

Note that in EPMA, a region from a surface to a depth of approximately 1 μm is analyzed. Thus, the quantitative value of each element is sometimes different from measurement results obtained by other analysis methods. For example, when surface analysis is performed by EPMA on the positive electrode active material 100, the concentrations of the additive elements existing in the surface portion 100a might be lower than the results obtained in XPS.

### <<Raman Spectroscopy>>

As described above, at least part of the surface portion 100a of the positive electrode active material 100 of one embodiment of the present invention preferably has a rock-salt crystal structure. Thus, when the positive electrode active material 100 and a positive electrode including the positive electrode active material 100 are analyzed by Raman spectroscopy, a cubic crystal structure such as a rock-salt crystal structure is preferably observed in addition to a layered rock-salt crystal structure. In a STEM image and a nanobeam electron diffraction pattern described later, a bright spot cannot be detected when cobalt that is substituted at a lithium site, cobalt that exists at a site coordinated to four oxygen atoms, or the like does not appear with a certain frequency in the depth direction in observation. Meanwhile, Raman spectroscopy is analysis that observes a vibration mode of a bond such as a Co—O bond, so that even when the number of Co—O bonds is small, the peak of a wave number of a corresponding vibration mode can be observed in some cases. Furthermore, since Raman spectroscopy can measure a range with an area of several square micrometers and a depth of approximately 1 μm of a surface portion, states that exist only at the surface of a particle can be observed with high sensitivity.

When a laser wavelength is 532 nm, for example, peaks (vibration mode: E_{g}, A_{1g}) of layered rock-salt LiCoO₂ are observed at 470 cm⁻¹ to 490 cm⁻¹ and at 580 cm⁻¹ to 600 cm⁻¹. Meanwhile, a peak (vibration mode: A_{1g}) of cubic CoOₓ (0<x<1) (rock-salt Co_{1-y}O (0<y<1) or spinel Co₃O₄) is observed at 665 cm⁻¹ to 685 cm⁻¹.

Thus, in the case where the integrated intensities of the peak in the range from 470 cm⁻¹ to 490 cm⁻¹, the peak in the range from 580 cm⁻¹ to 600 cm⁻¹, and the peak in the range from 665 cm⁻¹ to 685 cm⁻¹ are represented by I1, I2, and I3, respectively, I3/I2 is preferably greater than or equal to 1% and less than or equal to 10%, further preferably greater than or equal to 3% and less than or equal to 9%.

In the case where a cubic crystal structure such as a rock-salt crystal structure is observed in the above-described range, it can be said that a preferable range of the surface portion 100a of the positive electrode active material 100 has a rock-salt crystal structure.

### <<Nanobeam Electron Diffraction Pattern>>

As in Raman spectroscopy, features of both a layered rock-salt crystal structure and a rock-salt crystal structure are preferably observed in a nanobeam electron diffraction pattern. Note that in consideration of the above-described difference in sensitivity, in a STEM image and a nanobeam electron diffraction pattern, it is preferable that the features of a rock-salt crystal structure not be too significant at the surface portion 100a, in particular, the outermost surface (e.g., a portion from the surface to a depth of 1 nm). This is because a diffusion path of lithium can be ensured and a function of stabilizing a crystal structure can be increased in the case where the additive element such as magnesium exists in the lithium layer while the outermost surface has a layered rock-salt crystal structure as compared with the case where the outermost surface is covered with a rock-salt crystal structure.

Thus, for example, when a nanobeam electron diffraction pattern of a region from the surface to a depth less than or equal to 1 nm and a nanobeam electron diffraction pattern of a region at a depth greater than or equal to 3 nm and less than or equal to 10 nm are obtained, the difference between lattice constants calculated from the patterns is preferably small.

For example, the difference between lattice constants calculated from a measured portion from the surface to a depth less than or equal to 1 nm and a measured portion at a depth greater than or equal to 3 nm and less than or equal to 10 nm is preferably less than or equal to 0.1 Å for the a-axis and less than or equal to 1.0 Å for the c-axis. The difference is further preferably less than or equal to 0.05 Å for the a-axis and further preferably less than or equal to 0.6 Å for the c-axis. The difference is still further preferably less than or equal to 0.04 Å for the a-axis and still further preferably less than or equal to 0.3 Å for the c-axis.

### <<Surface Roughness and Specific Surface Area>>

The positive electrode active material 100 of one embodiment of the present invention preferably has a smooth surface with little unevenness. A smooth surface with little unevenness indicates that a fusing agent described later is fully effective and the surfaces of the additive element source and lithium cobalt oxide melt. Thus, a smooth surface with little unevenness is a factor indicating a favorable distribution of the additive element in the surface portion 100a.

A smooth surface with little unevenness can be determined from, for example, a cross-sectional SEM image or a cross-sectional TEM image of the positive electrode active material 100 or the specific surface area of the positive electrode active material 100.

The level of the surface smoothness of the positive electrode active material 100 can be quantified from its cross-sectional SEM image, as described below, for example.

First, the positive electrode active material 100 is processed with an FIB or the like, so that its cross section is exposed. At this time, the positive electrode active material 100 is preferably covered with a protective film, a protective agent, or the like. Next, a SEM image of the interface between the positive electrode active material 100 and the protective film or the like is taken. The SEM image is subjected to noise processing using image processing software. For example, the Gaussian Blur (=2) is performed, followed by binarization. In addition, interface extraction is performed using image processing software. Moreover, an interface line between the positive electrode active material 100 and the protective film or the like is selected with an automatic selection tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square surface roughness (RMS) is obtained by calculating standard deviation. This surface roughness refers to the surface roughness in at least 400 nm of the particle periphery of the positive electrode active material.

On the surface of the particle of the positive electrode active material 100 of this embodiment, root-mean-square (RMS) surface roughness, which is an index of roughness, is preferably less than 3 nm, further preferably less than 1 nm, still further preferably less than 0.5 nm.

Note that the image processing software used for the noise processing, the interface extraction, or the like is not particularly limited, and for example, “ImageJ” described in Non-Patent Document 8 to Non-Patent Document 10 can be used. In addition, the spreadsheet software or the like is not particularly limited, and Microsoft Office Excel can be used, for example.

For example, the level of surface smoothness of the positive electrode active material 100 can also be quantified from the ratio of an actual specific surface area SR measured by a constant-volume gas adsorption method to an ideal specific surface area Si.

The ideal specific surface area Si is calculated on the assumption that all the particles have the same diameter as D50, have the same weight, and have ideal spherical shapes.

The median diameter D50 can be measured with a particle size distribution analyzer or the like using a laser diffraction and scattering method. The specific surface area can be measured with a specific surface area analyzer or the like by a constant-volume gas adsorption method, for example.

In the positive electrode active material 100 of one embodiment of the present invention, the ratio SR/Si of the actual specific surface area SR to the ideal specific surface area Si obtained from the median diameter D50 is preferably less than or equal to 2.1.

Alternatively, the level of the surface smoothness of the positive electrode active material 100 can be quantified from its cross-sectional SEM image by the following method.

First, a surface SEM image of the positive electrode active material 100 is obtained. At this time, conductive coating may be performed as pretreatment for observation. The surface to be observed is preferably vertical to an electron beam. In the case of comparing a plurality of samples, the same measurement conditions and the same observation area are adopted.

Then, the above SEM image is converted into an 8-bit image (which is referred to as a grayscale image) with the use of image processing software (e.g., “ImageJ”). The grayscale image includes luminance (brightness information). For example, in an 8-bit grayscale image, luminance can be represented by 28-256 gradation levels. A dark portion has a low gradation level and a bright portion has a high gradation level. A variation in luminance can be quantified in relation to the number of gradation levels. The quantified value is referred to as a grayscale value. By obtaining a grayscale value, the unevenness of the positive electrode active material can be evaluated quantitatively.

In addition, a variation in luminance in a target region can also be represented with a histogram. A histogram three-dimensionally shows distribution of gradation levels in a target region and is also referred to as a luminance histogram. A luminance histogram enables visually easy-to-understand evaluation of unevenness of the positive electrode active material.

In the case where the positive electrode active material 100 of one embodiment of the present invention is evaluated, the difference between the maximum grayscale value and the minimum grayscale value is preferably less than or equal to 120, further preferably less than or equal to 115, still further preferably greater than or equal to 70 and less than or equal to 115. The standard deviation of the grayscale value is preferably less than or equal to 11, further preferably less than or equal to 8, still further preferably greater than or equal to 4 and less than or equal to 8.

<Particle Size Distribution Analysis with Cross-Sectional SEM Image of Positive Electrode>

The particle size distribution of the positive electrode active material 100 can also be calculated from the cross-sectional SEM image of the positive electrode active material 100 by the following method.

First, an analysis region is cut out from the obtained cross-sectional SEM image. For example, as a range with a sufficient area for image analysis, a range of greater than or equal to 50 um x greater than or equal to 100 μm can be cut out; however, one embodiment of the present invention is not limited thereto. A smaller area or a larger area may be cut out depending on factors such as the size of the positive electrode active material.

Note that a function of image processing software may be used to cut out the cross-sectional SEM image. For example, ImageJ may be used as the image processing software and the image may be cut out by the crop function of Image J.

Next, a first image cut out by the image processing software is binarized and subjected to particle analysis.

ImageJ can be used as the image processing software, for example. The binarization processing is described below. The first image represented by a 256-level grayscale is used as a frequency graph excluding black (a value of 0) and white (a value of 255), and as the half width at half maximum (HWHM) of the maximum peak, HWHM on the low-level side (HWHM_L) and HWHM on the high-level side (HWHM_H) are obtained. Next, the minimum value a of a range on the low-level side having a width that is twice HWHM_L and the maximum value b of a range on the high-level side having a width that is twice HWHM_H are determined from the value at the peak top (maximum frequency) of the maximum peak.

Next, binarization processing is performed such that the range of values less than a is white, the range of values from a to b, inclusive, is black, and the range of values greater than b is white. Specifically, the binarization as Threshold (a, b) is performed with Threshold function of ImageJ. After that, random bright spots that are probably attributed to the conductive material are removed under the conditions of Gray Morphology (radius=3, operator=open, type=circle) and Gray Morphology (radius=1, operator=close, type=circle), so that a second image can be obtained.

Next, particles with a particle size (projected area) greater than or equal to 0.5 μm² and less than or equal to 700 μm² are detected using the second image by the Analyze Particles function of ImageJ, whereby the area S of each particle is obtained. Next, the diameter r of each particle is calculated on the basis of the area S of each particle (Formula 1).

$$\begin{matrix}[ Formula 1 ] & \\ r = 2 \times \sqrt{( S / π )} & ( 1 )\end{matrix}$$

In this manner, the particle size distribution can be calculated from the cross-sectional SEM image. Performing the above analysis is referred to as performing particle size distribution analysis using a cross-sectional SEM image of a positive electrode.

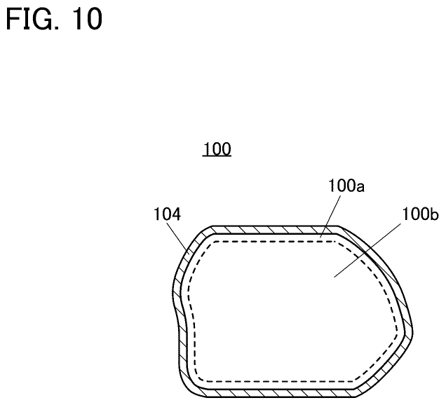

A coating portion may be attached to at least part of the surface of the positive electrode active material 100. FIG. 10 illustrates an example of the positive electrode active material 100 to which the coating portion 104 is attached.

The coating portion 104 is preferably formed by deposition of decomposition products of an electrolyte and an organic electrolyte solution due to charge and discharge, for example. A coating portion originating from an electrolyte solution, which is on the surface of the positive electrode active material 100, is expected to improve charge and discharge cycle performance particularly when charging making x in LiₓCoO₂ be less than or equal to 0.24 is repeated. This is because an increase in impedance of the surface of the positive electrode active material is inhibited or dissolution of cobalt is inhibited, for example. The coating portion 104 preferably contains carbon, oxygen, and fluorine, for example. The coating portion can have high quality easily when the electrolyte solution contains LiBOB and/or SUN (suberonitrile), for example.

Accordingly, the coating portion 104 preferably contains one or two or more selected from boron, nitrogen, sulfur, and fluorine to possibly have high quality. The coating portion 104 does not necessarily cover the positive electrode active material 100 entirely. For example, the coating portion 104 covers greater than or equal to 50%, preferably greater than or equal to 70%, further preferably greater than or equal to 90% of the surface of the positive electrode active material 100.

### <<Powder Resistance Measurement>

The positive electrode active material 100 of one embodiment of the present invention has a stable crystal structure even at a high voltage. The stable crystal structure of the positive electrode active material in a charged state can inhibit a decrease in charge and discharge capacity due to repeated charge and discharge. In <<XRD>> above, the positive electrode active material 100 having excellent characteristics as described above is described as having a feature of having the O3′ type structure and/or the monoclinic O1(15) type structure when x in LiₓCoO₂ is small. In <<EDX>> above, the preferable distributions of the additive elements in the STEM-EDX analysis of the positive electrode active material 100 are described. Furthermore, the positive electrode active material 100 of one embodiment of the present invention also has a feature in the volume resistivity of powder.

As the feature of the positive electrode active material 100 of one embodiment of the present invention, the volume resistivity of the powder of the positive electrode active material 100 is preferably higher than or equal to 1.0×10⁸ Ω·cm and lower than or equal to 1.0×10¹⁰ Ω·cm, further preferably higher than or equal to 5.0×10⁸ Ω·cm and lower than or equal to 1.5×10⁹ Ω·cm under a pressure of 64 MPa.

The positive electrode active material 100 with the above volume resistivity has a stable crystal structure at a high voltage, and can indicate the favorable formation of the surface portion 100a, which is an important factor for a stable crystal structure of a positive electrode active material in a charged state.

A method for measuring the volume resistivity of the powder of the positive electrode active material 100 of one embodiment of the present invention is described.

For measurement of the volume resistivity of the powder, a device portion including terminals for resistance measurement and a mechanism for applying pressure to the powder serving as a measurement target are preferably provided. The terminals for resistance measurement are preferably four terminals (also referred to as four probes). As such a measurement apparatus that includes the terminals for resistance measurement and the mechanism for applying pressure to the powder as a measurement target (sample), for example, MCP-PD51 produced by Mitsubishi Chemical Analytech Co., Ltd. can be used. As the resistance measurement device, the low resistance meter Loresta-GP or the high resistance meter Hiresta-GP can be used. The Loresta-GP can be used for measurement of a low-resistance sample, and the Hiresta-GP can be used for measurement of a high-resistance sample. Note that the measurement environment is preferably a stable environment such as a dry room. In the environment of a dry room, the temperature is preferably 25° C. and the dew point is preferably lower than or equal to −40° C., for example. When the measurement is performed in a high-humidity environment, the electric resistance may be lowered by the influence of moisture in the air, so that an original physical property value cannot be obtained in some cases.

The measurement of the volume resistivity of the powder using the above-described measurement apparatus is described. First, a powder sample is set in a measurement unit. The measurement unit has a structure in which the powder sample and the terminals for resistance measurement are in contact with each other, and pressure can be applied to the powder sample. A structure for measuring the volume of a powder sample in the measurement unit is also included. Specifically, the measurement unit includes a cylindrical space, and the powder sample is set in the space. In the structure for measuring the volume of the powder sample, the volume occupied by the powder set in the space can be measured by measuring the height of the powder.

In the measurement of the volume resistivity of the powder, the electric resistance and volume of the powder under pressure are measured. The pressure applied to the powder can be varied. For example, the electric resistance and volume of the powder can be measured under pressures of 16 MPa, 25 MPa, 38 MPa, 51 MPa, and 64 MPa. The volume resistivity of the powder can be calculated from the values of the measured electric resistance and volume of the powder.

In the case where the above-described measurement under a pressure of 64 MPa is performed and the volume resistivity of the powder of the positive electrode active material 100 of one embodiment of the present invention is measured to be higher than or equal to 1.0×10⁸ Ω·cm and lower than or equal to 1.0×10¹⁰ Ω·cm, good cycle performance is obtained in a charge and discharge cycle test under the high charge voltage condition, and better cycle performance is obtained in the charge and discharge cycle test under the high charge voltage condition in the case where the volume resistivity is measured to be higher than or equal to 5.0×10⁸ Ω·cm and lower than or equal to 1.5×10⁹ Ω·cm.

In this specification and the like, unless otherwise specified, the volume resistivity measured as described above is the volume resistivity of the powder.

### <<Ion Chromatography>>

A method of ion chromatography measurement of the powder of the positive electrode active material 100 of one embodiment of the present invention is described. In the ion chromatography measurement, a pretreatment step of dissolving the powder of the positive electrode active material 100 in acid to obtain a measurement solution and a measurement step of measuring the solution are performed.

There is no particular limitation on the apparatus and conditions for ion chromatography. For example, the measurement can be performed using the following apparatus and conditions.

As an apparatus for ion chromatography, an ion chromatography system Dionex ICS-2100 produced by Thermo Fisher Scientific Inc. can be used, for example.

An example of the pretreatment for ion chromatography is described. Two hundred and fifty milligrams of powder of the positive electrode active material 100 and 2 ml of a 0.05-M H₂SO₄ aqueous solution are prepared, put into a glass container with a lid, and mixed, whereby a first mixture solution is obtained. For the mixing, an ultrasonic wave is preferably applied for approximately one hour. After that, the container is left to stand at normal temperature for 12 hours or longer. After that, 1 ml of a filtrate obtained by filtration of the first mixed solution and 9 ml of pure water are mixed, whereby a second mixed solution is obtained. In this manner, pretreatment of the powder of the positive electrode active material 100 can be performed.

Next, ion chromatography is performed using the second mixed solution obtained in the above pretreatment. Anion analysis and cation analysis are preferably performed in ion chromatography.

An example of the anion analysis conditions is shown below. The anion analysis can be performed at 35° C. with the use of a Dionex IonPac AG20 column (2×50 mm) and a Dionex IonPac AS20 column (2×250 mm). The eluent is preferably a KOH aqueous solution and the flow rate is preferably 0.44 ml/min. Note that gradient measurement is preferably performed such that the concentration of the KOH aqueous solution is gradually increased. A conductivity detector can be used as the detector, and a calibration curve can be created with an anion mixed standard solution produced by Kanto Chemical Co., Inc.

An example of the cation analysis conditions is shown below. The cation analysis can be performed at 30° C. with the use of a Dionex IonPac CG16 column (3×50 mm) and a Dionex IonPac CS16 column (3×250 mm). The eluent is preferably a methanesulfonic acid (MSA) aqueous solution and the flow rate is preferably 0.36 ml/min. Note that isocratic measurement is preferably performed with the concentration of the MSA aqueous solution kept constant. A conductivity detector can be used as the detector, and a calibration curve can be created with a cation mixed standard solution produced by Kanto Chemical Co., Inc.

The ion chromatography measurement described above allows quantitative measurement of fluorine (F), chlorine (Cl), or the like in the anion analysis, for example, and allows quantitative measurement of lithium (Li), magnesium (Mg), cobalt (Co), nickel (Ni), or the like in the cation analysis, for example.

In the ion chromatography measurement of the powder of the positive electrode active material 100 of one embodiment of the present invention, the weight of fluorine is preferably greater than or equal to 100 ppm and less than or equal to 1000 ppm, further preferably greater than or equal to 100 ppm and less than or equal to 200 ppm with respect to the weight of the powder.

This embodiment can be used in combination with the other embodiments.

### Embodiment 2

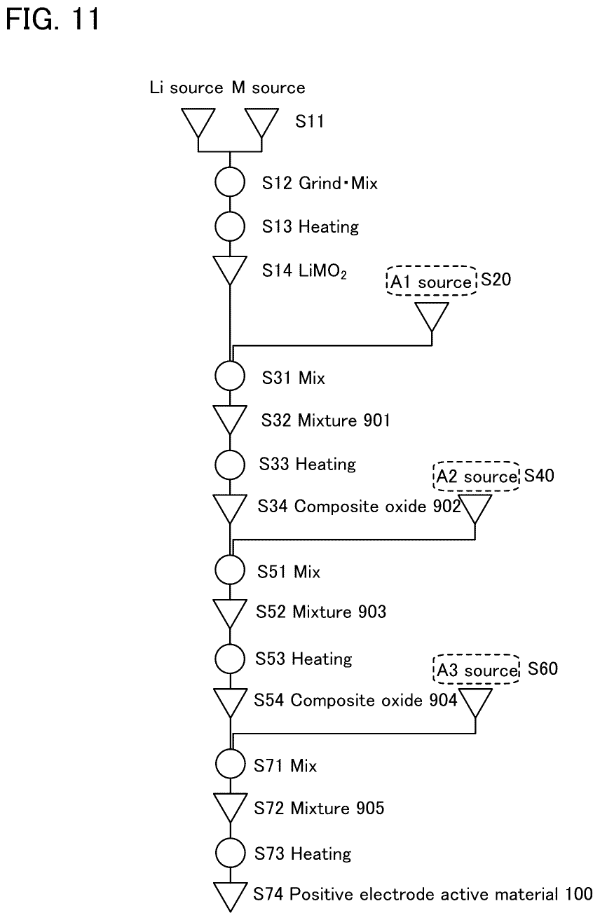

This embodiment will describe examples of a formation method of the positive electrode active material 100 of one embodiment of the present invention with reference to FIG. 11 to FIG. 14.

The way of adding an additive element is important in forming the positive electrode active material 100 having the distribution of the additive element, the composition, and/or the crystal structure that are/is described in the above embodiment. Favorable crystallinity of the inner portion 100b is important as well.

Thus, in the case where cobalt is mainly used as the transition metal M in the positive electrode active material 100, it is preferable that lithium cobalt oxide be synthesized first, then an additive element source be mixed, and heat treatment be performed in the formation process.

In a method of synthesizing lithium cobalt oxide containing an additive element by mixing an additive element source concurrently with a cobalt source and a lithium source, it is difficult to increase the concentration of the additive element in the surface portion 100a. In addition, after lithium cobalt oxide is synthesized, only mixing an additive element source without performing heating causes the additive element to be just attached to the lithium cobalt oxide without forming a solid solution therewith. It is difficult to distribute the additive element suitably without sufficient heating. Thus, it is preferable that the lithium cobalt oxide be synthesized, then the additive element source be mixed, and heat treatment be performed. The heat treatment after mixing of the additive element source may be referred to as annealing.

However, annealing at an excessively high temperature causes cation mixing, which increases the possibility of entry of the additive element such as magnesium into the cobalt sites. Magnesium that exists at the cobalt sites does not have an effect of maintaining a layered rock-salt crystal structure belonging to R-3m when x in LiₓCO₂ is small. Furthermore, heat treatment at an excessively high temperature might have an adverse effect; for example, cobalt might be reduced to have a valence of two or lithium might be evaporated.

In view of the above, a material functioning as a fusing agent is preferably mixed together with the additive element source. A material having a lower melting point than lithium cobalt oxide can be regarded as a material functioning as a fusing agent. For example, a fluorine compound such as lithium fluoride is suitable. Addition of a fusing agent lowers the melting points of the additive element source and lithium cobalt oxide. Lowering the melting points makes it easier to suitably distribute the additive element at a temperature at which cation mixing is less likely to occur.

### <<Manufacturing Method 1 of Positive Electrode Active Material>>

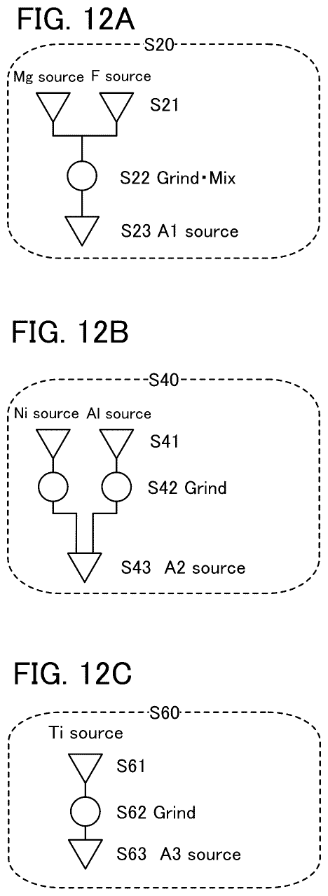

A formation method 1 of the positive electrode active material 100 is described with reference to FIG. 11 to FIG. 12C.

### <Step S11>

In Step S11 shown in FIG. 11, a lithium source (Li source) and a transition metal M source (M source) are prepared as materials of lithium and the transition metal M which are starting materials. Here, an example of using cobalt as the transition metal M is described. As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used, and for example, cobalt oxide such as tricobalt tetraoxide or cobalt hydroxide can be used.

The cobalt source preferably has a high purity and is preferably a material having a purity of higher than or equal to 3N (99.9%), further preferably higher than or equal to 4N (99.99%), still further preferably higher than or equal to 4N5 (99.995%), yet further preferably higher than or equal to 5N (99.999%), for example. Impurities of the positive electrode active material can be controlled by using such a high-purity material. As a result, a secondary battery with increased capacity and/or increased reliability can be obtained.

Furthermore, the cobalt source preferably has high crystallinity and for example, the cobalt source preferably includes single crystal grains. The crystallinity of the cobalt source can be evaluated with a TEM (transmission electron microscope) image, a STEM (scanning transmission electron microscope) image, a HAADF-STEM (high-angle annular dark-field scanning transmission electron microscope) image, or an ABF-STEM (annular bright-field scanning transmission electron microscope) image or by X-ray diffraction (XRD), electron diffraction, neutron diffraction, or the like. Note that the above methods for evaluating crystallinity can also be employed to evaluate the crystallinity of materials other than the cobalt source.

### <Step S12>

Next, in Step S12 shown in FIG. 11, the lithium source and the cobalt source are ground and mixed to form a mixed material. The grinding and mixing can be performed by a dry method or a wet method. A wet method is preferred because it can crush a material into a smaller size. When the grinding and mixing are performed by a wet method, a solvent is prepared. As the solvent, a ketone such as acetone, an alcohol such as ethanol or isopropanol, an ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the cobalt source be mixed into dehydrated acetone whose moisture content is less than or equal to 10 ppm and which has a purity higher than or equal to 99.5% in the grinding and mixing. With use of dehydrated acetone with the above-described purity, impurities that might be mixed can be reduced.

A ball mill, a bead mill, or the like can be used as a means of the grinding and mixing. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the peripheral speed is set to 838 mm/s (the rotational frequency is 400 rpm, and the diameter of the ball mill is 40 mm).

### <Step S13>

Next, the mixed material is heated in Step S13 shown in FIG. 11. The heating is preferably performed at a temperature higher than or equal to 800° C. and lower than or equal to 1100° C., further preferably at a temperature higher than or equal to 900° C. and lower than or equal to 1000° C., still further preferably at a temperature approximately 950° C. An excessively low temperature might lead to insufficient decomposition and melting of the lithium source and the cobalt source. Meanwhile, an excessively high temperature might lead to a defect due to evaporation of lithium from the lithium source and/or excessive reduction of cobalt, for example. An oxygen vacancy or the like might be induced by a change of trivalent cobalt into divalent cobalt, for example.

When the heating time is too short, lithium cobalt oxide is not synthesized, but when the heating time is too long, the productivity is lowered. For example, the heating time is preferably longer than or equal to one hour and shorter than or equal to 100 hours, further preferably longer than or equal to two hours and shorter than or equal to 20 hours.

A temperature rising rate is preferably higher than or equal to 80° C./h and lower than or equal to 250° C./h, although depending on the end-point temperature of the heating. For example, in the case of heating at 1000° C. for 10 hours, the temperature rising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, for example, a dry air is continuously introduced into a reaction chamber. The flow rate of a dry air in this case is preferably 10 L/min. A method of continuously introducing oxygen into a reaction chamber to make oxygen flow therein is referred to as flowing.

In the case where the heating atmosphere is an oxygen-containing atmosphere, flowing is not necessarily performed. For example, a method may be employed in which the pressure in the reaction chamber is reduced, the reaction chamber is then filled (which may also be referred to as purged) with oxygen, and the entry and exit of the oxygen from the reaction chamber are prevented. For example, the pressure in the reaction chamber is reduced to −970 hPa and then, the reaction chamber is filled with oxygen until the pressure becomes 50 hPa.

Cooling after the heating can be performed by natural cooling, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

As a crucible used at the time of the heating, a crucible made of aluminum oxide is preferable. A crucible made of aluminum oxide has a material property that hardly releases impurities. In this embodiment, a crucible made of aluminum oxide with a purity of 99.9% is used. The heating is preferably performed with the crucible covered with a lid. This can prevent volatilization of the material.

A crucible that has been used a plurality of times is preferred to a new crucible. In this specification and the like, a new crucible refers to a crucible that is subjected to a heating step two or less times while a material containing lithium, the transition metal M, and/or the additive element is contained therein. A crucible that has been used a plurality of times refers to a crucible that is subjected to a heating step three or more times while a material containing lithium, the transition metal M, and/or the additive element is contained therein. In the case where a new crucible is used, some materials such as lithium fluoride might be absorbed by, diffused in, transferred to, and/or attached to a sagger at the time of heating. Loss of some materials due to such phenomena increases a concern that an element is not distributed in a preferred range particularly in the surface portion of the positive electrode active material. In contrast, such a risk is low in the case of a crucible that has been used a plurality of times.

The heated material is ground as needed and may be made to pass through a sieve. Before collection of the heated material, the material may be moved from the crucible to a mortar. An agate mortar or a partially stabilized zirconium oxide mortar is preferably used. Note that heating conditions equivalent to those in Step S13 can be employed in a later-described heating step other than Step S13.

### <Step S14>

Through the above steps, lithium cobalt oxide (LiCoO₂) shown in Step S14 in FIG. 11 can be synthesized.

Although the example is described in which the composite oxide is formed by a solid phase method as in Step S11 to Step S14, the composite oxide may be formed by a coprecipitation method. Alternatively, the composite oxide may be formed by a hydrothermal method.

Note that lithium cobalt oxide synthesized in advance may be used in Step S14. In this case, Step S11 to Step S13 can be omitted. When Step S15 is performed on the pre-synthesized lithium cobalt oxide, lithium cobalt oxide with a smooth surface can be obtained.

### <Step S20>

Next, as shown in Step S20, the additive element is preferably added to the lithium cobalt oxide. Because the formation method of the positive electrode active material described in this embodiment separates addition of the additive elements into a plurality of steps, in the flowchart shown in FIG. 11, the additive element to be added first is referred to as A1, the additive element to be added second is referred to as A2, and the additive element to be added third is referred to as A3. The step of adding an additive element A1 is described with reference to FIG. 12A.

### <Step S21>

In Step S21 shown in FIG. 12A, an additive element source (A1 source) to be added to the lithium cobalt oxide is prepared. A lithium source may be prepared in addition to the A1 source.

As the additive element A1, any of the additive elements described in the above embodiment can be used. Specifically, one or two or more selected from magnesium, fluorine, nickel, aluminum, titanium, zirconium, vanadium, iron, manganese, chromium, niobium, arsenic, zinc, silicon, sulfur, phosphorus, and boron can be used. Furthermore, one or two selected from bromine and beryllium can be used.

When magnesium is selected as the additive element, the additive element source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element, the additive element source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can be used also as the lithium source. Another example of the lithium source that can be used in Step S21 is lithium carbonate.

The fluorine source may be a gas, and fluorine (F₂), carbon fluoride, sulfur fluoride, oxygen fluoride (e.g., OF₂, O₂F₂, O₃F₂, O₄F₂, O₅F₂, O₆F₂, or O₂F), nitrogen trifluoride (NF₃), or the like may be used and mixed in the atmosphere in a heating step described later. Two or more of these fluorine sources may be used.

In the formation method 1 of the positive electrode active material described with reference to FIG. 11 to FIG. 12C, magnesium and fluorine are used as the additive element A1. Lithium fluoride (LiF) is prepared as the fluorine source, and magnesium fluoride (MgF₂) is prepared as the fluorine source and the magnesium source. When lithium fluoride and magnesium fluoride are mixed at approximately LiF:MgF₂=65:35 (molar ratio), the effect of lowering the melting point is maximized. Meanwhile, when the proportion of lithium fluoride increases, cycle performance might be degraded because of an excessive amount of lithium. Thus, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 or an approximate value thereof). Note that in this specification and the like, “an approximate value of a given value” means a value greater than 0.9 times and less than 1.1 times the given value.

### <Step S22>

Next, in Step S22 shown in FIG. 12A, the magnesium source and the fluorine source are ground and mixed. Any of the conditions for grinding and mixing that are described for Step S12 can be selected to perform this step.

### <Step S23>

Next, in Step S23 shown in FIG. 12A, the materials ground and mixed in the above step are collected, so that the A1 source can be obtained. Note that the A1 source in Step S23 contains a plurality of starting materials and can be referred to as a mixture.

As for the particle diameter of the mixture, D50 (median diameter) is preferably greater than or equal to 600 nm and less than or equal to 10 μm, further preferably greater than or equal to 1 μm and less than or equal to 5 μm. Also when one kind of material is used as the additive element source, D50 (median diameter) is preferably greater than or equal to 600 nm and less than or equal to 10 μm, further preferably greater than or equal to 1 μm and less than or equal to 5 μm.

Such a pulverized mixture (which may include only one kind of the additive element) is easily attached to the surface of lithium cobalt oxide particles uniformly in a later step of mixing with the lithium cobalt oxide. The mixture is preferably attached uniformly to the surface of the lithium cobalt oxide particles, in which case the additive element is easily distributed or dispersed uniformly in the surface portion 100a of the composite oxide after heating.

### <Step S31>

Next, in Step S31 shown in FIG. 11, the lithium cobalt oxide and the A1 source are mixed. The ratio of the number of cobalt atoms Co in the lithium cobalt oxide to the number of magnesium atoms Mg contained in the A1 source is preferably Co:Mg=100:y (0.1≤y≤6), further preferably M:Mg=100:y (0.3≤y≤3).

The condition of the mixing in Step S31 is preferably milder than that of the mixing in Step S12 not to damage the lithium cobalt oxide particle shape. For example, conditions with a lower rotational frequency or a shorter time than those for the mixing in Step S12 are preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 11, the materials mixed in the above step are collected, whereby a mixture 901 is obtained. At the time of the collection, the materials may be crushed as needed and made to pass through a sieve.

### <Step S33>

Then, in Step S33 shown in FIG. 11, the mixture 901 is heated. Any of the heating conditions described for Step S13 can be selected for this heating. The heating time is preferably longer than or equal to 2 hours. Here, the pressure in a furnace may be higher than atmospheric pressure to make the oxygen partial pressure of the heating atmosphere high. An insufficient oxygen partial pressure of the heating atmosphere might cause reduction of cobalt or the like and hinder the lithium cobalt oxide or the like from maintaining a layered rock-salt crystal structure.

Here, a supplementary explanation of the heating temperature is given. The lower limit of the heating temperature in Step S33 needs to be higher than or equal to the temperature at which a reaction between the lithium cobalt oxide and the additive element source proceeds. The temperature at which the reaction proceeds is the temperature at which interdiffusion of the elements contained in the lithium cobalt oxide and the additive element source occurs, and may be lower than the melting temperatures of these materials. It is known that in the case of an oxide as an example, solid phase diffusion occurs at the temperature 0.757 times the melting temperature Tm (the Tamman temperature Ta). Accordingly, the heating temperature in Step S33 is higher than or equal to 650° C.

Needless to say, the reaction more easily proceeds at a temperature higher than or equal to the temperature at which one or two or more selected from the materials contained in the mixture 901 are melted. For example, in the case where LiF and MgF₂ are contained as the additive element sources, the lower limit of the heating temperature in Step S33 is preferably higher than or equal to 742° C. because the eutectic point of LiF and MgF₂ is around 742° C.

The mixture 901 obtained by mixing at LiCoO₂: LiF:MgF₂=100:0.33:1 (molar ratio) exhibits an endothermic peak at around 830° C. in differential scanning calorimetry measurement (DSC measurement). Thus, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of lithium cobalt oxide might be decomposed. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 650° C. and lower than or equal to 1130° C., further preferably higher than or equal to 650° C. and lower than or equal to 1000° C., still further preferably higher than or equal to 650° C. and lower than or equal to 950° C., yet still further preferably higher than or equal to 650° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is preferably higher than or equal to 800° C. and lower than or equal to 1100° C., further preferably higher than or equal to 830° C. and lower than or equal to 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C.

In addition, at the time of heating the mixture 901, the partial pressure of fluorine or a fluoride originating from the fluorine source or the like is preferably controlled to be within an appropriate range.

In the formation method described in this embodiment, some of the materials, e.g., LiF as the fluorine source, function as a fusing agent in some cases. Owing to this function, the heating temperature can be lower than the decomposition temperature of the lithium cobalt oxide, e.g., a temperature higher than or equal to 742° C. and lower than or equal to 950° C., which allows distribution of the additive element such as magnesium in the surface portion and manufacture of the positive electrode active material having favorable characteristics.

However, since LiF in a gas state has a specific gravity less than that of oxygen, the heating might volatilize or sublimate LiF. In the case where LiF is volatilized, LiF in the mixture 901 decreases. As a result, the function as a fusing agent deteriorates. Thus, heating needs to be performed while volatilization of LiF is inhibited. Note that even when LiF is not used as the fluorine source or the like, Li at the surface of LiCoO₂ and F of the fluorine source might react to produce LiF, which might be volatilized. Thus, such inhibition of volatilization is needed also when a fluoride having a higher melting point than LiF is used.

In view of this, the mixture 901 is preferably heated in an atmosphere containing LiF, i.e., the mixture 901 is preferably heated in a state where the partial pressure of LiF in the heating furnace is high. Such heating can inhibit volatilization of LiF in the mixture 901. The heating in this step is preferably performed such that the particles of the mixture 901 are not adhered to each other. Adhesion of the particles of the mixture 901 during the heating might decrease the area of contact with oxygen in the atmosphere and block a path of diffusion of the additive element (e.g., fluorine), thereby worsening the distribution of the additive element (e.g., magnesium and fluorine) in the surface portion.

It is considered that a uniform distribution of the additive element (e.g., fluorine) in the surface portion leads to a smooth positive electrode active material with little unevenness. Thus, it is preferable that the particles of the mixture 901 not be adhered to each other in order to allow the smooth surface obtained through the heating in Step S15 to be maintained or to be smoother in this step.

In the case of using a rotary kiln for the heating, the heating is preferably performed while the flow rate of an oxygen-containing atmosphere in the kiln is controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 901 can be heated in an atmosphere containing LiF with the container in which the mixture 901 is put covered with a lid.

A supplementary explanation of the heating time is given. The heating time depends on conditions such as the heating temperature and the size and composition of the lithium cobalt oxide in Step S14. In the case where the lithium cobalt oxide is small, it is sometimes preferable that the heating be performed at a lower temperature or for a shorter time than in the case where the lithium cobalt oxide is large.

In the case where the lithium cobalt oxide in Step S14 in FIG. 11 has a median diameter (D50) of approximately 12 μm, the heating temperature is preferably higher than or equal to 650° C. and lower than or equal to 950° C., for example. The heating time is preferably longer than or equal to 3 hours and shorter than or equal to 60 hours, further preferably longer than or equal to hours and shorter than or equal to 30 hours, still further preferably approximately 20 hours, for example. Note that the temperature decreasing time after the heating is, for example, preferably 10 longer than or equal to 10 hours and shorter than or equal to 50 hours.

In the case where the lithium cobalt oxide in Step S14 has a median diameter (D50) of approximately 7 μm, the heating temperature is preferably higher than or equal to 650° C. and lower than or equal to 950° C., for example. The heating time is preferably longer than or equal to one hour and shorter than or equal to 10 hours, further preferably approximately five hours, for example. Note that the temperature decreasing time after the heating is, for example, preferably longer than or equal to 10 hours and shorter than or equal to 50 hours.

### <Step S34>

Next, the heated material is collected in Step S34 shown in FIG. 11, in which crushing is performed as needed; thus, a composite oxide 902 is obtained.

### <Step S40>

Next, in Step S40 shown in FIG. 11, an additive element source (42 source) is used. As an additive element A2, any of the additive elements mentioned in description of Step S21 can be used. In the formation method 1 of the positive electrode active material described with reference to FIG. 11 to FIG. 12C, nickel and aluminum are used as the additive element A2. As the nickel source, nickel oxide, nickel hydroxide, or the like can be used. As the aluminum source, aluminum oxide, aluminum hydroxide, or the like can be used. As shown in Step S41 to Step S43 in FIG. 12B, the nickel source and the aluminum source can be ground to serve as the A2 source. For the conditions of grinding, the conditions of Step S22 can be referred to.

### <Step S51>

Next, in Step S51 shown in FIG. 11, the composite oxide 902 and the A2 source are mixed. For the mixing conditions, the description of Step S31 can be referred to.

### <Step S52>

Next, in Step S52 shown in FIG. 11, the materials mixed in the above step are collected, whereby a mixture 903 is obtained. At the time of the collection, the materials may be crushed as needed and made to pass through a sieve.

### <Step S53>

Then, in Step S53 shown in FIG. 11, the mixture 903 is heated. For the heating conditions, the description of Step S33 can be referred to.

### <Step S54>

Next, the heated material is collected in Step S54 shown in FIG. 11, in which crushing is performed as needed; thus, a composite oxide 904 is obtained.

### <Step S60>

Next, in Step S60 shown in FIG. 11, an additive element source (43 source) is used. As an additive element A3, any of the additive elements mentioned in description of Step S21 can be used. In the formation method 1 of the positive electrode active material described with reference to FIG. 11 to FIG. 12C, titanium is used as the additive element A3. As a titanium source, lithium titanate, titanium oxide, titanium hydroxide, or the like can be used. As shown in Step S61 to Step S63 in FIG. 12C, the titanium source can be ground to serve as the A3 source. For the conditions of grinding, the conditions of Step S22 can be referred to.

### <Step S71>

Next, in Step S71 shown in FIG. 11, the composite oxide 904 and the A3 source are mixed. For the mixing conditions, the description of Step S31 can be referred to.

### <Step S72>

Next, in Step S72 shown in FIG. 11, the materials mixed in the above step are collected, whereby a mixture 905 is obtained. At the time of the collection, the materials may be crushed as needed and made to pass through a sieve.

### <Step S73>

Then, in Step S73 shown in FIG. 11, the mixture 905 is heated. For the heating conditions, the description of Step S33 can be referred to.

### <Step S74>

Next, in Step S74 shown in FIG. 11, the heated material is collected and then crushed as need to obtain the positive electrode active material 100. Here, the collected particles are preferably made to pass through a sieve. Through the above process, the positive electrode active material 100 of one embodiment of the present invention can be formed. The positive electrode active material of one embodiment of the present invention has a smooth surface.

The positive electrode active material 100 with a smooth surface may be less likely to be physically broken by pressure application or the like than a positive electrode active material without a smooth surface. For example, the positive electrode active material 100 is unlikely to be broken in a test involving pressure application such as a nail penetration test, which can result in high safety.

### [Initial Heating]

It is sometimes further preferable that in the formation method described above, heating be also performed after the synthesis of the lithium cobalt oxide but before the mixing of the additive element. This heating is referred to as initial heating.

Owing to influence of lithium extraction from part of the surface portion 100a of the lithium cobalt oxide by the initial heating, the distribution of the additive element becomes more favorable.

Specifically, the distributions of the additive elements can be easily made different from each other by the initial heating in the following mechanism. First, lithium is extracted from part of the surface portion 100a by the initial heating. Next, additive element sources such as a nickel source, an aluminum source, and a magnesium source and lithium cobalt oxide including the surface portion 100a that is deficient in lithium are mixed and heated. Among the additive elements, magnesium is a divalent representative element, and nickel is a transition metal but is likely to be a divalent ion. Thus, in part of the surface portion 100a, a rock-salt phase containing Co²⁺, which is obtained by reduction due to lithium deficiency, Mg²⁺, and Ni²⁺ is formed. Note that this phase is formed in part of the surface portion 100a, and thus is sometimes not clearly observed in an image obtained with an electron microscope, such as a STEM image, and an electron diffraction pattern.

Among the additive elements, nickel is likely to form a solid solution and is diffused to the inner portion 100b in the case where the surface portion 100a is the lithium cobalt oxide that has a layered rock-salt crystal structure, but nickel is likely to remain in the surface portion 100a in the case where part of the surface portion 100a has a rock-salt crystal structure. Thus, the initial heating can make it easy for a divalent additive element such as nickel to remain in the surface portion 100a. The effect of this initial heating is large particularly at the surface having an orientation other than the (001) orientation of the positive electrode active material 100 and the surface portion 100a thereof.

Furthermore, in such a rock-salt crystal structure, the bond distance between a metal Me and oxygen (Me-O distance) tends to be longer than that in a layered rock-salt crystal structure.

For example, the Me-O distance is 2.09 Å and 2.11 Å in rock-salt Ni_{0.5}Mg_{0.50} and rock-salt MgO, respectively. Even when a spinel phase is formed in part of the surface portion 100a, the Me-O distance is 2.0125 Å and 2.02 Å in spinel NiAl₂O₄ and spinel MgAl₂O₄, respectively. In each case, the Me-O distance is longer than 2 Å. Note that 1 Å=10⁻¹⁰ m.

Meanwhile, in a layered rock-salt crystal structure, the bond distance between oxygen and a metal other than lithium is shorter than the above-described distance. For example, the A1-O distance is 1.905 Å (the Li—O distance is 2.11 Å) in layered rock-salt LiAlO₂. In addition, the Co—O distance is 1.9224 Å (the Li—O distance is 2.0916 Å) in layered rock-salt LiCoO₂.

According to Shannon's ionic radii (Non-Patent Document 8), the ion radius of hexacoordinated aluminum and the ion radius of hexacoordinated oxygen are 0.535 Å and 1.4 Å, respectively, and the sum of those values is 1.935 Å.

From the above, aluminum is considered to exist at sites other than lithium sites more stably in a layered rock-salt crystal structure than in a rock-salt crystal structure. Thus, in the surface portion 100a, aluminum is more likely to be distributed in, than in a region having a rock-salt phase and being close to the surface, a region having a layered rock-salt phase at a larger depth and/or the inner portion 100b.

Moreover, the initial heating can be expected to have an effect of increasing the crystallinity of the layered rock-salt crystal structure of the inner portion 100b.

However, the initial heating is not necessarily performed.

### <<Manufacturing Method 2 of Positive Electrode Active Material>>

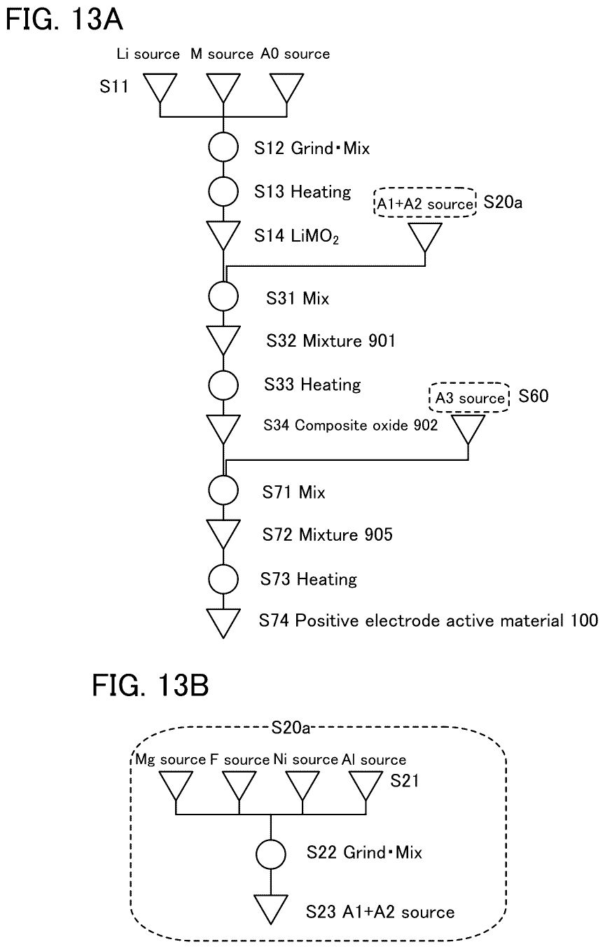

Next, as one embodiment of the present invention, a formation method 2 of the positive electrode active material, which is different from the formation method 1 of the positive electrode active material, is described with reference to FIG. 13A and FIG. 13B. The formation method 2 of the positive electrode active material is different from the formation method 1 mainly in the number of times of adding the additive element. For the description except for the above, the description of the formation method 1 can be referred to.

Although the formation method 1 of the positive electrode active material has described the formation method in which the addition of the additive element is performed only after formation of LiMO₂, the present invention is not limited to the above-described method. The addition of the additive element may be performed at another timing or may be performed a plurality of times. The timing of the addition may be different between the elements.

For example, the additive element may be added to the lithium source and the cobalt source in Step S11, i.e., at the stage of the starting materials of the composite oxide. The additive element source added at this time is shown as an 40 source in FIG. 13A. Then, lithium cobalt oxide containing the additive element can be obtained in Step S13. In that case, there is no need to separately perform Step S11 to Step S14 and Step S21 to Step S23. This method can be regarded as being simple and highly productive.

Alternatively, lithium cobalt oxide that contains some of the additive elements in advance may be used. When lithium cobalt oxide to which magnesium and fluorine are added is used, for example, Step S11 to Step S14 and part of Step S20 can be skipped. This method can be regarded as being simple and highly productive.

In addition, the additive element may be added to lithium cobalt oxide to which magnesium and fluorine are added in advance.

The formation method 1 of the positive electrode active material has described the formation method in which magnesium and fluorine are used as A1, nickel and aluminum are used as A2, and the elements are added at different timings; however, magnesium, fluorine, nickel, and aluminum may be added at the same time. FIG. 13A and FIG. 13B show a method for adding these elements at the same time as Step S20a. This formation method can also reduce the number of mixing and heating steps and thus can be regarded as being simple and highly productive.

This embodiment can be used in combination with the other embodiments.

### Embodiment 3

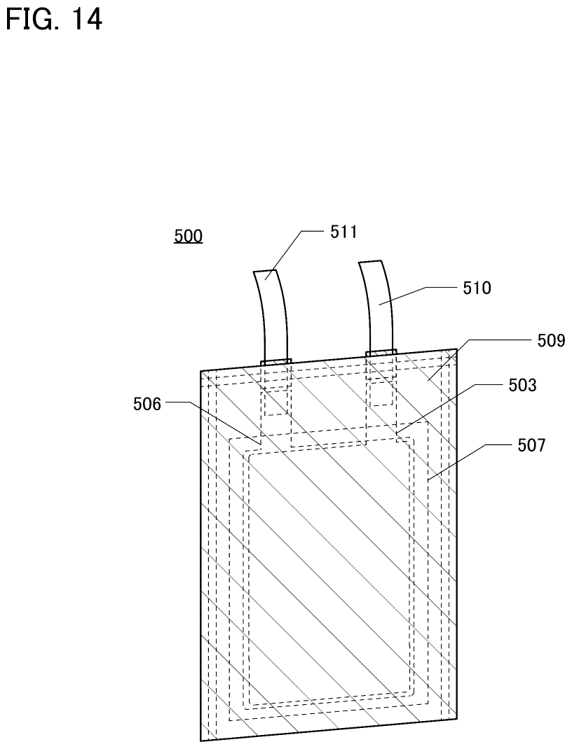

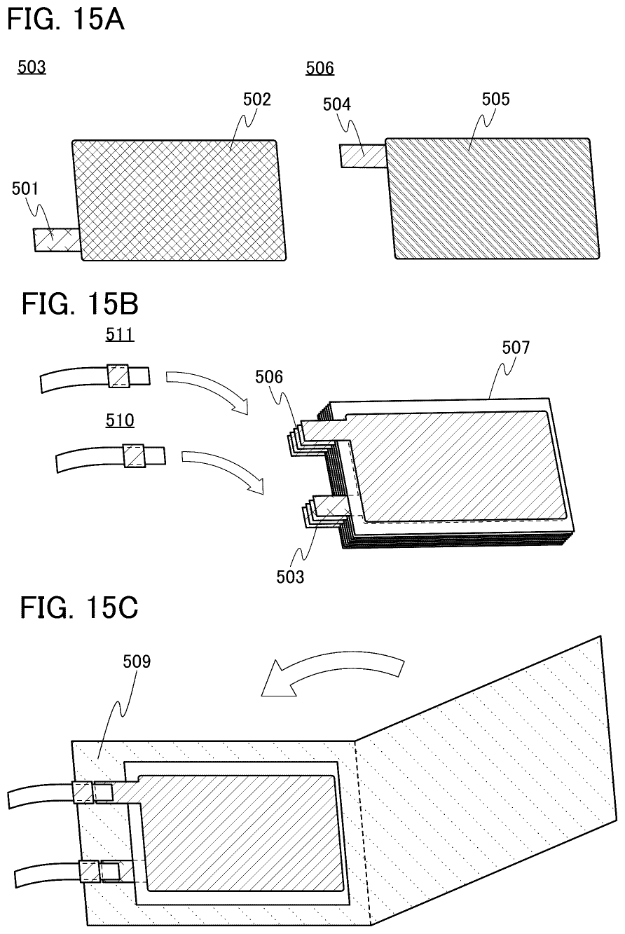

In this embodiment, an example of a secondary battery of one embodiment of the present invention are described with reference to FIG. 14 and FIG. 15.

### <Structure Example of Secondary Battery>

Hereinafter, a secondary battery illustrated in FIG. 14 in which a positive electrode, a negative electrode, and an electrolyte solution are wrapped in an exterior body is described as an example.

### [Positive Electrode]

The positive electrode includes a positive electrode active material layer and a positive electrode current collector. The positive electrode active material layer includes a positive electrode active material, and may include a conductive material (which can be rephrased as a conductive additive) and a binder. As the positive electrode active material, the positive electrode active material formed by the formation method described in the above embodiment is used.

The positive electrode active material described in the above embodiments and another positive electrode active material may be mixed to be used.

Examples of the another positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

As the another positive electrode active material, it is preferable to mix lithium nickel oxide (LiNiO₂ or LiNi₁₋ₓMₓO₂ (0<x<1) (M=Co, A1, the like)) with a lithium-containing material that has a spinel crystal structure and contains manganese, such as LiMn₂O₄. This composition can improve the characteristics of the secondary battery.

### <Conductive Material>

A conductive material is also referred to as a conductivity-imparting agent or a conductive additive, and a carbon material is used. The conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

An active material layer such as a positive electrode active material layer or a negative electrode active material layer preferably contains a conductive material.

For example, one kind or two or more kinds of carbon black such as acetylene black and furnace black, graphite such as artificial graphite and natural graphite, carbon fiber such as carbon nanofiber and carbon nanotube, and a graphene compound can be used as the conductive material.

As the carbon fiber, carbon fiber such as mesophase pitch-based carbon fiber or isotropic pitch-based carbon fiber can be used, for example. As the carbon fiber, carbon nanofiber, carbon nanotube, or the like can also be used. Carbon nanotube can be fabricated by, for example, a vapor deposition method.

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of six-membered rings of carbon atoms. The two-dimensional structure formed of the six-membered rings of carbon atoms may be referred to as a carbon sheet. A graphene compound may include a functional group. The graphene compound is preferably bent. The graphene compound may be rounded like carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of six-membered rings of carbon atoms. The reduced graphene oxide functions by itself but may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

A graphene compound sometimes has excellent electrical characteristics of high conductivity and excellent physical properties of high flexibility and high mechanical strength. The graphene compound has a sheet-like shape. The graphene compound has a curved surface in some cases, thereby enabling low-resistant surface contact. Furthermore, the graphene compound has extremely high conductivity even with a small thickness in some cases and thus allows a conductive path to be formed in an active material layer efficiently even with a small amount. Hence, when the graphene compound is used as the conductive material, the area where the active material and the conductive material are in contact with each other can be increased.

The graphene compound preferably covers 80% or more of the area of the active material. Note that a graphene compound preferably clings to at least part of an active material particle. A graphene compound preferably overlays at least part of an active material particle. The shape of a graphene compound preferably conforms to at least part of the shape of an active material particle. The shape of an active material particle means, for example, an uneven surface of a single active material particle or an uneven surface formed by a plurality of active material particles. A graphene compound preferably surrounds at least part of an active material particle. The graphene compound may have a hole.

In the case where an active material particle with a small particle diameter, e.g., 1 μm or less, is used, the specific surface area of the active material particle is large and thus more conductive paths for connecting the active material particles are needed. In such a case, a graphene compound that can efficiently form a conductive path even with a small amount is preferably used.

It is particularly effective to use a graphene compound, which has the above-described properties, as a conductive material of a secondary battery that needs to be rapidly charged and discharged. For example, a secondary battery for a two- or four-wheeled vehicle, a secondary battery for a drone, or the like is required to have rapid charge and rapid discharge characteristics in some cases. In addition, a mobile electronic device or the like is required to have rapid charge characteristics in some cases. Rapid charge and discharge refer to charge and discharge at, for example, 200 mA/g, 400 mA/g, or 1000 mA/g or more per weight of the positive electrode active material.

A plurality of graphenes or graphene compounds are formed to partly coat a plurality of particulate positive electrode active materials or adhere to the surfaces of the plurality of particulate positive electrode active materials, so that the plurality of graphenes or graphene compounds preferably make surface contact with the particulate positive electrode active materials.

Here, the plurality of graphenes or graphene compounds can be bonded to each other to form a net-like graphene compound sheet (hereinafter, referred to as a graphene compound net or a graphene net). A graphene net that covers the active material can function also as a binder for bonding the active materials. Accordingly, the amount of the binder can be reduced, or the binder does not have to be used, which can increase the proportion of the active material in the electrode volume and the electrode weight. That is, the discharge capacity of the secondary battery can be increased.

A material used in formation of the graphene compound may be mixed with the graphene compound to be used for the active material layer. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The median diameter (D50) of the particles is preferably less than or equal to 1 μm, further preferably less than or equal to 100 nm.

The content of the conductive material with respect to the total amount of the active material layer is preferably greater than or equal to 1 wt % and less than or equal to 10 wt %, further preferably greater than or equal to 1 wt % and less than or equal to 5 wt %.

Unlike a particulate conductive material such as carbon black, which makes point contact with an active material, the graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Accordingly, the discharge capacity of the battery can be increased.

A particulate carbon-containing compound such as carbon black or graphite and a fibrous carbon-containing compound such as carbon nanotube easily enter a microscopic space. A microscopic space means, for example, a region or the like between a plurality of active materials.

When a carbon-containing compound that easily enters a microscopic space and a sheet-like carbon-containing compound, such as graphene, that can impart conductivity to a plurality of particles are used in combination, the density of the electrode is increased and an excellent conductive path can be formed. The battery obtained by the manufacturing method of one embodiment of the present invention can have high capacity density and stability, and is effective as an in-vehicle battery.

### [Binder]

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, water-soluble polymers are preferably used, for example. As the water-soluble polymers, a polysaccharide can be used, for example. As the polysaccharide, one or more of starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, poly(vinylidene fluoride) (PVDF), polyacrylonitrile (PAN), ethylene-propylene-diene polymer, polyvinyl acetate, or nitrocellulose is preferably used.

As the binder, two or more of the above materials may be used in combination.

### [Current Collector]

The current collector can be formed using a material that has high conductivity, such as a metal like stainless steel, gold, platinum, aluminum, or titanium, or an alloy thereof. It is preferable that a material used for the positive electrode current collector not be dissolved at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used.

Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

The additive element whose oxide can be a semiconductor described in Embodiment 1 may be attached to the surface of the negative electrode and/or the positive electrode active material. Specifically, the additive element whose oxide can be a semiconductor may be attached to the surface of the active material as particles of nickel oxide (NiO), copper oxide, copper, or the like. This can increase the contact area between the current collector and the active material and the particle containing the additive element. Accordingly, reduction in the impedance of the positive electrode and/or the negative electrode is expected. In particular, annealed copper has high extensibility and conductivity among the types of copper and thus is expected to enhance this effect.

### [Negative Electrode]

The negative electrode includes a negative electrode active material layer and a negative electrode current collector. The negative electrode active material layer may contain a conductive material and a binder.

### [Negative Electrode Active Material]

As a negative electrode active material, for example, an alloy-based material and/or a carbon-based material can be used.

For the negative electrode active material, an element that enables charge and discharge reactions by an alloying reaction and a dealloying reaction with lithium can be used. For example, a material containing one or two or more selected from silicon, tin, gallium, aluminum, germanium, lead, antimony, bismuth, silver, zinc, cadmium, indium, and the like can be used. Such elements have higher charge and discharge capacity than carbon; in particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. SiO can alternatively be expressed as SiOₓ. Here, x preferably has an approximate value of 1. For example, x is preferably greater than or equal to 0.2 and less than or equal to 1.5, further preferably greater than or equal to 0.3 and less than or equal to 1.2. Alternatively, x is preferably greater than or equal to 0.2 and less than or equal to 1.2. Still alternatively, x is preferably greater than or equal to 0.3 and less than or equal to 1.5.

As the carbon-based material, graphite, graphitizing carbon (soft carbon), non-graphitizing carbon (hard carbon), carbon nanotube, graphene, carbon black, or the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferable because it may have a spherical shape. Moreover, MCMB may be preferable because it can relatively easily have a small surface area. Examples of natural graphite include flake graphite and spherical natural graphite.

Graphite has a low potential substantially equal to that of lithium metal (higher than or equal to 0.05 V and lower than or equal to 0.3 V vs. Li/Li⁺) when lithium ions are inserted into graphite (while a lithium-graphite intercalation compound is formed). For this reason, a lithium-ion secondary battery can have a high operating voltage. In addition, graphite is preferred because of its advantages such as a relatively high charge and discharge capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of its high charge and discharge capacity (900 mAh/g and 1890 mAh/cm³).

A composite nitride of lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. In the case of using a material containing lithium ions as a positive electrode active material, the composite nitride of lithium and a transition metal can be used as the negative electrode active material by extracting the lithium ions contained in the positive electrode active material in advance.

A material that causes a conversion reaction can also be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be contained in the negative electrode active material layer, materials similar to those of the conductive material and the binder that can be contained in the positive electrode active material layer can be used.

### [Negative Electrode Current Collector]

For the negative electrode current collector, a material similar to that of the positive electrode current collector can be used. Note that a material that does not alloy with carrier ions of lithium or the like is preferably used for the negative electrode current collector.

### [Electrolyte]

As one mode of an electrolyte, an electrolyte solution containing a solvent and an electrolyte dissolved in the solvent can be used. The electrolyte solution contains a solvent and a lithium salt. As the solvent of the electrolyte solution, an aprotic organic solvent is preferably used; for example, one kind of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, sultone, and the like can be used, or two or more kinds thereof can be used in an appropriate combination at an appropriate ratio.

When ethylene carbonate (EC) and diethyl carbonate (DEC) are contained in the electrolyte solution, it is possible to use a mixed organic solvent in which the volume ratio between ethylene carbonate and diethyl carbonate is x:100-x (where 20≤x≤40) on the assumption that the total content of ethylene carbonate and diethyl carbonate is 100 vol %. More specifically, a mixed organic solvent containing EC and DEC at EC:DEC=30:70 (volume ratio) can be used.

In the case where ethylene carbonate (EC), ethyl methyl carbonate (EMC), and dimethyl carbonate (DMC) are contained in the electrolyte solution, it is possible to use a mixed organic solvent in which the volume ratio between ethylene carbonate, ethyl methyl carbonate, and dimethyl carbonate is x:y:100-x-y (where 5≤x≤35 and 0<y<65) on the assumption that the total content of ethylene carbonate, ethyl methyl carbonate, and dimethyl carbonate is 100 vol %. More specifically, a mixed organic solvent containing EC, EMC, and DMC at EC:EMC:DMC=30:35:35 (volume ratio) can be used.

Furthermore, in the electrolyte solution, a mixed organic solvent containing a fluorinated cyclic carbonate (also referred to as a cyclic carbonate fluoride in some cases) or a fluorinated chain carbonate (also referred to as a chain carbonate fluoride in some cases) can be used. The above mixed organic solvent further preferably contains both a fluorinated cyclic carbonate and a fluorinated chain carbonate. A fluorinated cyclic carbonate and a fluorinated chain carbonate are preferable because they each include a substituent with an electron-withdrawing property and have a low solvation energy of a lithium ion. Accordingly, a fluorinated cyclic carbonate and a fluorinated chain carbonate are each suitable for the electrolyte solution, and a mixed organic solvent containing either of them is suitable.

As a fluorinated cyclic carbonate, for example, fluoroethylene carbonate (fluorinated ethylene carbonate, FEC, or F1EC), difluoroethylene carbonate (DFEC or F2EC), trifluoroethylene carbonate (F3EC), tetrafluoroethylene carbonate (F4EC), or the like can be used.

Note that DFEC has isomers such as a cis-4,5 isomer and a trans-4,5 isomer. Each of these fluorinated cyclic carbonates includes a substituent with an electron-withdrawing property and thus is presumed to have a low solvation energy of a lithium ion. The substituent with an electron-withdrawing property in FEC is an F group.

An example of the fluorinated chain carbonate is methyl 3,3,3-trifluoropropionate. An abbreviation of methyl 3,3,3-trifluoropropionate is “MTFP”. The substituent with an electron-withdrawing property in MTFP is a CF₃ group.

FEC, which is a cyclic carbonate, has a high dielectric constant and thus has an effect of promoting dissociation of a lithium salt when used in an organic solvent. Meanwhile, it can be said that since FEC includes a substituent having an electron-withdrawing property, a lithium ion is desolvated with FEC more easily than with ethylene carbonate (EC). Specifically, the solvation energy of a lithium ion is lower in FEC than in EC, which does not include a substituent with an electron-withdrawing property. Thus, lithium ions are likely to be extracted from surfaces of a positive electrode active material and a negative electrode active material, which can reduce an internal resistance of a secondary battery. In addition, FEC has a deep highest occupied molecular orbital (HOMO) level and is thus not easily oxidized, meaning high oxidation resistance. Meanwhile, FEC disadvantageously has high viscosity. In view of this, a mixed organic solvent including not only FEC but also MTFP is preferably used for the electrolyte solution. MTFP, which is a linear carbonate, can have an effect of reducing the viscosity of the electrolyte solution or maintaining the viscosity at room temperature (typically, 25° C.) even at low temperatures (typically, 0° C.). Moreover, MTFP achieves a lower solvation energy than methyl propionate (abbreviated as “MP”), which does not include a substituent with an electron-withdrawing property, but may solvate a lithium ion when used for the electrolyte solution.

The above-described organic solvent is preferably highly purified and has low contents of dust particles or molecules other than the constituent molecules of the organic solvent (hereinafter also simply referred to as “impurities”, containing oxygen (O2), water (H2O), or moisture). It is preferable that generation of a reaction by-product in synthesis be inhibited through appropriate purification. Specifically, the impurity in the electrolyte is at less than or equal to 100 ppm, preferably less than or equal to 50 ppm, further preferably less than 10 ppm. The concentration of moisture among the impurities can be detected by Karl Fischer titration.

Furthermore, it is preferable that peaks attributed to impurities in the above-described organic solvent be hardly observed by NMR measurement or the like. The expression “hardly observed” includes the case where the ratio of the integral area of the peak attributed to impurities to the integral area of the peak attributed to the main component (such a ratio is simply referred to as an integral ratio) is less than or equal to 0.005, preferably less than or equal to 0.002. An apparatus used for the NMR measurement is not particularly limited, and for example, “AVANCE III 400” produced by Bruker Corporation can be used. Among the five peaks of acetonitrile derived from acetonitrile-d3 used in a solvent in the 1H-NMR measurement, the center peak can be 1.94 ppm.

For example, in the case of MTFP, it is known that when 1H-NMR is measured using an acetonitrile-d3 solvent, four peaks appear at δ of greater than or equal to 3.29 ppm and less than or equal to 3.43 ppm. However, in the case where another peak appears in the vicinity of the above range, for example, another peak appears at δ of greater than or equal to 3.24 ppm and less than or equal to 3.29 ppm, the peak is probably derived from impurities. Accordingly, when the ratio (integral ratio) of a peak area greater than or equal to 3.24 ppm and less than or equal to 3.29 ppm to a peak area greater than or equal to 3.29 ppm and less than or equal to 3.43 ppm is less than or equal to 0.005, preferably less than or equal to 0.002, peaks attributed to impurities are hardly observed.

FEC and MTFP having such physical properties are preferably mixed at a volume ratio of x:100-x (where 5≤x≤30, preferably 10≤x≤20) on the assumption that the total content of a mixed organic solvent containing FEC and MTFP is 100 vol %. In other words, FEC and MTFP are preferably mixed such that the amount of MTFP is larger than that of FEC in the mixed organic solvent.

The use of one or more kinds of ionic liquids (room temperature molten salts) which have features of non-flammability and non-volatility as the solvent of the electrolyte solution can prevent a secondary battery from exploding and/or igniting, for example, even when the secondary battery internally shorts out or the internal temperature increases owing to overcharging or the like. An ionic liquid contains a cation and an anion, specifically, an organic cation and an anion.

Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

### [Lithium Salt]

As a lithium salt (also referred to as an electrolyte) dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiCAF₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂FsSO₂)₂ can be used, or two or more kinds of these can be used in an appropriate combination in an appropriate ratio. The lithium salt is preferably at greater than or equal to 0.5 mol/L and less than or equal to 3.0 mol/L with respect to the solvent. Using a fluoride such as LiPF₆ or LiBF₄ enables a lithium-ion secondary battery to have improved safety.

As the above-described electrolyte solution, it is preferable to use a highly purified electrolyte solution containing low contents of dust particles or elements other than the constituent elements of the electrolyte solution (hereinafter, also simply referred to as “impurities”). Specifically, the weight ratio of impurities to the electrolyte solution is less than or equal to 1 wt %, preferably less than or equal to 0.1 wt %, further preferably less than or equal to 0.01 wt %.

### [Additive Agent]

The electrolyte solution may contain an additive agent. An additive agent can inhibit a decomposition reaction of an electrolyte which might occur on a positive electrode surface or a negative electrode surface when a secondary battery operates at a high voltage and/or high temperatures. As the additive agent, for example, vinylene carbonate (VC), propane sultone (PS), TerT-butylbenzene (TBB), fluoroethylene carbonate (FEC), or lithium bis(oxalate) borate (LiBOB) is preferably used. It is particularly preferable to use LiBOB because it facilitates formation of a favorable coating film. VC or FEC is preferable because it forms a favorable coating film on a negative electrode at the time of aging the secondary battery or charging the secondary battery at the initial use, which improves the cycle performance.

As the additive agent, one kind or two or more kinds of dinitrile compounds can be used. Specific examples of a dinitrile compound include succinonitrile, glutaronitrile, adiponitrile (ADN), and ethylene glycol bis(propionitrile) ether (EGBE).

Furthermore, fluorobenzene may be added to the above organic solvent. The concentration of the additive agent in the whole electrolyte solution is, for example, higher than or equal to 0.1 wt % and lower than or equal to 5 wt %. PS or EGBE is preferable because it forms a favorable coating film on a positive electrode at the time of charge and discharge, which improves the cycle performance. FB is preferable because it improves the wettability of the organic solvent with respect to the positive electrode and the negative electrode. The dinitrile compound is preferable because its nitrile groups are oriented to the positive electrode and the negative electrode and oxidative decomposition of the organic solvent is hindered, whereby voltage resistance can be increased. Furthermore, in the case where the negative electrode includes a current collector containing copper, a dinitrile compound is preferable because it can prevent dissolution of copper at the time of overdischarging. Considering the use of the secondary battery at a high voltage, a nitrile compound is preferably added. [Gel electrolyte]

A polymer gel obtained in a manner in which a polymer is swelled with an electrolyte solution may be used as a gel electrolyte. When a polymer gel electrolyte is used, a semisolid electrolyte layer can be provided, so that safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

### [Solid Electrolyte]

Instead of the electrolyte solution, a solid electrolyte containing an inorganic material such as a sulfide-based or oxide-based inorganic material, a solid electrolyte containing a polymer material such as a PEO (polyethylene oxide)-based polymer material, or the like can be used. When the solid electrolyte is used, a separator and/or a spacer are/is not necessary. Furthermore, the battery can be entirely solidified; thus, there is no possibility of liquid leakage and thus the safety of the battery is dramatically improved.

### [Separator]

The secondary battery preferably includes a separator. The separator can be formed using, for example, paper, nonwoven fabric, glass fiber, ceramics, or synthetic fiber including nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramics-based material, the oxidation resistance is improved; hence, degradation of the separator during high-voltage charge can be inhibited and thus the reliability of the secondary battery can be improved. When the separator is coated with the fluorine-based material, the separator is easily brought into close contact with an electrode, resulting in high output characteristics. When the separator is coated with a polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

The use of a separator having a multilayer structure makes it possible to maintain the safety of the secondary battery even when the total thickness of the separator is small, so that the discharge capacity per volume of the secondary battery can be increased.

### [Exterior Body]

For the exterior body of the secondary battery, a metal material such as aluminum and/or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### <Laminated Secondary Battery and Manufacturing Method Thereof>

FIG. 14 and FIG. 15 illustrate an example of an external view of a laminated secondary battery 500. The secondary battery 500 in FIG. 14 and FIG. 15 includes a positive electrode 503 including a positive electrode current collector 501 and a positive electrode active material layer 502, a negative electrode 506 including a negative electrode current collector 504 and a negative electrode active material layer 505, a separator 507, an exterior body 509, a positive electrode lead electrode 510, and a negative electrode lead electrode 511. When the laminated secondary battery has flexibility and is used in an electronic device at least part of which is flexible, the secondary battery can be bent as the electronic device is bent. An example of a manufacturing method of the laminated secondary battery will be described with reference to FIG. 15A to FIG. 15C.

First, the negative electrode 506, the separator 507, and the positive electrode 503 are stacked. FIG. 15B illustrates the negative electrodes 506, the separators 507, and the positive electrodes 503 that are stacked. Here, an example in which five negative electrodes and four positive electrodes are used is shown. Next, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion shown by a dashed line, as illustrated in FIG. 15C. Then, the outer edges of the exterior body 509 are bonded to each other. The bonding is performed by thermocompression, for example. At this time, an unbonded region (hereinafter referred to as an inlet) is provided for part (or one side) of the exterior body 509 so that an electrolyte solution can be introduced later.

Next, an electrolyte solution (not illustrated) is introduced into the exterior body 509 from the inlet of the exterior body 509. The electrolyte solution is preferably introduced in a reduced pressure atmosphere or in an inert gas atmosphere. Lastly, the inlet is sealed by bonding. In this manner, the laminated secondary battery 500 can be manufactured.

When the positive electrode active material described in the above embodiment is used in the positive electrode 503, the secondary battery 500 can have high discharge capacity and excellent cycle performance.

This embodiment can be used in appropriate combination with the other embodiments.

### Embodiment 4

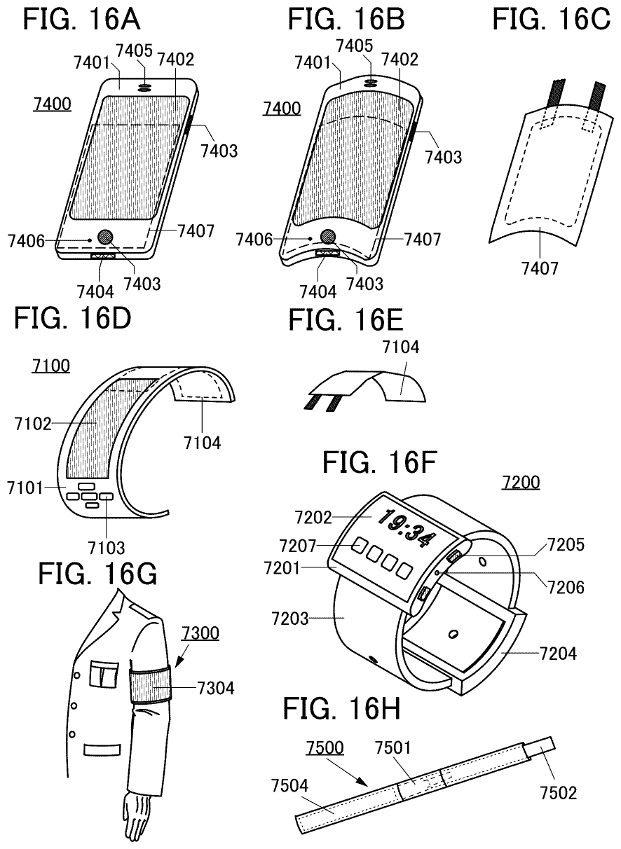

In this embodiment, examples of electronic devices each including the secondary battery of one embodiment of the present invention will be described with reference to FIG. 16A to FIG. 18C.

FIG. 16A to FIG. 16G illustrate examples of electronic devices each including the secondary battery including the positive electrode active material described in the above embodiment. Examples of electronic devices each including a secondary battery include television devices (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

Furthermore, a flexible secondary battery can be incorporated along a curved inside/outside wall surface of a house, a building, or the like or a curved interior/exterior surface of an automobile, for example.

FIG. 16A illustrates an example of a mobile phone. A mobile phone 7400 is provided with a display portion 7402 incorporated in a housing 7401, operation buttons 7403, an external connection port 7404, a speaker 7405, a microphone 7406, and the like. The mobile phone 7400 includes a secondary battery 7407. When the secondary battery of one embodiment of the present invention is used as the secondary battery 7407, a lightweight mobile phone with a long lifetime can be provided.

FIG. 16B illustrates the state where the mobile phone 7400 is curved. When the whole mobile phone 7400 is curved by the external force, the secondary battery 7407 included therein is also curved. FIG. 16C illustrates the bent secondary battery 7407. The secondary battery 7407 is a thin storage battery. The secondary battery 7407 is fixed in a state of being bent. The secondary battery 7407 includes a lead electrode electrically connected to a current collector. The current collector is, for example, copper foil, and partly alloyed with gallium; thus, adhesion between the current collector and an active material layer in contact with the current collector is improved and the secondary battery 7407 can have high reliability even in a state of being bent.

FIG. 16D illustrates an example of a bangle display device. A portable display device 7100 includes a housing 7101, a display portion 7102, operation buttons 7103, and a secondary battery 7104. FIG. 16E illustrates the bent secondary battery 7104. When the display device is worn on a user's arm while the secondary battery 7104 is bent, the housing changes its shape and the curvature of part or the whole of the secondary battery 7104 is changed. The bending condition of a curve at a given point that is represented by a value of the radius of a corresponding circle is referred to as the radius of curvature, and the reciprocal of the radius of curvature is referred to as curvature. Specifically, part or the whole of the housing or the main surface of the secondary battery 7104 is changed in the range of radius of curvature of 40 mm or more to 150 mm or less. When the radius of curvature at the main surface of the secondary battery 7104 is in the range of 40 mm or more to 150 mm or less, the reliability can be kept high. When the secondary battery of one embodiment of the present invention is used as the secondary battery 7104, a lightweight portable display device with a long lifetime can be provided.

FIG. 16F illustrates an example of a watch-type portable information terminal. A portable information terminal 7200 includes a housing 7201, a display portion 7202, a band 7203, a buckle 7204, an operation button 7205, an input/output terminal 7206, and the like. The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by the operating system incorporated in the portable information terminal 7200.

The portable information terminal 7200 can perform near field communication that is standardized communication. For example, mutual communication with a headset capable of wireless communication enables hands-free calling.

Moreover, the portable information terminal 7200 includes the input/output terminal 7206, and data can be directly transmitted to and received from another information terminal via a connector. In addition, charging via the input/output terminal 7206 is possible. The charging operation may be performed by wireless power feeding without using the input/output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. For example, the secondary battery 7104 illustrated in FIG. 16E can be provided in the housing 7201 while being curved, or can be provided in the band 7203 such that it can be curved.

The portable information terminal 7200 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 16G illustrates an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication that is standardized communication.

The display device 7300 includes an input/output terminal, and data can be directly transmitted to and received from another information terminal via a connector. In addition, charging via the input/output terminal is possible. The charging operation may be performed by wireless power feeding without using the input/output terminal.

When the secondary battery of one embodiment of the present invention is used as the secondary battery included in the display device 7300, a lightweight display device with a long lifetime can be provided.

Examples of electronic devices each including the secondary battery with excellent cycle performance described in the above embodiment are described with reference to FIG. 16H to FIG. 18C.

When the secondary battery of one embodiment of the present invention is used as a secondary battery of a daily electronic device, a lightweight product with a long lifetime can be provided. Examples of the daily electronic device include an electric toothbrush, an electric shaver, and electric beauty equipment, and as secondary batteries of these products, small and lightweight stick type secondary batteries with high discharge capacity are desired in consideration of handling ease for users.

FIG. 16H is a perspective view of a device called a cigarette smoking device (electronic cigarette). In FIG. 16H, an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharging and/or overdischarging of the secondary battery 7504 may be electrically connected to the secondary battery 7504. The secondary battery 7504 illustrated in FIG. 16H includes an external terminal for connection to a charger. When the electronic cigarette 7500 is held, the secondary battery 7504 is a tip portion; thus, it is preferable that the secondary battery 7504 have a short total length and be lightweight. With the secondary battery of one embodiment of the present invention, which has high discharge capacity and excellent cycle performance, the small and lightweight electronic cigarette 7500 that can be used for a long time over a long period can be provided.

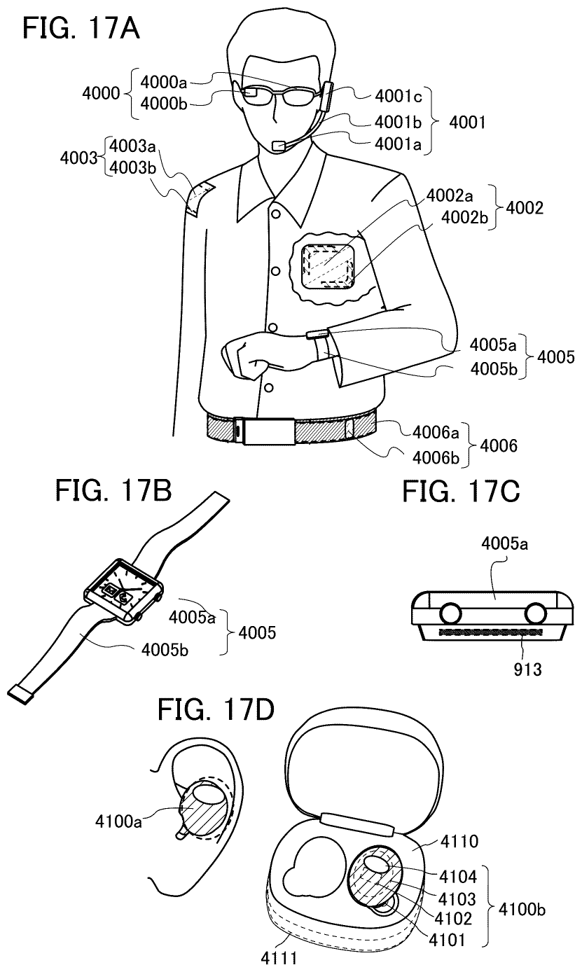

FIG. 17A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 17A. The glasses-type device 4000 includes a frame 4000a and a display part 4000b. The secondary battery is provided in a temple portion of the frame 4000a having a curved shape, whereby the glasses-type device 4000 can be lightweight, can have a well-balanced weight, and can be used continuously for a long time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b and/or the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail and an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 17B illustrates a perspective view of the watch-type device 4005 that is detached from an arm.

FIG. 17C illustrates a side view. FIG. 17C illustrates a state where a secondary battery 913 is incorporated inside. The secondary battery 913 is the secondary battery described in Embodiment 4. The secondary battery 913, which is small and lightweight, is provided at a position overlapping with the display portion 4005a.

FIG. 17D illustrates an example of wireless earphones. The wireless earphones illustrated here consist of, but not limited to, a pair of main bodies 4100a and 4100b.

The main bodies 4100a and 4100b each include a driver unit 4101, an antenna 4102, and a secondary battery 4103. Each of the main bodies 4100a and 4100b may also include a display portion 4104. Moreover, each of the main bodies 4100a and 4100b preferably includes a substrate where a circuit such as a wireless IC is provided, a terminal for charge, and the like. Each of the main bodies 4100a and 4100b may also include a microphone.

A case 4110 includes a secondary battery 4111. Moreover, the case 4110 preferably includes a substrate where a circuit such as a wireless IC or a charge control IC is provided, and a terminal for charge. The case 4110 may also include a display portion, a button, and the like.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to the main bodies 4100a and 4100b and played. Hence, the wireless earphones can be used as a translator, for example.

The secondary battery 4103 included in the main body 4100a can be charged by the secondary battery 4111 included in the case 4110. As the secondary battery 4111 and the secondary battery 4103, the coin-type secondary battery of the above embodiment or a cylindrical secondary battery, for example, can be used. A secondary battery whose positive electrode includes the positive electrode active material 100 obtained in Embodiment 1 has a high energy density; thus, with the use of the secondary battery as the secondary battery 4103 and the secondary battery 4111, space saving required with downsizing of the wireless earphones can be achieved.

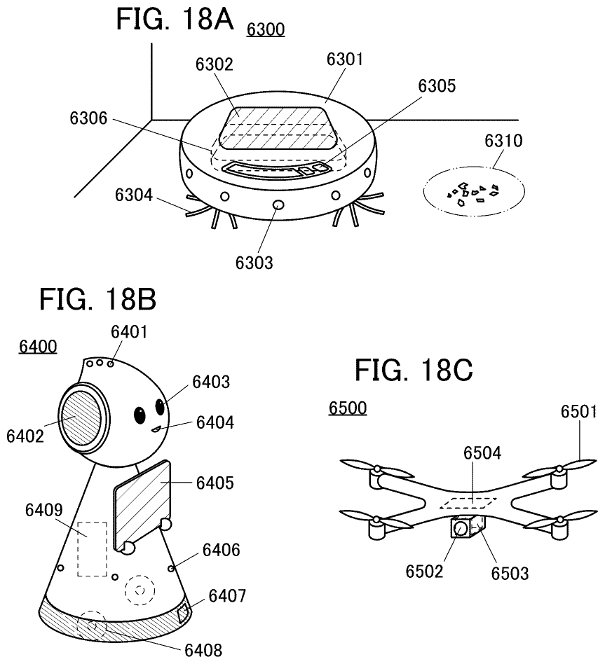

FIG. 18A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, senses dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 senses an object, such as a wire, that is likely to be caught in the brush 6304 by image analysis, the rotation of the brush 6304 can be stopped. The cleaning robot 6300 includes the secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 18B illustrates an example of a robot. A robot 6400 illustrated in FIG. 18B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of sensing a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can sense an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 18C illustrates an example of a flying object. A flying object 6500 illustrated in FIG. 18C includes propellers 6501, a camera 6502, a secondary battery 6503, and the like and has a function of flying autonomously.

For example, image data taken by the camera 6502 is stored in an electronic component 6504. The electronic component 6504 can analyze the image data to sense whether there is an obstacle in the way of the movement. Moreover, the electronic component 6504 can estimate the remaining battery level from a change in the power storage capacity of the secondary battery 6503. The flying object 6500 further includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with any of the other embodiments.

### Embodiment 5

In this embodiment, examples of vehicles each including a secondary battery including the positive electrode active material of one embodiment of the present invention will be described.

The use of secondary batteries in vehicles enables production of next-generation clean energy vehicles such as hybrid electric vehicles (HVs), electric vehicles (EVs), and plug-in hybrid electric vehicles (PHVs).

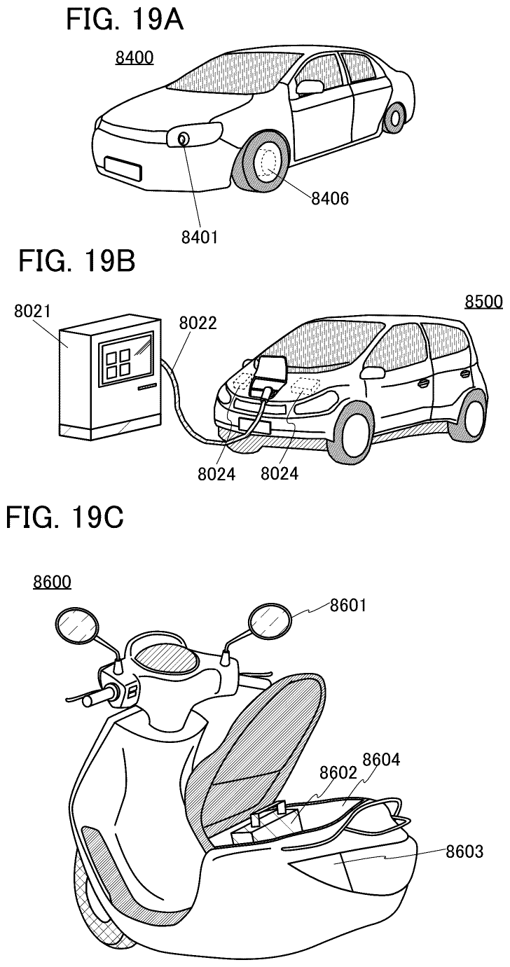

FIG. 19 illustrates examples of a vehicle including the secondary battery of one embodiment of the present invention. An automobile 8400 illustrated in FIG. 19A is an electric vehicle that runs on the power of an electric motor. Alternatively, the automobile 8400 is a hybrid electric vehicle capable of driving using either an electric motor or an engine as appropriate. The use of one embodiment of the present invention achieves a high-mileage vehicle. The automobile 8400 includes the secondary battery. For example, the modules of the secondary battery can be arranged in a floor portion in the automobile to be used. The secondary battery can be used not only for driving an electric motor 8406, but also for supplying electric power to light-emitting devices such as a headlight 8401 and a room light (not illustrated).

The secondary battery can also supply electric power to a display device included in the automobile 8400, such as a speedometer or a tachometer. Furthermore, the secondary battery can supply electric power to a semiconductor device included in the automobile 8400, such as a navigation system.

An automobile 8500 illustrated in FIG. 19B can be charged when the secondary battery included in the automobile 8500 is supplied with electric power through external charge equipment by a plug-in system, a contactless power feeding system, and/or the like. FIG. 19B illustrates a state where a secondary battery 8024 included in the automobile 8500 is charged with the use of a ground-based charging apparatus 8021 through a cable 8022. In charging, a given method such as CHAdeMO (registered trademark) or Combined Charging System may be employed as a charge method, the standard of a connector, and the like as appropriate. The charging apparatus 8021 may be a charging station provided in a commerce facility or a power source in a house. For example, with the use of a plug-in technique, the secondary battery 8024 provided in the automobile 8500 can be charged by being supplied with electric power from outside. The charge can be performed by converting AC electric power into DC electric power through a converter such as an ACDC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road and/or an exterior wall, charging can be performed not only when the vehicle is stopped but also when driven. In addition, the contactless power feeding system may be utilized to perform transmission and reception of electric power between vehicles.

Furthermore, a solar cell may be provided in the exterior of the vehicle to charge the secondary battery when the vehicle stops and/or moves. To supply electric power in such a contactless manner, an electromagnetic induction method and/or a magnetic resonance method can be used. FIG. 19C illustrates an example of a motorcycle including the secondary battery of one embodiment of the present invention. A motor scooter 8600 illustrated in FIG. 19C includes a secondary battery 8602, side mirrors 8601, and direction indicators 8603. The secondary battery 8602 can supply electric power to the direction indicators 8603.

In the motor scooter 8600 illustrated in FIG. 19C, the secondary battery 8602 can be held in an under-seat storage 8604. The secondary battery 8602 can be held in the under-seat storage 8604 even when the under-seat storage 8604 is small. The secondary battery 8602 is detachable; thus, the secondary battery 8602 is carried indoors when charged, and is stored before the motor scooter is driven.

According to one embodiment of the present invention, the secondary battery can have improved cycle performance and the discharge capacity of the secondary battery can be increased. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals typified by cobalt can be reduced.

This embodiment can be implemented in appropriate combination with any of the other embodiments.

### REFERENCE NUMERALS

100 positive electrode active material
100a: surface portion, 100b: inner portion, 100c: inner wall surface portion, 104: coating portion,
106: crack portion, 901: mixture, 902: composite oxide, 903: mixture, 904: composite oxide, and
905: mixture

1. A secondary battery comprising:
a positive electrode active material,
wherein the positive electrode active material comprises an additive element whose oxide can be a semiconductor, magnesium, and lithium cobalt oxide,
wherein the positive electrode active material comprises a crack portion,
wherein the positive electrode active material comprises a surface portion and an inner wall surface portion,
wherein the surface portion is a region within 10 nm from a surface other than the crack portion in a direction substantially perpendicular to the surface,
wherein the inner wall surface portion is a region within 10 nm from a surface of the crack portion in a direction substantially perpendicular to the surface and is a region other than the surface portion,
wherein magnesium is detected from the surface portion and the crack portion, and
wherein the additive element whose oxide can be a semiconductor is detected from the surface portion and is one or two selected from nickel and titanium.

2. A secondary battery comprising:
a positive electrode active material,
wherein the positive electrode active material comprises magnesium and lithium cobalt oxide,
wherein magnesium has a concentration gradient in a surface portion of the positive electrode active material, and
wherein in an EDX line analysis result of magnesium contained in the positive electrode active material, when a peak width at a height which is ⅕ of a height of a maximum value of a detected amount of magnesium is divided into two parts by a perpendicular extending from the maximum value to a horizontal axis, a peak width MgW_{core} on an inner portion side is larger than a peak width MgWₛₕₑₗₗ on a surface side.

3. A secondary battery comprising:
a positive electrode active material,
wherein the positive electrode active material comprises an additive element whose oxide can be a semiconductor, magnesium, and lithium cobalt oxide,
wherein the positive electrode active material comprises a crack portion,
wherein the positive electrode active material comprises a surface portion and an inner wall surface portion,
wherein the surface portion is a region within 10 nm from a surface other than the crack portion in a direction substantially perpendicular to the surface,
wherein the inner wall surface portion is a region within 10 nm from a surface of the crack portion in a direction substantially perpendicular to the surface and is a region other than the surface portion,
wherein magnesium is detected from the surface portion and the crack portion,
wherein the additive element whose oxide can be a semiconductor is detected from the surface portion and is one or two selected from nickel and titanium,
wherein magnesium has a concentration gradient in the surface portion of the positive electrode active material, and
wherein in an EDX line analysis result of magnesium contained in the positive electrode active material, when a peak width at a height which is ⅕ of a height of a maximum value of a detected amount of magnesium is divided into two parts by a perpendicular extending from the maximum value to a horizontal axis, a peak width MgW_{core} on an inner portion side is larger than a peak width MgWₛₕₑₗₗ on a surface side.

4. The secondary battery according to claim 1, further comprising fluorine in the surface portion and the inner wall surface portion.

5. The secondary battery according to claim 2, further comprising fluorine in the surface portion and the inner wall surface portion.

6. The secondary battery according to claim 3, further comprising fluorine in the surface portion and the inner wall surface portion.
